(19) United States
(12) Patent Application Publication
(10) Pub. No.: US 2024/0322244 A1
(43) Pub. Date: Sep. 26, 2024

(54) LOCALIZED HIGH CONCENTRATION ELECTROLYTE AND LITHIUM-ION BATTERY COMPRISING THE SAME

(71) Applicant: Sila Nanotechnologies, Inc., Alameda, CA (US)

(72) Inventors: Naoki NITTA, Alameda, CA (US); Gleb Nikolayevich YUSHIN, Atlanta, GA (US); Ismael RODRÍGUEZ PÉREZ, Oakland, CA (US); William Elliott GENT, San Francisco, CA (US)

(21) Appl. No.: 18/608,268

(22) Filed: Mar. 18, 2024

Related U.S. Application Data
(60) Provisional application No. 63/491,234, filed on Mar. 20, 2023.
(60) Provisional application No. 63/612,748, filed on Dec. 20, 2023.

(51) Int. Cl. H01M 10/0567; H01M 4/133; H01M 4/134; H01M 4/38; H01M 4/587; H01M 4/62; H01M 4/66; H01M 10/0525; H01M 10/0568; H01M 10/0569

(52) U.S. Cl. CPC H01M 10/0567; H01M 4/133; H01M 4/134; H01M 4/386; H01M 4/587; H01M 4/625; H01M 4/661; H01M 10/0525; H01M 10/0568; H01M 10/0569

(57) ABSTRACT

An electrolyte includes (1) a lithium salt composition, (2) a solvent composition, and (3) a diluent composition. In some embodiments, the diluent composition includes at least one alkane compound. In some embodiments, the at least one alkane compound is selected from (1) non-fluorinated alkane compounds characterized by a first molecular formula CₚH₂ₚ₊₂, in which p is a first integer between 5 and 20, and (2) fluorinated alkane compounds characterized by a second molecular formula C_{q}H_{q1}F_{q2}, in which q is a second integer between 4 and 20, q₁ is a third positive integer, and q₂ is a fourth positive integer, q, q₁, and q₂ being related by q₁+q₂=2q+2. A lithium-ion battery including such electrolyte is also disclosed.

### CROSS-REFERENCE TO RELATED APPLICATIONS

The present Application for Patent claims the benefit of U.S. Provisional Application No. 63/491,234, entitled “LOCALIZED HIGH CONCENTRATION ELECTROLYTE AND LITHIUM-ION BATTERY COMPRISING THE SAME,” filed Mar. 20, 2023, and U.S. Provisional Application No. 63/612,748, entitled “LOCALIZED HIGH CONCENTRATION ELECTROLYTE AND LITHIUM-ION BATTERY COMPRISING THE SAME,” filed Dec. 20, 2023, each of which is assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively light weight, small size, and potential for long lifetimes, advanced rechargeable batteries are desirable for a wide range of consumer electronics, electric vehicles, grid storage and other important applications.

However, despite the increasing commercial prevalence of batteries, further development of these batteries is needed, particularly for applications in low- or zero-emission, hybrid-electrical or fully electric vehicles, consumer electronics, wearable devices, energy-efficient cargo ships and locomotives, drones, aerospace applications, and power grids. In particular, further improvements are desired for various rechargeable batteries, such as Li and Li-ion batteries, Na and Na-ion batteries, and rechargeable K and K-ion batteries and dual-batteries, to name a few.

A broad range of electrolyte compositions may be utilized in the construction of Li and Li-ion batteries and other metal and metal-ion batteries. However, for improved cell performance (e.g., low and stable resistance, high cycling stability, high-rate capability, good thermal stability, long calendar life, etc.), an optimal choice of electrolyte needs to be developed for specific types and specific sizes of active particles in both the anode and cathode, specific total battery cell capacities as well as specific operational conditions (e.g., temperature, charge rate, discharge rate, voltage range, capacity utilization, etc.). In many cases, the choice of electrolyte components and their ratios is not trivial and can be counterintuitive.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries. Unfortunately, Li and Li-ion battery cells with such anodes and conventional electrolytes often require the use of such large amounts of conventional solid-electrolyte interphase (SEI)-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V. Higher cell voltage, broader operational temperature window, and longer cycle life, however, are advantageous for most applications. Such cells may suffer from excessive capacity degradation (e.g., above about 5%), large volume expansion (e.g., above about 10%) and significant gassing (e.g., above about 10% thickness change) when exposed to high temperatures (e.g., above about 50-90° C.) in a fully charged state (e.g., state-of-charge (SOC) of about 90-100%) for a prolonged time (e.g., about 12-168 hours). Passing such elevated temperature charging tests is required for most applications. Performance of such cells may also become particularly poor when the anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs.

In certain types of rechargeable batteries, charge storing anode materials may be produced as high-capacity (nano)composite powders (e.g., at least partially comprised of active material nanomaterials or nanostructures), which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles may include anode particles with an average size (e.g., diameter or thickness) in the range of about 0.2 to about 40 microns (micrometers). Such a class of charge-storing particles offers great promises for scalable manufacturing and achieving high cell-level energy density and other performance characteristics. Unfortunately, such particles are relatively new and their use in cells using conventional electrolytes may result in relatively poor cell performance characteristics and limited cycle stability. Performance of such battery cells may become particularly poor when the cells are charged to above about 4.1-4.3 V, more so when the cells are charged to above about 4.3-4.4 V and even more so when the cells are charged to above about 4.5 V. Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (“high-temperature outgassing”) (e.g., about 50-90° C. or higher) in a fully charged state (e.g., state-of-charge, SOC, of about 90-100%) for a prolonged time (e.g., about 12-168 hours). Passing such elevated temperature charging tests is required for most applications. Cell performance may also become particularly poor when the high-capacity (nano)composite anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs. Similarly, cell performance may degrade when the porosity of such an anode (e.g., the volume occupied by the spacing between the (nano)composite active anode particles in the electrode and filled with electrolyte, exclusive of closed pores, if any, within the particles themselves that are inaccessible to electrolyte) becomes moderately small (e.g., about 25-35 vol. % after the first charge-discharge cycle) and more so when the porosity of the anode becomes small (e.g., about 5-25 vol. % after the first charge-discharge cycle) or when the amount of a binder and conductive additives in the electrode becomes moderately small (e.g., about 5-15 wt. %) and more so when the amount of the binder and conductive additives in the electrode becomes small (e.g., about 0.5-5 wt. %). Higher electrode density and lower binder and conductive additive content, however, are advantageous for increasing cell energy density and reducing cost. Lower binder content may also be advantageous for increasing cell rate performance.

Examples of materials that exhibit moderately high-volume changes (e.g., about 8-180 vol. %) during the first charge-discharge cycle and moderate volume changes (e.g., about 5-50 vol. %) during the subsequent charge-discharge cycles include (nano)composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorous, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

In certain types of rechargeable batteries, high concentrations (e.g., about 1.3 M or greater) of salt or salts may be used to improve the battery performance. For example, high concentrations may be used to improve the passivation of the anode or cathode by surface passivation layers (SEI or CEI respectively), thereby extending cell lifetime. High concentrations of salt(s) may also be used to reduce the added resistance from the SEI and CEI, thereby reducing the cell resistance, particularly at lower temperatures (<15° C.). High concentrations of salt(s) may also be used to reduce the unwanted gas generation at high temperatures (>40° C.), high cell voltages (>4.0V), and at the end of life. High concentrations of salt(s) may also be used to passivate metal current collector foils against corrosion. Unfortunately, high salt concentrations also have many drawbacks. High salt concentration may increase the viscosity of the electrolyte, increasing wetting time during battery cell manufacturing (thereby increasing manufacturing cost) and decreasing conductivity and diffusivity of the electrolyte (thereby decreasing battery rate capability and increasing cell resistance). Some salts are more expensive than other battery materials and compounds, so high salt concentrations may drive up the cost of the battery cell. Some salts are more dense than other battery materials and compounds, so high salt concentrations may increase the density of the electrolyte, thereby decreasing the mass-based gravimetric energy density of the battery.

Localized high concentration electrolytes (L-HCEs) may mitigate the negative effects of high salt concentration through the use of a diluent. Herein, an L-HCE may be referred to as an “electrolyte” for brevity. A diluent is a solvent which does not coordinate the Li⁺ ion of the salt(s). In most cases, diluents are solvents in which the salt(s) have low-to-negligible solubility. For example, solubility of less than about 0.3 M may be referred to as low-to-negligible solubility. The diluent reduces the viscosity of the electrolyte, while maintaining strong interactions between the salt(s) and the other non-diluent co-solvent(s), in which the salt(s) have high solubility. For example, solubility of greater than about 2 M may be referred to as high solubility. The effect of strong interactions between the salt(s) and/or the other non-diluent co-solvent(s) may be similar to what is observed at high salt concentrations. In some cases, the diluent may also passivate the anode, cathode, and/or metal (e.g., current collector metal foil) surfaces against unwanted side reactions. Diluents may also lower the density of the electrolyte. Unfortunately, even with the use of a diluent, the conductivity of the conventional (or explored in relevant cells or form factors) L-HCEs is typically too low for most practical applications, thereby their applications would lower cell rate capability, require reduced electrode mass loading (and hence reduce volumetric energy density and gravimetric energy density), decrease roundtrip energy efficiency, and increase cell internal resistance and heat generation.

Accordingly, careful design and improvement of the electrolyte, battery electrodes, manufacturing processes, and cell usage specifications is necessary.

### SUMMARY

Embodiments disclosed herein address some or all of the above stated needs by providing improved electrolytes, batteries, components, and other related materials and manufacturing processes.

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, an electrolyte includes a lithium salt composition; a solvent composition; and a diluent composition, wherein: the diluent composition comprises at least one alkane compound selected from (1) non-fluorinated alkane compounds characterized by a first molecular formula CₚH₂ₚ₊₂, in which p is a first integer between 5 and 20, and (2) fluorinated alkane compounds characterized by a second molecular formula C_{q}H_{q1}F_{q2}, in which q is a second integer between 4 and 20, q₁ is a third positive integer, and q₂ is a fourth positive integer, q, q₁, and q₂ being related by q₁+q₂=2q+2.

In an aspect, an electrolyte includes a lithium salt composition; a solvent composition; and a diluent composition, wherein: the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

One aspect is directed to a lithium-ion battery, including an anode current collector, a cathode current collector, an anode disposed on and/or in the anode current collector, a cathode disposed on and/or in the cathode current collector, and an electrolyte ionically coupling the anode and the cathode. In some embodiments, the electrolyte includes (1) a lithium salt composition, (2) a solvent composition, and (3) a diluent composition. In some embodiments, the anode includes composite particles including carbon and silicon, wherein the composite particles include pores and at least some of the silicon is nanosized silicon in the pores.

Another aspect is directed to a battery pack or a device that utilizes at least one of such a lithium-ion battery.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode, the electrolyte comprising (1) a lithium salt composition and (2) a solvent composition, and (3) a diluent composition, wherein: the anode comprises composite particles comprising carbon and silicon, at least some of the silicon being nanosized silicon in the composite particles; the diluent composition comprises at least one aromatic compound and/or at least one alkane compound; and the at least one alkane compound is selected from (1) non-fluorinated alkane compounds characterized by a first molecular formula CₚH₂ₚ₊₂, in which p is a first integer between 5 and 20 (e.g., in some designs, between 7 and 20), and (2) fluorinated alkane compounds characterized by a second molecular formula C_{q}H_{q1}F_{q2}, in which q is a second integer between 4 and 20 (e.g., in some designs, between 6 and 20), q₁ is a third positive integer, and q₂ is a fourth positive integer, q, q₁, and q₂ being related by q₁+q₂=2q+2.

In some aspects, the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

In some aspects, the at least one alkane compound comprises two or more of the non-fluorinated alkane compounds and/or the fluorinated alkane compounds.

In some aspects, the at least one alkane compound is selected from heptanes (C₇H₁₆), octanes (C₈H₁₈), nonanes (C₉H₂₀), fluoroheptanes (C₇H₁₅F), difluorooctanes (C₈H₁₆F₂), and fluorononanes (C₉H₁₉F).

In some aspects, a mole fraction of the lithium salt composition in the electrolyte is in a range of 10 mol. % to 20 mol. %.

In some aspects, the lithium salt composition comprises a salt compound selected from lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li₃PS₄, Li₆PS₅Cl, lithium tris(fluorosulfonyl)methide (LTFSM), lithium bis(oxalate)borate (LiBOB), lithium tetracyanoborate (LiBison), lithium dicyano-trifluoromethyl-imidazole (LiTDI), lithium dicyano-pentafluoroethyl-imidazole (LiDPI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), and lithium cyclo-hexafluoropropane-1,1-bis(sulfonyl)imide (Li HPSI).

In some aspects, the lithium salt composition comprises two or more salt compounds.

In some aspects, the electrolyte comprises at least one non-Li salt compound.

In some aspects, the solvent composition comprises vinylene carbonate (VC), a mole fraction of the VC in the electrolyte being in a range of about 0.05 to about 2.00 mol. %.

In some aspects, the solvent composition comprises fluoroethylene carbonate (FEC), a mole fraction of the FEC in the electrolyte being in a range of about 0.1 to about 20 mol. %.

In some aspects, the solvent composition comprises a linear ester, a cyclic ester, and/or a branched ester.

In some aspects, the solvent composition comprises a ketone selected from: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA).

In some aspects, the solvent composition comprises an ether selected from: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (DME), and diethoxyethane.

In some aspects, the solvent composition comprises a nitrile selected from acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), and 1,3,6-hexanetricarbonitrile (HTCN).

In some aspects, the solvent composition comprises an amide selected from dimethylacetamide (DMAc), hexamethylphosphoramide (HMPA), N,N-dimethyl trifluoromethanesulfonamide (DMTMSA), N,N-diethyl trifluoromethanesulfonamide, N,N-dimethyl fluorosulfonamide, and carbamides.

In some aspects, the solvent composition comprises a nitroalkane selected from nitromethane (NM), nitroethane (NE), trinitromethane, tetranitromethane, 2-nitropropane (2NP), 1-nitropropane (1-NP), dinitromethane, hexanitroethane (HNE), and heptanitrocubane (HNC).

In some aspects, the solvent composition comprises a phosphate selected from trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate.

In some aspects, the solvent composition comprises a phosphite selected from tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite.

In some aspects, the solvent composition comprises a sulfite selected from dimethyl sulfite (DMS), trimethylene sulfite, and ethylene sulfite (ESi).

In some aspects, the solvent composition comprises a sulfone selected from ethyl methyl sulfone, ethyl isopropyl sulfone, dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), sulfolane, and phenyl vinyl sulfone.

In some aspects, the solvent composition comprises a sulfonamide selected from 2-methyl-5-(methylsulfonyl)benzenesulfonamide, N,N-dimethyl trifluoromethanesulfonamide (DMTMSA), and N,N-dimethyl fluorosulfonamide.

In some aspects, the solvent composition comprises a boron (B)-comprising compound selected from pyridine-boron trifluoride (PBF), 3-fluoro pyridine-boron trifluoride (3F-PBF), pyrazine-boron trifluoride, and borate esters.

In some aspects, the solvent composition comprises a silicon (Si)-comprising compound selected from siloxanes and silanes.

In some aspects, the diluent composition comprises fluorinated ether selected from 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether, tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane.

In some aspects, the diluent composition comprises one or more amines selected from trimethylamine, triethylamine, tripropylamine, di-isopropylamine, perfluorotriethylamine ((CF₃CF₂)₃N), perfluoromethyldiethylamine ((CF₃CF₂)₂CF₃N), perfluoroethyldimethylamine (CF₃CF₂)₁(CF₃)₂N), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), and 2,2,2-trifluoro-1-phenylethylamine (C₈H₈F₃N).

In some aspects, the solvent composition comprises one or more amines selected from methylamine, fluoromethylamine, trifluoromethylamine, difluoroethylamine, and diethylamine.

In some aspects, the solvent composition comprises one or more sulfonyl fluorides selected from 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, ethane sulfonyl fluoride, propane sulfonyl fluoride, butane sulfonyl fluoride, and sulfonyl fluoride compounds characterized by a third molecular formula CₓH_{y}F_{Z} SO₂F in which x is a fifth integer between 1 and 6, each of y and z is respectively a sixth integer and a seventh integer, x, y, and z being related by y+z=2x+1.

In some aspects, the solvent composition comprises one or more linear carbonates selected from dimethyl carbonate (DMC), ethyl methyl carbonate (EMC), and diethyl carbonate (DEC).

In some aspects, a mass of the silicon is in a range of about 10 wt. % to about 90 wt. % of the anode (not counting the anode current collector).

In some aspects, the anode additionally comprises graphite particles.

In some aspects, the anode additionally comprises carbon nanotubes or carbon black particles.

In some aspects, the anode current collector comprises copper.

In some aspects, the cathode current collector comprises aluminum.

In some aspects, the lithium-ion battery is operated at a temperature in a range of about 40 to about 90° C., and the lithium-ion battery is configured for propulsion of an automobile.

In some aspects, the first integer is between 7 and 20, and the second integer is between 6 and 20.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the electrolytes, components, materials, methods, and other techniques described herein may be implemented.

FIG. 2 illustrates a few examples of compounds suitable for use in described Li-ion battery electrolytes, including lithium bis(fluorosulfonyl)imide (202), dimethyl carbonate (204), ethyl propionate (206), 1,1,2,2-tetrafluoroethyl-2,2,3,3-tetrafluropropyl ether (208), n-heptane (210), trifluorotoluene (212), and cyclohexane (214).

FIG. 3 shows Table 1 with illustrative examples of combinations of primary salts and solvents in which the respective primary salts are soluble in the respective solvents at a molar ratio (primary salt:solvent) of 1:2.

FIG. 4 shows a Table 2 showing compositions of example electrolytes ELYs #1, #2, and #3. ELY #1 is an example electrolyte that does not contain any diluents. ELYs #2 and #3 are illustrative examples of L-HCE compositions comprising fluorobenzene (FB) and heptane, respectively.

FIG. 5 illustrates the results of high-temperature storage (HT storage) tests performed on ELYs #1-3, including graphical plots of the following battery cell performance characteristics: volume change (502), first-cycle efficiency (FCE) (504), change in internal resistance (AR) (506), residual capacity (508), and recoverable capacity (510).

FIG. 6 shows a Table 3 showing compositions of example electrolytes ELYs #4, #5, #6, #7, #8, #9, and #10, which are illustrative examples of L-HCE compositions and electrolytes comprising respective co-solvents and diluents.

FIG. 7 illustrates the results of high-temperature storage (HT storage) tests performed on ELYs #4-10, including graphical plots of the following battery cell performance characteristics: volume change (702), first-cycle efficiency (FCE) (704), change in internal resistance (AR) (706), residual capacity (708), and recoverable capacity (710).

FIG. 8 shows a Table 4 showing the respective additional co-solvents or diluents used in ELYs #11-36.

FIG. 9 shows the results of cycle life testing on lithium ion battery test cells comprising example electrolytes ELYs #11-31 and #36 including the following battery cell performance characteristics: estimated cycle life (902), discharge voltage (expressed in V) (904), and first-cycle efficiency (FCE) (906).

FIG. 10 shows a Table 5, showing the conductivities of ELYs #11, #12, #16-22, #24, and #32-35 at 0° C. and at 25° C.

FIG. 11 shows the first-cycle efficiency (FCE) data of lithium ion battery test cells comprising ELY #37-43, respectively.

FIG. 12 shows a Table 6 showing the respective boiling points of certain co-solvents or diluents.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and—60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . 0%). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

| Material | Property | Measurement | |
|---|---|---|---|
| Type | Type | Instrumentation | Measurement Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, the |
| | | | charge and discharge |
| | | | currents may be constant and |
| | | | often have absolute values |
| | | | that are the same or close to |
| | | | each other. It should be |
| | | | understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial Vapor | Manometer | The partial vapor pressure of |
| Material | Pressure | | an active material in a |
| | (e.g., Torr.) | | mixture (e.g., composite |
| | at a | | particle) at a particular |
| | Temperature | | temperature is given by the |
| | (e.g., K) | | known vapor pressure of the |
| | | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at a |
| | | | constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger |
| | (e.g., nm) | transmission | particles and larger pores) in |
| | | microscope (STEM), | combination with image |
| | | laser microscope, | analyses, optical microscopy |
| | | Synchrotron X-ray, | (for larger particles and |
| | | X-ray microscope | larger pores), neutron |
| | | | scattering, X-ray scattering, |
| | | | X-ray microscopy imaging may |
| | | | be employed to measure |
| | | | pore sizes (average pore size |
| | | | or pore size distribution) in |
| | | | different size ranges (in |
| | | | addition to the analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer and comparing |
| | | | them to the theoretical |
| | | | density of the individual |
| | | | material components present |
| | | | in Si-comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced by |
| | (e.g., nm) | | a solid can be determined. |
| Active | Size | TEM, STEM, SEM, | Laser particle size |
| Material | (e.g., nm, μm, | X-Ray, PSA, etc. | distribution analysis (LPSA), |
| Particle | etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: A wt. % change may |
| Material | (e.g., mass | | be calculated by comparing |
| Particle | fraction or | | the mass fraction of a |
| | wt. %, mg, | | material in the particle |
| | number of | | relative to the total particle |
| | atoms, etc.) | | mass. |
| | | | Note #2: The capacity |
| | | | attributable to particular |
| | | | active material(s) in the |
| | | | particle may be derived from |
| | | | the composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be |
| | | | characterized by a number of |
| | | | atoms of a particular element |
| | | | (e.g., Fe, F, C, etc.). In case of |
| | | | atoms, the number of atoms |
| | | | may be estimated from the |
| | | | weight of that atom in the |
| | | | particle (e.g., based on gas |
| | | | chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or at. | Dispersive | |
| | % of various | Spectroscopy | |
| | elements, | (WDS), Electron | |
| | etc.) | Energy Loss | |
| | | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a |
| Material | (e.g., m²/g) | | sealed chamber at 77K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead to |
| | | | more precise measurements, |
| | | | in some experiments). Using |
| | | | LPSA, particle size |
| | | | parameters of a population's |
| | | | PSD may be measured, such |
| | | | as: a tenth-percentile |
| | | | volume-weighted particle |
| | | | size parameter (e.g., |
| | | | abbreviated as D10), a |
| | | | fiftieth-percentile volume- |
| | | | weighted particle size |
| | | | parameter (e.g., abbreviated |
| | | | as D50), a ninetieth- |
| | | | percentile volume-weighted |
| | | | particle size parameter (e.g., |
| | | | abbreviated as D90), and a |
| | | | ninety-ninth-percentile |
| | | | volume-weighted particle |
| | | | size parameter (e.g., |
| | | | abbreviated as D99). |
| Active | Width (e.g., | PSA | Parameters relating to |
| Material | nm) | | characteristic widths of the |
| Particle | | | PSD may be derived from |
| Population | | | these particle size |
| | | | parameters, such as D50- |
| | | | D10 (sometimes referred to |
| | | | herein as a left width), D90- |
| | | | D50 (sometimes referred to |
| | | | herein as a right width), and |
| | | | D90-D10 (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET SSA | BET Isotherm | obtained from the data of |
| Material | (e.g., m²/g) | | nitrogen sorption-desorption |
| Particle | | | at cryogenic temperatures, |
| Population | | | such as about 77K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by the |
| | | | mass of the constituents |
| | | | divided by the density. The |
| | | | molar mass of the salt is then |
| | | | used to calculate the total |
| | | | number of moles of salt in the |
| | | | solution. The moles of salt is |
| | | | then divided by the total |
| | | | volume to obtain the solvent |
| | | | concentration in M (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by the |
| | | | mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume to |
| | | | obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being mixed |
| | | | into a slurry to estimate their |
| | | | mass in a casted electrode. |
| | | | The mass of materials |
| | | | deposited onto the casted |
| | | | electrode may be measured |
| | | | by comparing the weight of |
| | | | the casted electrode |
| | | | before/after the material |
| | | | deposition. |
| Electrode | Areal Binder | balance | A mass fraction of the binder |
| | Loading (e.g., | | in the battery electrode, |
| | mg/m²) | | divided by a product of (1) a |
| | | | mass fraction of the active |
| | | | material (e.g., Si-C |
| | | | nanocomposite, etc.) |
| | | | particles in the battery |
| | | | electrode, and (2) a |
| | | | Brunauer-Emmett-Teller |
| | | | (BET) specific surface area of |
| | | | the active material particle |
| | | | population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow is |
| | | | opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from the |
| | | | material of interest until the |
| | | | cell voltage reaches an |
| | | | appropriate limit. Then, the |
| | | | process is reversed until a |
| | | | second voltage limit is |
| | | | reached, and the charge |
| | | | passed in both steps is used to |
| | | | calculate the Coulombic |
| | | | Efficiency, as described |
| | | | above. |
| Battery Cell | Rate | Potentiostat | This is the time it takes to |
| | Performance | | charge or discharge a battery |
| | | | between a given state of |
| | | | charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode is |
| | Voltage (e.g., | | charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of |
| | | | current to the battery cell |
| | | | and recording the |
| | | | instantaneous change in cell |
| | | | voltage. |
| Any Liquid | Surface | Surface Tensiometer | Surface Tension in mN/m |
| | Tension | (e.g., Bubble | may be measured at room |
| | | Pressure | temperature |
| | | Tensiometer) | |
| Any Liquid | Viscosity (cP) | Viscometer(e.g., | Viscosity of a liquid may be |
| | | Brookfield | measured at room |
| | | Viscometer) | temperature |

### Table of Techniques and Instrumentation for Material Property Measurements

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline-ion batteries, flow batteries, etc.) as well as electrochemical capacitors and hybrid energy storage devices.

While the description below may describe certain examples with reference to battery electrode compositions, the state of the battery electrode compositions may be in different forms at different stages of manufacture. Generally, the battery electrode composition refers to a plurality of active material particles, such as composite active material particles (e.g., Si—C nanocomposite particles), graphite particles, and so on. Before being mixed into a slurry, the active material particles of the battery electrode composition may be in the form of a dry powder. After being mixed into the slurry, the active material particles of the battery electrode composition may be suspended in a slurry suspension (e.g., along with other electrode components such as a binder, conductive additives, etc.). After the slurry is casted onto a current collector to form an electrode, the slurry is dried (solvent evaporation) and the active material particles of the battery electrode composition are bound together via a binder. After being sealed in a battery cell with other components such as electrolyte, the active material particles may store/release Li-ions during battery operation.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

In some embodiments described below, certain parameters (e.g., temperature, state-of-charge (SOC), etc.) are defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

In one or more embodiments of the present disclosure, a preferred battery cell may include a lithium cobalt oxide (LCO), lithium nickel cobalt manganese oxide (NCM), lithium nickel cobalt aluminum oxide (NCA), lithium nickel cobalt manganese aluminum oxide (NCMA), lithium nickel oxide (LNO) (e.g., doped LNO or LNO with 15-2 at. % of Ni metal substituted by other metals or semimetals, including but not limited to one, two or more of the following: Co, Mn, Al, W, Nb, Ti, Ta, Mg, Sn, Si, Cr, Hf, Mo, Zr, Y, La, among others), lithium manganese oxide (LMO) or lithium nickel manganese oxide (LNMO) (in some designs, as high voltage spinel) as a cathode active material. In other embodiments, preferred battery cell designs may comprise one or more of the following cathodes: lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium-excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂ and many others), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.). It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

In some of the preferred examples a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with one or more layers of ceramic material having a distinctly different composition or microstructure. Illustrative examples of a preferred coating material for a preferred active cathode material may include, but are not limited to metal oxides that comprise one or more of the following metals: Ti, Al, Mg, Sr, Li, Si, Sn, Sb, Nb, W, Cr, Mo, Hf, Ta, B, Y, La, Ce, Zn, and Zr. Illustrative examples of a preferred coating material for such cathodes include, but are not limited to, various oxy-fluorides and oxides, such as titanium oxide (e.g., TiO₂), aluminum oxide (e.g., Al₂O₃), tungsten oxide (e.g., WO), molybdenum oxide (e.g., MoO or MoO₂), chromium oxide (e.g., Cr₂O₃), niobium oxide (e.g., NbO or NbO₂) and zirconium oxide (e.g., ZrO₂), magnesium oxide (e.g., MgO), silicon oxide (e.g., SiO₂), boron oxide (e.g., B₂O₃), lanthanum oxide (La₂O₃), zirconium oxide (e.g., ZrO₂) and other suitable metal or mixed metal oxides and their various mixtures and alloys. In some designs, such ceramic materials may additionally comprise lithium (Li)—e.g., as lithium titanium oxide (or oxyfluoride), lithium aluminum oxide (or oxyfluoride), lithium tungsten oxide (or oxyfluoride), lithium chromium oxide (or oxyfluoride), lithium niobium oxide (or oxyfluoride), lithium zirconium oxide (or oxyfluoride) and their various alloys, mixtures and combinations.

In other preferred examples, LCO, NCM, NCMA, NCA, LFP, LMFP, LMP, LMO or LMNO may be doped with one or more of Al, Ti, Mg, Nb, Zr, Cr, Hf, Ta, W, Mo, La or other metals described above. In some designs, a preferred cathode current collector may comprise aluminum or an aluminum alloy. In some designs, a preferred battery cell may include a polymer separator, a polymer-ceramic composite separator or a ceramic separator. In some designs, such a separator may be stand-alone or may be integrated into an anode or cathode or both. In some designs, a polymer separator may comprise or be made of polyethylene, polypropylene, or a mixture thereof. In some of the preferred examples a surface of a polymer separator may be coated with a layer of ceramic material. Examples of a preferred coating material for polymer separators may include, but not limited to titanium oxide (TiO₂), aluminum oxide (Al₂O₃), aluminum hydroxide or oxyhydroxide, magnesium oxide (MgO) or magnesium hydroxide or oxyhydroxide, silicon oxide (SiO₂), zirconium oxide (ZrO₂) and their various mixtures and alloys.

In some designs, the cathode may advantageously comprise high Li-capacity materials (e.g., materials with the first cycle specific and/or volumetric de-lithiation capacities higher (e.g., about 10%—about 600% higher) than that of LCO, NCM, NCMA, NCA, LFP, LMFP, LMP, LMO, LMNO or other primary active cathode materials used in the Li-ion battery design), which exhibit high irreversible Li capacity (e.g., in some designs, about 30% or higher irreversible Li capacity; in other designs, 50% or higher irreversible Li capacity; in other designs, 70% or higher irreversible Li capacity; in other designs, 80% or higher irreversible Li capacity) when the Li-ion battery is cycled in a typical voltage range. Such materials (which may be called high Li capacity cathode additives) may be added to cathode in order to provide more Li to compensate for irreversible Li losses in the anode during formation cycling. In some designs, the use of such materials may require a higher charging voltage (e.g., from about 0.1V to about 1V higher—e.g., about 0.1-0.2V higher or 0.2-0.4V higher or about 0.4-0.6V higher or about 0.6-0.8V higher or about 0.8-1 V higher) during the first charge (or any other charge during the so-called “formation”) compared to charging during regular battery use. In some designs, suitable materials with such high irreversible Li capacity may be produced by combining Li₂O with a suitable (in some designs, amphoteric; in some designs, Fe or Fe-comprising or Ni or Ni-comprising or Mn or Mn-comprising or Zn or Zn-comprising) metal or metal oxide or by reacting Li₂O with amphoteric transition metal oxides (e.g., oxides of Fe, Ni, Zn, Al, Mn, Cu, etc.) or oxides of semimetals or nonmetals (e.g., Si, C, P, B, S, Se, etc.) (in other words, with oxides that possess acidic properties when reacted with basic Li₂O). In some designs, suitable materials with such high irreversible Li (single-use cathodes that may exhibit small reversible Li capacity when cycled in a regular Li-ion battery cycling regime) may comprise carbon (e.g., Li₂C₂O₄) or sulfur (e.g., Li₂S) or iron (e.g., Li₅FeO₄ or Li₄FeO_{3.5} or Li₃FeO_{3.5} or Li₂FeO₃, etc.) or nickel (e.g., Li₂NiO₂, etc.) or vanadium (e.g., Li₃V₂O₅, etc.) or other lithium transition metal oxides or their various combinations (note—in some designs, these may comprise various dopants).

One or more aspects are directed to a battery electrode (e.g., anode) composition comprising a population of Si-comprising particles. Illustrative examples of suitable Si-comprising active material particles (e.g., preferably for use in Li-ion battery anodes) include, but are not limited to: simple (e.g., approximately uniform or relatively low spatial variation) composition of silicon-comprising particles, silicon particles, particles comprising silicon nanoparticles having average size in a range from about 1 nm to about 10 nm or from about 10 nm to about 50 nm or from about 50 nm to about 100 nm or from about 100 nm to about 500 nm, doped or heavily doped silicon comprising particles, particles comprising amorphous material, particles comprising nanocrystalline material, particles comprising amorphous silicon, particles comprising amorphous silicon or silicon-comprising nanoparticles, particles comprising nanocrystalline silicon or silicon-comprising particles, particles comprising silicon nanoparticles surrounded by oxygen-rich matrix material, particles comprising silicon nanoparticles surrounded by lithium-comprising matrix material, particles comprising silicon nanoparticles surrounded by magnesium-comprising matrix material, particles comprising silicon nanoparticles surrounded by aluminum-comprising matrix material, particles comprising silicon nanoparticles surrounded by iron-comprising matrix material, particles comprising silicon nanoparticles surrounded by carbon, carbon-rich or carbon-containing matrix material, particles comprising silicon nanoparticles surrounded by nitrogen-rich or nitrogen-containing matrix material, polymer comprising particles, electrically semiconductive or conductive polymer comprising particles, ionically conductive polymer comprising particles, silicon carbide comprising particles, silicon oxide (SiOₓ; where 0<x<2) comprising particles, silicon nitride comprising particles, silicon phosphide comprising particles, silicon hydride comprising particles, silicon alloy (with one, two, three, four or more non-Si metals or semimetals) comprising particles, silicon-magnesium alloy comprising particles, silicon-aluminum alloy comprising particles, silicon-tin alloy comprising particles, silicon-zinc alloy comprising particles, silicon lithium oxide (e.g., with a composition of SiLi_{y}Oₓ; where 0<x<7; 0<y<6; e.g., Li₂SiO₃, Li₆Si₂O₇, Li₂Si₂O₅, Li₄SiO₄, among others) comprising particles, lithium silicate comprising particles, magnesium silicate comprising particles, silicon magnesium oxide (e.g., with a composition of SiMg_{y}Oₓ; where 0<x<4; 0<y<1.5) comprising particles, aluminum silicon oxide comprising particles, aluminum silicate comprising particles, silicon sulfide comprising particles, oxidized silicon sulfide comprising particles, particles comprising carbon-coated or carbon-decorated silicon, particles comprising silicon carbide-coated or silicon carbide-decorated silicon, particles comprising silicon oxide-coated silicon, particles comprising silicon oxide-decorated silicon, particles comprising silicon nitride-coated silicon, particles comprising silicon nitride-decorated silicon, core-shell particles, particles with composite shells, particles with shells comprising two or more distinct layers, particles with composite coating(s) around at least some of the silicon surface, particles with layered coating(s) around at least some of the silicon surface, dense (non-porous) particles, porous particles, microporous particles, mesoporous particles, macroporous particles, particles with internal (not accessible by nitrogen gas during nitrogen sorption measurements) pores (e.g., micropores (about sub-2 nm), mesopores (about 2-50 nm) or macropores (>about 50 nm) or their various combinations, size distributions and relative volume ratios, as determined from nitrogen sorption measurements, neutron scattering, electron microscopy, and other related techniques), particles with external (accessible by nitrogen gas during nitrogen sorption measurements) pores (e.g., micropores, mesopores or macropores or their various combinations, size distributions and relative volume ratios, as determined from nitrogen sorption measurements, neutron scattering, electron microscopy, and other related techniques), porous silicon-comprising particles, composite particles, nanocomposite particles, nanocomposite particles that comprise both silicon and carbon atoms, nanocomposite particles with the total wt. % of Si and C in the range from about 75% to about 100%, particles with specific reversible electrochemical lithium storage capacity in a range from about 400 to about 700 mAh/g or from about 700 to about 1000 mAh/g or from about 1000 to about 1400 mAh/g or from about 1400 to about 1700 mAh/g or from about 1700 to about 2000 mAh/g or from about 2000 to about 2400 mAh/g or from about 2400 to about 3000 mAh/g or from about 3000 to about 3700 mAh/g, as determined by electrochemical measurements in liquid electrolytes at room temperature; nanocomposite particles comprising silicon nanoparticles within carbon pores, particles comprising carbon on their surface, particles comprising polymers on their surface, particles comprising carbon-coated silicon, particles with more than one distinct coatings, particles with more than one distinct coatings on the silicon surface, milled particles, irregularly-shaped particles, spherical or spheroidal particles, round particles, jagged particles, flattened particles, planar particles, elongated particles, fiber-shaped particles and particles with various combinations, variations and mixtures of such compositions, features and properties, among others.

In some designs, a preferred battery cell may include a silicon-comprising nanocomposite (particles) (including, but not limited to the nanocomposite comprising both silicon and carbon) (note that as used herein, a nanocomposite or (nano)composite is at least partially comprised of active material nanomaterials or nanostructures or nanoparticles, irrespective of whether the nanocomposite or (nano)composite itself is a nanomaterial) or silicon oxide (SiOₓ) or silicon nitride or natural or synthetic graphite or soft carbon or hard carbon or their various mixtures and combinations in its anode composition. Also note that silicon-comprising and carbon-comprising nanocomposite particles are referred to herein as Si—C composite or Si—C nanocomposite particles, even if such particles comprise elements other than Si and C in relatively small quantities of less than about 10-25 at. %.

In some of the preferred examples, the anode material includes a mixture of silicon-comprising active materials (e.g., Si—C nanocomposite (particles) or other suitable Si-comprising particles) and graphite (e.g., the graphite being separate from the C-part of the Si—C nanocomposite). In some implementations, a Si—C nanocomposite comprises composite particles, which may include Si nanoparticles embedded in pores of a porous carbon or porous carbon-comprising scaffold particle. Such a porous carbon scaffold particle can comprise graphene material (including, but not limited to highly curved and highly defective graphene) and/or graphite material. In some designs, a preferred anode current collector may comprise copper or copper alloy.

In some of the preferred examples, the battery anode composition comprises a population of Si-comprising particles (e.g., nanocomposite particles, among others), in which each of the Si particles comprises silicon (Si) and carbon (C) elements and may comprise other elements, such as nitrogen (N), phosphorus (P), boron (B), oxygen (O), hydrogen (H), sulfur (S), to name a few. In some embodiments, the total mass of the Si and the C (on average) may contribute from about 75 wt. % to about 100 wt. % of the total mass of the Si-comprising particles (as in Si—C composites and nanocomposites). In some embodiments, the total mass of O may contribute (on average) from about 0 wt. % to about 10 wt. % of the total mass of the Si-comprising particles (in some designs, from about 0 wt. % to about 1 wt. %; in other designs, from about 1 wt. % to about 2.5 wt. %; in other designs, from about 2.5 wt. % to about 5 wt. %; in other designs, from about 5 wt. % to about 10 wt. %;). In some embodiments, the total mass of O may contribute (on average) to less than about 5 wt. % of the total mass of the Si-comprising particles. In some embodiments, the total mass of N may contribute (on average) from about 0 wt. % to about 10 wt. % of the total mass of the Si-comprising particles (in some designs, from about 0 wt. % to about 0.1 wt. %; in other designs, from about 0.1 wt. % to about 2 wt. %; in other designs, from about 2 wt. % to about 5 wt. %; in yet other designs, from about 5 wt. % to about 10 wt. %). In some embodiments, the total mass of P may contribute (on average) from about 0 wt. % to about 10 wt. % of the total mass of the Si-comprising particles (in some designs, from about 0 wt. % to about 0.1 wt. %; in other designs, from about 0.1 wt. % to about 1 wt. %; in other designs, from about 1 wt. % to about 5 wt. %; in yet other designs, from about 5 wt. % to about 10 wt. %). In some embodiments, the total mass of B may contribute (on average) from about 0 wt. % to about 5 wt. % of the total mass of the Si-comprising particles (in some designs, from about 0 wt. % to about 0.1 wt. %; in other designs, from about 0.1 wt. % to about 2.5 wt. %; in yet other designs, from about 2.5 wt. % to about 5 wt. %). In some embodiments, the total mass of H may contribute (on average) from about 0 wt. % to about 2 wt. % of the total mass of the Si-comprising particles (in some designs, from about 0 wt. % to about 0.5 wt. %; in other designs, from about 0.5 wt. % to about 1 wt. %; in yet other designs, from about 1 wt. % to about 2 wt. %). In some embodiments, the total mass of S may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %).

In some embodiments, a total atomic fraction of the Si and the C may contribute from about 75 at. % to about 100 at. % of the overall Si—C composite particles. In some embodiments, such composite particles comprise nano-sized or nanostructured elements (e.g., nano-sized or nanostructured Si, nano-sized or nanostructured C), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques.

An aspect is directed to a battery anode composition comprising a population of Si-comprising particles (e.g., nanocomposite particles, among others), in which each of the particles comprises Si and C, and the Si-comprising particles have certain characteristics. In some embodiments, a mass fraction of the silicon in the Si-comprising particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %). In some embodiments, a Brunauer-Emmett-Teller (BET) specific surface area (SSA) of the Si-comprising particles (e.g., nanocomposite particles, among others) is in a range of about 0.5 m²/g to about 150 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 150 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode composition comprising a population of Si-comprising particles, in which the particle population of may be characterized by a particle size distribution (PSD) as determined by laser particle size distribution analysis (LPSA), image analysis of electron microscopy images, or other suitable techniques. The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₉₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), and D₉₀−D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 μm to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at about 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at about 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at 2 about 0 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at about 30 μm, may advantageously be about 99 vol. % or less, or about 95 vol. % or less, or about 90 vol. % or less, or about 85 vol. % or less, or about 80 vol. % or less.

Note that in some designs the presence of excessively large Si-comprising particles (e.g., Si—C nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at about 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 35 μm, may advantageously be about 90 vol. % or more, or about 95 vol. % or more, or (in some designs) even about 98 vol. % or more. In other embodiments (e.g., when the D₅₀ is in a range from about 8.0 μm to about 16.0 μm), the cumulative volume fraction, with the threshold particle size at about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at about 50 μm, may advantageously be about 90 vol. % or more, or about 95 vol. % or more, or (in some designs) even about 98 vol. % or more.

In one or more embodiments of the present disclosure, Si-comprising active material (composite) particles may exhibit true density (e.g., as measured by using an argon gas pycnometer) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material (composite) particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising particles)—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising composite particles) may range from about 0.00 cc/g to about 1.00 cc/g—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm—in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material (composite) particles may exhibit moderate (e.g., about 7-120 vol. %) or high (e.g., about 120-200 vol. %) volume changes during initial lithiation (e.g., down to around 0.01 V vs. Li/Li⁺). In some designs, Si-comprising active material (composite) particles may exhibit volume changes in the range from about 8 vol. % to about 180 vol. % during one or more charge-discharge cycles of the battery cell. In one or more embodiments of the present disclosure, Si-comprising active material (composite) particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation. In one or more embodiments of the present disclosure, Si-comprising active material (composite) particles may exhibit reversible capacity for Li storage in the range from about 1400 to about 2800 mAh/g (e.g., about 1400-1600 mAh/g or about 1600-1800 mAh/g or about 1800-2000 mAh/g or about 2000-2400 mAh/g or about 2400-2800 mAh/g), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step). In one or more embodiments of the present disclosure, Si-comprising active material (composite) particles may exhibit first cycle lithiation capacity in the range from about 1600 to about 3000 mAh/g (e.g., about 1600-1800 mAh/g or about 1800-2000 mAh/g or about 2000-2200 mAh/g or about 2200-2400 mAh/g or about 2400-2600 mAh/g or about 2600-3000 mAh/g), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step). In one or more embodiments of the present disclosure, Si-comprising active material (composite) particles may exhibit first cycle “formation” losses in the range from about 6% to about 15% (e.g., about 6-8% or about 8-10% or about 10-12% or about 1²-15%), as measured at room temperature in half cells using a suitable charge-discharge protocol (e.g., when lithiated to about 0.01 V vs. Li/Li⁺ using a constant (e.g., C/10) current and a constant voltage (e.g., to C/50 current) steps and de-lithiated to about 1.50 V vs. Li/Li⁺) using a constant current (e.g., C/10) step).

In one or more embodiments of the present disclosure, a preferred battery cell may comprise a relatively high areal capacity loading in its electrodes (anodes and cathodes), such as from around 2.0 mAh/cm² to around 12 mAh/cm² (in some implementations, from about 2 to about 3.5 mAh/cm²; in other implementations, from about 3.5 to about 4.5 mAh/cm²; in other implementations, from about 4.5 to about 6.5 mAh/cm²; in other implementations, from about 6.5 to about 8 mAh/cm²; in other implementations, from about 8 to about 12 mAh/cm²).

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector. Moreover, as used here, an Li-free state is used to refer to a material that is free of electrochemically active Li, and other types of Li such as in electrochemically inactive compounds may (optionally) be part of such an Li-free material.

During battery (such as a Li-ion battery) operation, conversion materials change (convert) from one crystal structure to another (hence the name “conversion”-type, e.g., an electrochemical reaction). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

In one or more embodiments of the present disclosure, a preferred anode for a battery cell may comprise a mixture of Si—C nanocomposite (particles) (or, in some designs, other Si-comprising anode particles) and graphite (particles) as the anode active material, a so-called blended anode. In addition to the anode active material, an anode may comprise inactive material (separate from any inactive material that is made part of active material-comprising composite particles), such as binder(s) (e.g., polymer binder) and other functional additives (e.g., surfactants, electrically conductive additives). In some implementations, the anode active material can be in a range of about 90 wt. % to about 98 wt. % of the anode.

While the description below may describe certain examples of suitable intercalation-type graphites to be used in combination with Si—C nanocomposite or other Si-comprising particles in a blend, it will be appreciated that various aspects of this disclosure may be applicable to soft-type synthesis graphite, hard-type synthesis graphite, and pitch coat natural graphite; including but not limited to those which exhibit discharge capacity from about 350 to about 362 mAh/g; including but not limited to those which exhibit low, moderate and high swelling; including but not limited to those which exhibit good and poor compression, including but not limited to those which exhibit Brunauer-Emmett-Teller (BET) surface area of about 1 to about 4 m²/g; including but not limited to those which exhibit lithiation efficiency of about 90% and more; including but not limited to those which exhibit particle sizes from about 8 μm to about 18 μm; including but not limited to those which exhibit densities ranging from about 1.5 g/cm³ to about 1.8 g/cm³; including but not limited to those which exhibit poor, moderate, or good cycle life; including but not limited to those which are coated and comprise coatings with coating thickness to appreciably improve compression and springing during cycling, or any combination thereof.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium nickel manganese oxide (LNMO), lithium cobalt oxide (LCO), lithium cobalt aluminum oxides (LCAO), lithium iron phosphate (LFP), lithium manganese phosphate (LMP), lithium cobalt phosphate (LCP), lithium nickel phosphate (LNP), lithium manganese iron phosphate (LMFP), and other lithium transition metal (TM) oxide or phosphate or sulfate (or mixed) cathodes that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc. and their various mixtures). It will be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, Sn, Si, or Ge).

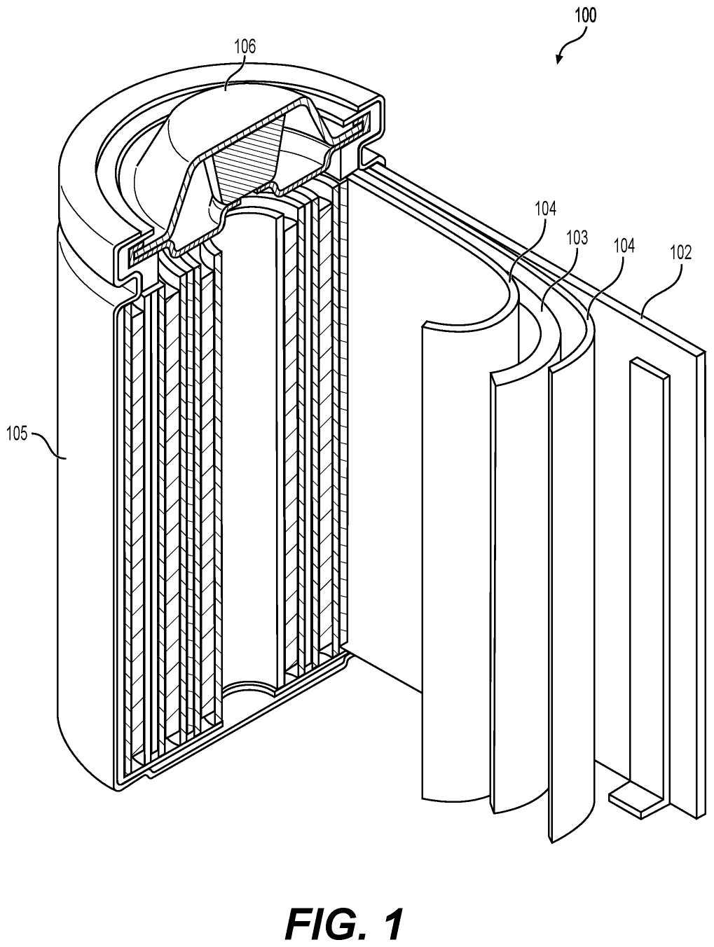

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). In some implementations, battery 100 also includes an anode current collector and a cathode current collector. The anode is disposed on and/or in the anode current collector and the cathode is disposed on and/or in the cathode current collector.

Li-ion battery electrolyte salts that are readily commercially available at scale include lithium hexafluorophosphate (LiPF₆), lithium tetrafluoroborate (LiBF₄), SO₂FN⁻(Li⁺)SO₂F (LiFSI), CF₃SO₂N⁻(Li⁺)SO₂CF₃ (LiTFSI), lithium trifluoromethanesulfonate (LiOTf), lithium bis(oxalato)borate (LiB(C₂O₄)₂) (LiBOB), lithium difluorophosphate (LFO), and lithium difluoro(oxalato)borate (LiBF₂(C₂O₄)) (LiDFOB). Other salts that may be less common, but may still be applicable include lithium perchlorate (LiClO₄), lithium fluorosulfate (LSF), lithium tris(fluorosulfonyl)methanide (LTFSM), lithium hexafluoroantimonate (LiSbF₆), lithium hexafluorosilicate (Li₂SiF₆), lithium hexafluoroaluminate (Li₃AlF₆), and various imides (CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others).

Electrodes utilized in Li-ion batteries are typically produced by (i) formation of a slurry comprising active materials, conductive additives, binder solutions and, in some cases, surfactant or other functional additives; (ii) casting the slurry onto and/or into a metal current collector foil (e.g., Cu foil for most anodes and Al foil for most cathodes); and (iii) drying the casted electrodes to completely evaporate the solvent.

Conventional anode materials utilized in Li-ion batteries are of an intercalation-type, whereby metal ions are intercalated into and occupy interstitial positions of such materials during the charge or discharge of a battery. Such anodes experience small or very small volume changes when used in electrodes. Polyvinylidene fluoride, also known as polyvinylidene difluoride (PVDF), and carboxymethyl cellulose (CMC) are the two most common binders used in these electrodes. Carbon black is the most common conductive additive used in these electrodes, followed by flakes of artificial graphite. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano)composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorous (P), boron (B) or other elements or be allowed with metals. In addition to Si-based composites, silicon oxides (SiOₓ) or oxynitrides (SiOₓN_{y}) or nitrides (SiN_{y}) or other Si element-comprising particles (including those that are partially reduced by Li or Mg) may reduce volume changes and improve cycle stability, although commonly at the expense of higher first cycle losses or faster degradation or both. In some designs, Si-comprising anode particles may exhibit high gravimetric capacities in the range from about 800 mAh/g to about 3000 mAh/g (per mass of Si-comprising anode particles in a Li-free state). Such high specific capacity is advantageous for attaining lighter batteries. However, Li-ion battery cells with anodes comprising high-capacity anode particles may exhibit undesirably fast degradation in conventional electrolytes, particularly at elevated temperatures (e.g., at or above battery operating temperature, e.g., above about 50-80° C.) or when charged to high voltages (e.g., above about 4-4.3 V). In some designs, a subset of anodes with Si-comprising anode particles may include anodes with an electrode layer exhibiting capacity in the range from about 400 mAh/g to about 2800 mAh/g (per mass of the electrode layer, not counting the mass of the current collector, in a Li-free state). Such a class of charge-storing anodes may offer great potential for increasing gravimetric and volumetric energy of rechargeable batteries. However, Li-ion battery cells with anodes comprising high-capacity anode particles may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V). In addition to Si-comprising anodes, other examples of such high-capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorous, silver, cadmium, indium, tin, lead, bismuth, their alloys, and others. In addition to anodes comprising active materials in a metallic form, other interesting types of high-capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) active anode materials may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) active anode materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with alloying-type (or, more broadly, conversion-type) active anode materials may become particularly undesirably fast for cells comprising medium (e.g., about 3-4 g/Ah) or small (e.g., about 2-3 g/Ah) amount of electrolyte when normalized by total cell capacity. However, in some designs, using a medium or a small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions.

High-capacity (nano)composite anode powders (including, but not limited to those that comprise Si), which exhibit moderately high volume changes (e.g., about 8-about 180 vol. %) during the first charge-discharge cycle, moderate volume changes (e.g., about 4-about 50 vol. %) during the subsequent charge-discharge cycles and an average size in the range from about 0.2 to about 40 microns (for some applications, more preferably from about 0.4 to about 20 microns) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (e.g., above about 12 mAh/cm²) are also particularly attractive for use in cells. In some designs, a near-spherical or a spheroidal or an ellipsoid (inc. oblate spheroid) shape of these composite particles may additionally be very attractive for increasing rate performance and volumetric capacity (density) of the electrodes. Note that such high-capacity (nano)composite anode “powders” may be in the form of a “dry” powder (e.g., before being mixed into or suspended in a slurry), in the slurry itself (e.g., in a suspended state), or in a casted electrode (e.g., casted into an electrode, bound together with a suitable binder and/or conductive additives and/or functional additives, and dried).

In spite of some improvements that may be achieved with the formation and utilization of such alloying-type (or conversion-type) active material(s)-comprising (e.g., nanocomposite) anode materials as well as electrode formulations, however, substantial additional improvements in cell performance characteristics may be achieved with improved composition and preparation of electrolytes (e.g., liquid electrolytes), beyond what is known or shown by the conventional state-of-the-art. Unfortunately, high-capacity (nano)composite anode and cathode powders, which exhibit moderately high volume changes (e.g., about 8-about 180 vol. %) during the first charge-discharge cycle, moderate volume changes (e.g., about 4-about 50 vol. %) during the subsequent charge-discharge cycles, an average size in the range from about 0.2 to about 40 microns and relatively low density (e.g., about 0.5-3.8 g/cc), are relatively new and their performance characteristics and limited cycle stability are typically relatively poor, particularly if electrode areal capacity loading is moderate (e.g., from about 2 to about 4 mAh/cm²) and even more so if electrode areal capacity loading is high (e.g., from about 4 to about 12 mAh/cm²) or ultra-high. Higher capacity loading, however, is advantageous in some designs for increasing cell energy density and reducing cell manufacturing costs. Similarly, the cell performance may suffer when such an electrode (e.g., anode) porosity (e.g., volume occupied by the spacing between the (nano)composite active anode particles in the electrode and filled with electrolyte, exclusive of closed pores, if any, within the particles themselves that are inaccessible to electrolyte) becomes moderately small (e.g., about 25-about 35 vol. %) and more so when the electrode (e.g., anode) porosity becomes small (e.g., about 5-about 25 vol. %) or when the amount of the binder and conductive additives in the electrode (e.g., anode) becomes moderately small (e.g., about 6-about 15 wt. %, total) and more so when the amount of the binder and conductive additives in the electrode (e.g., anode) becomes small (e.g., about 0.5-about 5 wt. %, total).

Higher electrode density and lower binder content, however, are advantageous for increasing cell energy density and reducing cost in certain applications. In some designs, lower binder content may also be advantageous for increasing cell rate performance. In some designs, larger volume changes may lead to inferior performance in some designs, which may be related to damages in the solid electrolyte interphase (SEI) layer formed on the anode, to the non-uniform lithiation and delithiation of the electrode particles within the electrodes, and/or other factors. Unfortunately, Li and Li-ion battery cells with such anodes and conventional electrolytes often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). In some designs, performance of such battery cells may become particularly poor when the cells are charged to above about 4.3-4.4 V and even more so when the cells are charged to above about 4.5 V.

Higher cell voltage, broader operational temperature window, and longer cycle life, however, are advantageous for most applications. In some designs, such cells (e.g., cells with high amounts of conventional SEI-building additives) may suffer from excessive capacity degradation (e.g., above about 5%), large volume expansion (e.g., above about 10%) and significant gassing when exposed to high temperatures (e.g., above about 50-90° C.) in a fully charged state (e.g., state-of-charge, SOC, of about 90-100%) for a prolonged time (e.g., about 12-168 hours). Passing such elevated temperature charging tests is often required for most applications. In some designs, degradation of Li-ion cells comprising high-capacity (nano)composite anode powders, which exhibit moderately high volume changes during the first charge-discharge cycle, moderate volume changes during the subsequent charge-discharge cycles and an average size in the range from about 0.2 to about 40 microns may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, Li-ion cells with such volume changing anode particles may become particularly undesirably fast for cells comprising medium (e.g., about 2-4 mL/Ah) or small (e.g., about 1-2 mL/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

One or more embodiments of the present disclosure overcome some of the above-discussed challenges of various types of metal-ion (e.g., Li-ion) cells comprising high-capacity nanocomposite anode materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 4-about 50 vol. %) during the subsequent charge-discharge cycles), may exhibit an average particle size in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 2 mL/Ah), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., SOC of about 70-100%) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

Conventional cathode materials utilized in Li-ion batteries are of an intercalation-type and commonly crystalline and polycrystalline. Such cathodes typically exhibit a highest charging potential of less than about 4.3 V vs. Li/Li⁺, reversible gravimetric capacity of less than about 190 mAh/g (based on the mass of active material) and reversible volumetric capacity of less than about 800 mAh/cm³ (based on the volume of the electrode and not counting the volume occupied by the current collector foil). For given anodes, higher energy density in Li-ion batteries may be achieved either by using high-voltage cathodes (cathodes with a highest charging potential from about 4.3 V vs. Li/Li⁺ to about 5.1 V vs. Li/Li⁺) or by using cathodes comprising so-called conversion-type cathode materials (including, but not limited to those that comprise F or S in their composition). Some high-voltage intercalation-type cathodes may comprise nickel (Ni). Some high-voltage intercalation-type cathodes may comprise manganese (Mn). Some high-voltage intercalation-type cathodes may comprise iron (Fe). Some high-voltage intercalation-type cathodes may comprise cobalt (Co). Some high-voltage intercalation-type cathodes may comprise aluminum (Al). Some high-voltage intercalation-type cathodes may comprise, as a dopant, silicon (Si), tin (Sn), antimony (Sb), or germanium (Ge) or their various combinations. In some designs, high-voltage intercalation-type cathode particles may comprise fluorine (F) as a dopant in their structure or the surface layer. Some high-voltage intercalation-type cathodes may comprise phosphorous (P) as a dopant. Some high-voltage intercalation-type cathodes may comprise sulfur (S) as a dopant. Some high-voltage intercalation-type cathodes may comprise selenium (Se) as a dopant. Some high-voltage intercalation-type cathodes may comprise tellurium (Te) as a dopant. Some high-voltage intercalation-type cathodes may comprise magnesium (Mg). Some high-voltage intercalation-type cathodes may comprise zirconium (Zr). Combination of such (or similar) types of higher energy density cathodes with high-capacity (e.g., Si-comprising) anodes may result in high cell-level energy density. Unfortunately, the cycle stability and other performance characteristics of such cells may not be sufficient for some applications, at least when used in combination with conventional electrolytes.

One or more embodiments of the present disclosure are thereby directed to electrolyte compositions that work well for a combination of high voltage intercalation cathodes (cathodes with the highest charging potential in the range from about 4.0-4.2 V to about 4.5 V vs. Li/Li⁺ and, in some cases, from about 4.5 V vs. Li/Li⁺ to about 5.1 V vs. Li/Li⁺) with a subclass of high-capacity moderate volume changing anodes (e.g., anodes comprising (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles), which exhibit an average particle size (e.g., average diameter) in the range from about 0.2 to about 40 microns and specific surface area in the range from about 0.5 to about 50 m²/g (when normalized by the mass of the composite electrode particles) and, in the case of Si-comprising anodes, specific capacities in the range from about 400 to about 2800 mAh/g (when normalized by the total mass of all the anode particles, conductive or other additives and binders, but does not include the weight of the current collectors) or in the range from about 650-800 to about 3000 mAh/g (when normalized by the mass of the Si-comprising anode particles only). In at least one embodiment, a particular electrolyte composition may be selected based on the value of the highest cathode charge potential or the highest operating temperature or the longest cycle or calendar life requirement.

One or more embodiments of the present disclosure are also directed to electrolyte compositions that work well for a combination of (i) a subclass of moderate capacity (e.g., about 150-260 mAh/g per mass of active materials, in some design), high-voltage intercalation-type cathodes (which may be layered cathodes in some designs; which may comprise Ni or Co or Mn or a combination of some of such metals in some designs, such as, for example, LCO (lithium cobalt oxides), NCA (lithium nickel cobalt aluminum oxides), NCMA (lithium nickel cobalt manganese aluminum oxides), LNO (lithium nickel oxides), LMO (lithium manganese oxides), NCM (lithium nickel cobalt manganese oxides, also known as NMC), LCAO (lithium cobalt aluminum oxides), LCP (lithium cobalt phosphates), LMP (lithium manganese phosphate), LNP (lithium nickel phosphate), LFP (lithium iron phosphate), LMFP (lithium manganese iron phosphate) or others), which are charged to above about 4.1 V vs. Li/Li⁺ during full cell battery cycling (in some designs, above about 4.2 V vs. Li/Li⁺; in other designs, above 4.3 V vs. Li/Li⁺; in yet other designs, above about 4.4 V vs. Li/Li⁺; in yet other designs, above about 4.5 V vs. Li/Li⁺; in yet other designs, above about 4.6 V vs. Li/Li⁺) with (ii) a subclass of high-capacity moderate volume changing anodes:anodes comprising about 5-about 100 wt. % of (nano)composite anode powders (e.g., Si—C nanocomposites), which exhibit moderately high volume changes (e.g., about 8-about 160 or about 180 vol. %) during the first charge-discharge cycle, moderate volume changes (e.g., about 4-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only).

The inventors have found that, in some designs, cells comprising anode electrodes based on high-capacity nanocomposite anode particles or powders (comprising conversion- or alloying-type active anode materials) that experience certain volume changes during cycling (moderately high volume changes (e.g., an increase by about 8-about 180 vol. % or a reduction by about 8-about 70 vol. %) during the first charge-discharge cycle and moderate volume changes (e.g., about 4-about 50 vol. %) during the subsequent charge-discharge cycles) and an average size in the range from about 0.2 to about 40 microns (such as Si-based nanocomposite anode powders, among many others) may benefit from specific compositions of electrolytes that provide significantly improved performance (particularly for high-capacity loadings or small electrolyte fractions or large cells).

For example, (i) continuous volume changes in high-capacity nanocomposite particles during cycling in combination with (ii) electrolyte decomposition on the electrically conductive electrode surface at electrode operating potentials (e.g., mostly electrochemical electrolyte reduction in the case of Si-based anodes) may lead to a continuous (even if relatively slow) growth of a solid electrolyte interphase (SEI) layer on the surface of the nanocomposite anode particles and the resulting irreversible losses in cell capacity. In some designs, the addition of some known SEI-forming additives may improve SEI stability during cycling but may induce undesirable electrolyte oxidation on the cathode (particularly at higher voltages or elevated temperature), resulting in gassing, cell swelling and reduced cycle and calendar life. In some designs, the addition of some known cathode solid electrolyte interphase (CEI)-forming additives may induce protective film formation on the cathode, reducing further electrolyte oxidation and gassing, but often at the expense of reduced SEI stability on the anode or other undesirable effects. In some designs, Localized High Concentration Electrolytes (L-HCEs) may improve the stability of the SEI without inducing undesirable electrolyte oxidation on the cathode. In some designs, L-HCEs may reduce the rate of undesirable electrolyte oxidation on the cathode, and in some designs may increase desirable electrolyte oxidation reactions on the cathode which prevent other gas generating electrolyte reactions from happening, for example, by forming a CEI.

The inventors have found that, in some designs, cells comprising anode electrodes based on Si-nanocomposite and graphite particles or powders, may benefit from electrolytes which exhibit moderate to minimal fluoroethylene carbonate (FEC) mole concentration, moderate to none ethylene carbonate (EC), and low-to-none vinylene carbonate (VC) concentration, wherein low to minimal is about 5 mol % to 0.5 mol %, low to none is about 5 mol % to 0 mol %, and moderate to none is about 20 mol % to 0 mol %. FEC, VC, and EC are examples of cyclic carbonates. For example, some electrolytes with lower concentrations of FEC and VC may exhibit longer cycle life, reduced high-temperature outgassing on the cathode, decreased voltage hysteresis, reduced SEI resistance, higher energy throughput (i.e., total energy stored by the battery cell during its lifetime), and decreased battery self-heating during operation.

In some designs, swelling of binder(s) in electrolyte(s) depends not just on the binder composition(s), but may also depend on the electrolyte composition(s). Furthermore, in some designs, such swelling (and the resulting performance reduction) often correlates with the reduction in elastic modulus upon exposure of binders to electrolytes. In this sense, the smaller the reduction in modulus in certain electrolytes, the more stable the binder-linked (nano)composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

In some designs it is advantageous to use binders with functional groups which do not chemically or electrochemically interact with the electrolyte components, such as Li salts, FEC, VC, co-solvents, Li salt additives, and HT storage additives. The inventors have found that in some designs the presence of carboxylic acid groups in the binders can cause excessive outgassing during the HT storage test. It may be advantageous in some designs to use a greater amount of branched esters in ELY formulations to cut HT outgassing. In some implementations, it may be desirable to have a branched ester composition in a range of about 10-30 mol. %, about 20-50 mol. %, or about 40-70 mol. % of the ELY formulation.

In one or more embodiments of the present disclosure, it may be advantageous to have a total salt concentration in the electrolyte in the range from about 8 mol. % to about 22 mol. % (e.g., in some designs, from about 10 mol. % to about 20 mol. %), while utilizing a mixture of two, three or more salts. Salt concentrations in the electrolyte that are too low (e.g., lower than about 0.8 M) may lead to excessive HT outgassing, reduced ELY conductivity, increased charge-transfer resistance in some designs (e.g., when high-capacity anode materials are used). Higher salt concentration in the electrolyte may lead to reduced cycle life stability. Such reduced cycle life stability characteristics may be related to reduced mobility of Li⁺ cations in the electrolyte in some designs and, in some designs, the formation of poor SEI. Higher salt concentration may also lead to increased electrolyte density, increased viscosity, decreased conductivity, and increased cost in some designs, which may be undesirable for some applications including low temperature performance. Higher salt concentrations may also lead to faster charging and discharging rates, which may be beneficial for some applications. Such improved rate performance may be related to the reduced anode and cathode charge-transfer resistance despite low electrolyte conductivity. Such improved rate performance may be beneficial for low temperature applications. Higher salt concentration may also lead to reduced high-temperature (HT) outgassing during the HT storage test. Such improved outcome of the HT storage test may be related to the higher concentration of salt and formation of fluoride protective layer on the surface of the cathode, which may impede other chemicals from the oxidative decomposition. In other implementations, improved HT storage outcome may be due to better the formation of an SEI that is more resistant to high-temperature outgassing reactions. The optimal salt concentration may depend on the particular cell design and electrolyte composition.

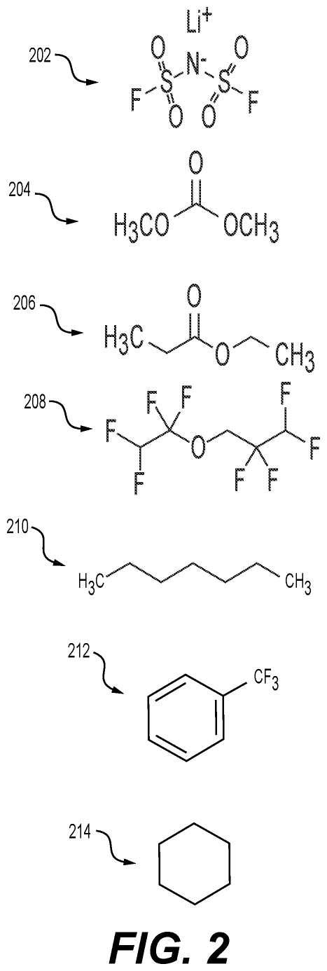

One aspect of the present disclosure is directed to an electrolyte for a lithium-ion battery. The electrolyte comprises a lithium salt composition, a solvent composition, and a diluent composition. In some implementations, the lithium salt composition may preferably comprise lithium bis(fluorosulfonyl)imide (LiFSI) (shown as 202 in FIG. 2) as a primary lithium salt. In some implementations, a mole fraction of the primary lithium salt (e.g., LiFSI) in the electrolyte may preferably be in a range of approximately 8 mol. % to approximately 22 mol. % (e.g., in some designs, in a range of about 10 mol. % to about 20 mol. %). In some implementations, a mole fraction (concentration) of the primary lithium salt in the electrolyte may preferably be in a range of approximately 4 mol. % to approximately 11 mol %, in which case the electrolyte may comprise one or more additional salts with a total salt mole fraction of approximately 8 mol. % to approximately 22 mol. % (e.g., in some designs, in a range of about 10 mol. % to about 20 mol. %. In some designs, it may be advantageous to use a higher molarity (or a higher mole fraction) of certain salt(s) (such as LiFSI) to stabilize the anode SEI and increase the cycle life of the cell. In some designs, it may be advantageous to use a higher molarity (or a higher mole fraction) of salt(s) to improve the operation of electrolyte at low temperatures, such as from about −30° C. to about +10° C. In some designs, it may be advantageous to use a higher molarity (or a higher mole fraction) of salt(s) to decrease HT outgassing. In some designs, a higher molarity (or a higher mole fraction) of certain salts may lead to poor charge and discharge rate capability. In some designs, if the molarity (or mole fraction) of the salt is too high, the operation of the electrolyte at lower temperatures may be degraded. The optimal salt molarity (or mole fraction) may depend on the particular cell design and electrolyte composition.

In some implementations, the primary salt may be one of the following: lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, and lithium difluoro(oxalato)borate (LiDFOB). The primary salt has a major contribution (e.g., about 15-20% or more of the total current carried by the salt's cations and anions) to the conductivity of the electrolyte, and/or comprises about 8-20 mol. % of the electrolyte, or about 10 to about 20 mol. % of the electrolyte.

In some implementations, the electrolyte may also comprise a total of 0.01-9 mol. % of one, two or more secondary salts. These secondary salts may comprise one or more of LiPF₆, LiFSI, LiTFSI, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li PS₄, Li₆PSₛCl, lithium tris(fluorosulfonyl)methide (LTFSM), LiBF₄, lithium bis(oxalate)borate (LiBOB), lithium tetracyanoborate (LiBison), lithium dicyano-trifluoromethyl-imidazole (LiTDI), lithium dicyano-(pentafluoroethyl)imidazole (LiPDI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), lithium cyclo-hexafluoropropane-1,1-bis(sulfonyl)imide (Li HPSI), and various other lithium imides (CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others). In some implementations, if the primary salt does not provide sufficient ionic conductivity or does not form sufficiently stable anode SEI or cathode CEI or does not form sufficiently ionically conductive anode SEI or cathode CEI at low or room temperature or does not provide sufficient thermal stability of the SEI or CEI or does not offer other important benefits, an additional salt may be added at relatively high concentrations (>about 3 mol. %) to improve the electrolyte conductivity or SEI or CEI properties.

In some implementations, the primary salt composition preferably does not contain LiPF₆, due to its thermal decomposition at high temperatures, reducing the battery cell's high-temperature stability and calendar life.

In some implementations, the electrolyte may comprise <about 1 mol. % of one, two, three or more non-Li alkali metal cation (e.g., Na), alkaline earth (e.g., Mg), Yttrium (Y), lanthanum (La) and lanthanide metal variants of the discussed above lithium primary or secondary salts, even if the electrolyte is intended for a Li-ion battery. Such additives may enhance SEI properties, in some designs.

In some implementations, the electrolyte may additionally include additives (additive compounds) such as charge-transfer additives which may reduce the charge-transfer resistance at the anode and/or cathode. Certain secondary Li salt additives as well as some other compounds may function as charge-transfer additives. Illustrative examples of suitable Li salt additives that may function as charge-transfer additives may include but not limited to: lithium difluorophosphate (LiPO₂F₂ or LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB). Some examples of charge-transfer additives that are not Li salts are methyl 2,2-difluoro-2-(fluorosulfonyl)acetate (MDFA), dimethyl sulfite (DMS), and triisopropyl phosphate (TIP). In addition, additives that function as high-temperature storage additives, which may suppress high-temperature outgassing (e.g., caused by electrolyte components such as VC) may be employed as well. Some examples of high-temperature storage additives are: 1,3,2-dioxathiolane 2,2-dioxide (DTD) and methylene methanedisulfonate (MMDS), to name a few. In some implementations, a mole fraction (concentration) of the additives (e.g., lithium salt additives, other charge-transfer additives, high-temperature storage additives) may be in a range of approximately 0.1 mol. % to approximately 6 mol. %. In some implementations, a mole fraction (concentration) of the additives (e.g., lithium salt additives, other charge-transfer additives, high-temperature storage additives) may be in a range of approximately 0.5 mol. % to approximately 1.5 mol. %. In some implementations, a mole fraction (concentration) of the additive lithium salt(s) in the electrolyte may preferably be in a range of approximately 0.05 M to approximately 0.15 M. Similar to other secondary salts, secondary salts used as charge-transfer additives can also comprise Na or other alkali metal cations or Mg or other alkaline earth metal cations instead of a Li cation, even if the electrolyte is intended for use in a Li-ion battery.

High-temperature outgassing (HT gassing) in a battery cell is an undesirable phenomenon that is observed to result from a heat treatment (also referred to as high-temperature storage treatment) of the battery cell after it has been charged to a high state-of-charge (SOC). The temperature of the heat treatment can vary depending on the specific heat treatment implementation, e.g., about 80° C., about 72° C., about 60° C., and other temperatures in a range of about 50° C. to about 90° C. The duration of the heat treatment can also vary depending on the specific heat treatment implementation, e.g., about 10 days, about 7 days, about 3 days, about 2.5 days, about 2 days, and other durations.

A measurement of the volume of the gases formed in the cell constitutes a metric for the high-temperature outgassing test. In one example, the volume of the gases in the cell at atmospheric pressure (“gas volume”), measured about 10 minutes after the cell has been cooled to about 25° C. after the high-temperature storage treatment under a high state-of-charge (SOC), is compared to the initial volume of the cell before the high-temperature storage treatment under a high state-of-charge (SOC). In some implementations, the gas volume preferably does not exceed about 20 vol. % of the initial volume of the cell. In some implementations, the gas volume preferably does not exceed about 12 vol. % of the initial volume of the cell. In some implementations, the gas volume preferably does not exceed about 3 vol. % of the initial volume of the cell. In some implementations, the gas volume preferably does not exceed about 1 vol. % of the initial volume of the cell.

In some designs, the solvent composition includes one or more compounds that help to solvate the lithium salt composition. Herein, a compound that is employed in the solvent composition may be referred to as a “main co-solvent” (alternatively referred to as a “primary solvent”) when the mole fraction of that compound is greater than each of the other compounds in the solvent composition. The solubility of a primary salt in the solvent composition may preferably be equal or higher than about 1.5 M. In some implementations, co-solvents that more strongly coordinate salts are preferable due to higher conductivity (leading to higher rate capability). In some implementations, smaller molecules may be preferable as co-solvents, for their superior ability to solvate high concentrations of salts and their greater mobility and lower viscosity due to their lower molar mass and weaker intermolecular dispersion forces. In some implementations, the compounds of the solvent composition preferably do not vaporize from the electrolyte mixture at temperatures below about 60 to about 80° C. In some implementations, some vaporization of electrolyte components may be permitted if the cell container is able to withstand the high pressure from gases inside the cell. In some implementations, the compounds of the solvent composition preferably do not solidify or precipitate from the electrolyte mixture at temperatures above about −30 to about −10° C. In some implementations, a higher mole fraction of the co-solvents will increase the conductivity of the electrolyte, and may increase the rate capability of the battery cell.

In one or more embodiments of the present disclosure, a preferred solvent composition for a Li-ion battery electrolyte may include at least one linear carbonate (LC). Examples of linear carbonates include: dimethyl carbonate (DMC), ethyl methyl carbonate (EMC), and diethyl carbonate (DEC). In one or more embodiments of the present disclosure, a preferred solvent composition for a lithium-ion battery electrolyte may include DMC as a main co-solvent. The molecular weights of these linear carbonate compounds are about 90.08 g/mol (DMC), about 104.10 g/mol (EMC), and about 118.13 g/mol (DEC), respectively. These linear carbonates are notable for their relatively low viscosities (e.g., approximately 0.59 cP for DMC and approximately 0.65 cP for EMC, at 25° C.). Accordingly, in some designs, the viscosity of an electrolyte can be decreased by adding one or more of these linear carbonates. For example, in some electrolyte formulations, DMC can increase discharge voltage and improve low-temperature performance.

In some implementations, the solvent composition includes a linear carbonate dimethyl carbonate (DMC), shown as 204 in FIG. 2. In some implementations, DMC may constitute at least about 60 wt. % (e.g., about 60-about 70 wt. %, about 70-about 80 wt. %, about 80-about 90 wt. %, about 90-about 95 wt. %, about 95-about 99 wt. %, or about 99-about 100 wt. %) of the solvent composition. In some implementations in which DMC is employed in the solvent composition, the mole fraction (concentration) of the DMC in the electrolyte may be in a range of about 35 mol. % to about 65 mol. % (e.g., in a range of about 35 mol. % to about 45 mol. %, in a range of about 45 mol. % to about 55 mol. %, or in a range of about 55 mol. % to about 65 mol. %).

In one or more embodiments of the present disclosure, the solvent composition of the preferable L-HCE (electrolyte) may include one, two or more ester compound(s) selected from the following: (i) linear esters such as ethyl propionate (EP), ethyl acetate (EA), methyl butyrate (MB), methyl propionate (MP), methyl acetate (MA), propyl acetate (PA), methyl formate (MF), butyl formate (BF), butyl acetate (BA), amyl formate, methyl caproate, ethyl valerate, propyl butyrate, butyl propionate, amyl acetate, hexyl formate, propyl propionate, methyl propionate, ethyl propionate, methyl valerate, methyl butyrate, ethyl butyrate, butyl valerate, butyl butyrate, propyl propionate; (ii) cyclic esters such as γ-valerolactone, γ-methylene-γ-butyrolactone, γ-hexalactone, α-angelica lactone, α-methylene-γ-butyrolactone, ε-caprolactone, 5,6-dihydro-2H-pyran-2-one, γ-butyrolactone, δ-hexalactone, α-methyl-γ-butyrolactone, phthalide, γ-caprolactone; and (iii) branched esters, such as ethyl isovalerate (EIV), methyl 2-methylpropionate, methyl 2,2-dimethylpropionate (also called methyl isobutyrate, MIB), methyl 2-methylbutyrate, ethyl 2-methylpropionate (also called ethyl isobutyrate, EI), ethyl 2,2-dimethylpropionate, ethyl 2-methylbutyrate, methyl 2-fluoro-2-methylpropionate, methyl 2-fluoropropionate, methyl 2-methyl-3-cyanopropionate, 2,2,2-trifluoroethyl isobutyrate, 2-cyanoethyl isobutyrate, 2,5-dicyanopentyl isobutyrate, 2-(2,2-dioxido-3H-1,2-oxathiol-4-yl)ethyl isobutyrate, 4-(methylsulfonyl)benzyl isobutyrate, 2-((difluorophosphoryl)oxy)ethyl isobutyrate, 2-((1,3,2-dioxaphospholan-2-yl)oxy)ethyl isobutyrate, 2-((trimethoxysilyl)oxy)ethyl isobutyrate, 2-(azidomethoxy)ethyl pivalate, allyl isobutyrate, and but-2-yn-1-yl propionate. In some implementations in which one, two or more ester compounds is (are) employed as co-solvent(s) in the preferable L-HCE (electrolyte), the total mole fraction (concentration) of all the ester compounds in the electrolyte may be in a range of about 5 mol. % to about 75 mol. % (e.g., in a range of about 1 mol. % to about 5 mol. %, or in a range of about 5 mol. % to about 15 mol. %, or in a range of about 15 mol. % to about 25 mol. %, or in a range of about 25 mol. % to about 45 mol. % or in a range of about 45 mol. % to about 55 mol. %, or in a range of about 55 mol. % to about 65 mol. % or in a range of about 65 mol. % to about 75 mol. %). In some implementations in which one, two or more ester compounds is (are) employed as co-solvent(s) in the preferable L-HCE (electrolyte), the total wt. fraction (concentration) of all the ester compounds of the solvent composition may range from about 30 wt. % to about 100 wt. % (in some designs, from about 30 wt. % to about 50 wt. %; in other designs, from about 50 wt. % to about 60 wt. %; in other designs, from about 60 wt. % to about 70 wt. %; in other designs, from about 70 wt. % to about 80 wt. %; in other designs, from about 80 wt. % to about 90 wt. %; in other designs, from about 90 wt. % to about 100 wt. %).

In some embodiments of the present disclosure, a suitable composition of ester compounds in the L-HCE may contribute to better ionic conductivity in the electrolyte, better discharge rate capability, better fast charge performance, reduced HT outgassing, reduced end-of-life outgassing, better calendar life, and/or better low-temperature performance.

In some implementations where the L-HCE solvent composition does not comprise EP, a mole fraction of esters may be in the range of about 1 mol. % to about 75 mol. %. In some implementations, EP, shown as 206 in FIG. 2 may offer a good balance of stability, solubility, and rate capability. In some implementations, EP may constitute at least about 60 wt. % (e.g., about 60-70 wt. %, about 70-80 wt. %, about 80-90 wt. %, about 90-95 wt. %, about 95-99 wt. %, or about 99-100 wt. %) of the solvent composition. In some implementations in which EP is employed in the solvent composition, the mole fraction (concentration) of the EP in the electrolyte may be in a range of about 40 mol. % to about 70 mol. % (e.g., in a range of about 40 mol. % to about 50 mol. %, or in a range of about 50 mol. % to about 60 mol. %, or in a range of about 60 mol. % to about 70 mol. %). In some implementations in which EP is employed in the solvent composition, the mole fraction (concentration) of the EP in the electrolyte may be in a range of about 35 mol. % to about 40 mol. %. In some implementations in which EP is employed in the solvent composition, the mole fraction (concentration) of the EP in the electrolyte may be in a range of about 60 mol. % to about 70 mol. %.

In some implementations, the solvent composition in a suitable L-HCE may comprise one or more cyclic carbonates (in some designs, in addition to other suitable co-solvents, such as esters) such as: vinylene carbonate (VC), vinylene ethylene carbonate (VEC), fluoroethylene carbonate (FEC), ethylene carbonate (EC), and propylene carbonate (PC). In some implementations in which VC is employed in the solvent composition, a mole fraction (concentration) of the VC in the electrolyte may be in a range of about 0.05 mol. % to about 2.00 mol. % (e.g., from about 0.05 mol. % to about 0.5 mol. %; or from about 0.5 mol. % to about 1 mol. %; or from about 1 mol. % to about 2 mol. %). In some implementations in which FEC is employed in the solvent composition, a mole fraction (concentration) of the FEC in the electrolyte may be in a range of about 0.1 mol. % to about 20 mol. % (e.g., from about 0.1 mol. % to about 0.5 mol. %; or from about 0.5 mol. % to about 1 mol. %; or from about 1 mol. % to about 2 mol. %; or from about 2 mol. % to about 4 mol. %; or from about 4 mol. % to about 6 mol. %; or from about 6 mol. % to about 8 mol. %; from about 8 mol. % to about 10 mol. %; from about 10 mol. % to about 15 mol. %; from about 15 mol. % to about 20 mol. %). In some implementations in which EC is employed in the solvent composition, a mole fraction (concentration) of the EC in the electrolyte may be in a range of 1 mol. % to 5 mol. %. In some implementations in which PC is employed in the solvent composition, a mole fraction (concentration) of the PC in the electrolyte may be in a range of about 1 mol. % to about 20 mol. %. In some implementations, a total mole fraction of the cyclic carbonates in the electrolyte may be in a range of about 0.05 to about 6 mol. %. In cases where the mol % is below about 2 mol. %, the cyclic carbonates may be considered as being present in the electrolyte at additive-level concentrations. In some implementations, a total mole fraction of the cyclic carbonates in the electrolyte may be in a range of about 6 to about 12 mol. %. In some implementations, a total mole fraction of the cyclic carbonates in the electrolyte may be in a range of about 12 to 20 mol. %. In some implementations, a total mole fraction of the cyclic carbonates in the electrolyte may be in a range of about 20 to 30 mol. %.

In some embodiments, a concentration of FEC in the electrolyte may be in a range of approximately 0.1 mol. % to approximately 30 mol. %. In some designs, when the concentration of FEC in the electrolyte is too low (e.g., in some implementations, less than approximately 1 mol. % or, in other implementations, about 0.1 to about 1 mol. % or, in other implementations, below about 0.1 mol. %), the cycle life may degrade undesirably fast because of insufficient amount of suitable SEI builders. In some designs, there is more SEI formation when the FEC concentration is greater than approximately 5 mol. %. However, in some designs, increasing FEC concentrations may undesirably be accompanied by increased high-temperature outgassing, as well as lower discharge voltages (due to the overly resistive SEI formation) and/or increased viscosity of the electrolyte (due to the high viscosity of FEC). Lower discharge voltages typically result in lower volumetric energy densities (VEDs), and higher viscosities result in lower ionic conductivities. For these reasons, the FEC concentration should preferably be set to below a certain threshold (e.g., mol. % threshold) in some designs. In some implementations, the FEC concentration should preferably not exceed approximately 30 mol. %. In some implementations, the FEC concentration preferably does not exceed approximately 6 mol. %. In some implementations, FEC may provide better cycle life by being used in combination with other SEI builder compounds.

In some embodiments, the L-HCE solvent composition includes VC, and the mole fraction of VC in the electrolyte is in the range of about 0.1 to about 4 mol. %. In some implementations, the mole fraction of VC is preferably in the range of about 0.1-1 mol. %. In some implementations, the mole fraction of VC is preferably in the range of about 1-4 mol. %. In some designs, within a preferred concentration range (e.g., mole fraction in a range of about 0.1 mol. % to about 1 mol. %, or mole fraction in a range of about 1 mol. % to about 4 mol. %), the presence of VC in the electrolyte may contribute to a preferable balance of good cycle life, good ionic conductivity, and high discharge voltage. In some implementations, the electrolyte comprises a low composition of VC (e.g., about 0.1-1 mol. %) to improve the calendar life, High T stability of the electrolyte, and charge-transfer resistance (which reduces rate capability, especially at lower temperatures).

In some embodiments, it may be advantageous to use ethylene carbonate (EC) as an SEI “builder” as a component of the solvent composition. In some embodiments, EC can be used as an SEI “builder” to build SEI, which helps to improve cycle life. In some embodiments, EC may provide better cycle life by being used in combination with other SEI “builder” compounds. In some implementations, EC may be more suitable as a SEI “builder” when graphite particles are blended into the anode. In some implementations, a good balance between cycle life, ionic conductivity, discharge voltage, and low-temperature performance can be achieved when the mole fraction of EC in the electrolyte is about 0.5 mol. % to about 1 mol. %, about 1 mol. % to about 5 mol. %, or about 5 mol. % to 15 mol. %.

In some embodiments, the solvent composition comprises non-fluorinated ethers (e.g., dimethoxyethane (also referred to as ethylene glycol dimethyl ether, DME), diethoxyethane, and dipropyl ether). In some embodiments, ethers (including non-fluorinated ethers) may be preferable as co-solvents due to their electrochemical stability to reduction at the anode, especially when oxidation reactions at the cathode are passivated by other means. In some embodiments, non-fluorinated ethers may not be preferable due to their electrochemical instability to oxidation at the cathode. In some implementations, an electrolyte comprises about 10-20 mol. % of non-fluorinated ethers. In other implementations, an electrolyte comprises about 20-50 mol. % of non-fluorinated ethers. In yet other implementations, an electrolyte comprises about 50-70 mol. % of non-fluorinated ethers.

In some embodiments (especially if the cathode potential is not too high or if the cathode is passivated well with additives or comprises a surface layer), the L-HCE solvent composition may comprise one, two or more ethers (including non-fluorinated ethers), such as: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (also referred to as dimethoxyethane, DME), and diethoxyethane, to name a few. Ethers exhibit very low density, very low melting point and very low viscosity, which may enhance cell performance at high rates or low temperatures or may help reduce electrolyte mass and thus increase gravimetric energy density (specific energy) of batteries. Ethers, however, may exhibit reduced stability at high electrochemical potentials and thus may be more suitable for cells comprising lower voltage cathodes or when cathode surface is well passivated with other co-solvent molecules.

In some designs, a total weight fraction of ether co-solvents in the L-HCE may range from about 1 wt. % to about 2 wt. %; in other designs, the total weight fraction may range from about 2 wt. % to about 3 wt. %; in other designs, the total weight fraction may range from about 3 wt. % to about 5 wt. %; in other designs, the total weight fraction may range from about 5 wt. % to about 10 wt. %; in other designs, the total weight fraction may range from about 10 wt. % to about 20 wt. %; in other designs, the total weight fraction may range from about 20 wt. % to about 40 wt. %; in other designs, the total weight fraction may range from about 40 wt. % to about 60 wt. %; in other designs, the total weight fraction may range from about 60 wt. % to about 70 wt. %.

In some embodiments, the L-HCE solvent composition may comprise one, two or more ketones, such as: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA). Ketones tend to have high dispersion forces, high dipole moment, and high dielectric constant and often make great solvents for salts and solvents alike. Many ketones also have low viscosity, resulting in fast Li⁺ diffusion and high conductivity which leads to high rate capability. However, ketones are often not used as electrolyte solvents due to their instability with the electrodes and/or salts. In some implementations, the mole fraction of ketones in the electrolyte may be limited to about 0.1-5 mol. % or about 5-20 mol. % because they may excessively swell or dissolve one or more electrode binder polymers, such as polyvinylidene difluoride (PVDF). In some implementations, if the surface and/or salt reactions are passivated, ketones may contribute higher than additive amounts (e.g., greater than about 5 mol. %) to the electrolyte composition. In some implementations, some ketones (e.g., hexamethylacetone (HMA)) may reduce HT gassing and improve the ionic conductivity of the salt, improving rate capability. In some implementations, ketones may not be compatible with some graphite anodes because the strong association with the Li⁺ ion causes the solvents to co-intercalate, causing the graphite particles to degrade via co-intercalation. In some implementations, an electrolyte preferably comprises ketones at a mole fraction in a range of about 0.01-5 mol. %. In other implementations, an electrolyte preferably comprises ketones at a mole fraction in a range of about 5-20 mol. %. In yet other implementations, an electrolyte preferably comprises ketones at a mole fraction in a range of about 20-50 mol. %. In yet other implementations, an electrolyte preferably comprises ketones at a mole fraction in a range of about 50-75 mol. %.

In some embodiments, the L-HCE solvent composition may advantageously comprise one, two or more nitriles or other nitrogen (N)—comprising solvents (with one, two, three, four or more N atoms per molecule), including but not limited to: nitriles (e.g., acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), 1,3,6-hexanetricarbonitrile (HTCN)), pyridine-boron trifluoride (PBF), 3-fluoro pyridine-boron trifluoride (3F-PBF), pyrazine-boron trifluoride, triethylamine, triisopropylamine, p-toluenesulfonyl isocyanate, and 1,1′-sulfonyldiimidazole to provide a few illustrative examples. Nitriles tend to have strong dipole moments and high dielectric constants, and often make great solvents for salts. However, nitriles tend to be used in limited quantities in Li-ion batteries due to instability to reduction at the anode, often destabilizing the SEI, and instability to oxidation at the cathode. Yet, some of such effects may be mitigated. In some implementations, nitriles a present in an electrolyte at only additive levels (e.g., about 0.01-5 mol. %) to prevent HT gassing reactions from occurring or to protect against overcharging the cathode to too high of a voltage. However, in some implementations, nitriles may be used at higher mole fractions (concentrations) if surface and/or salt reactions are passivated. In some implementations, an electrolyte may comprise nitrile molecules at a mole fraction of about 0.01-5 mol. % as an additive. In other implementations, an electrolyte may comprise nitrile molecules at a mole fraction of about 5-20 mol. %. In yet other implementations, an electrolyte may comprise nitrile molecules at a mole fraction of about 20-50 mol. %. In yet other implementations, an electrolyte may comprise nitrile molecules at a mole fraction of about 50-70 mol. %.

In some embodiments, the L-HCE solvent composition may comprise one, two, three or more of other types of N-containing solvents, such as amides. Illustrative examples of suitable amides may include, but are not limited to: dimethylacetamide (DMAc), hexamethylphosphoramide (HMPA), N,N-dimethyl trifluoromethanesulfonamide (DMTMSA), N,N-diethyl-trifluoromethanesulfonamide, N,N-dimethyl fluorosulfonamide, and carbamides (also referred to as ureas) (e.g., tetramethylurea). In some implementations, the solvent composition preferably comprises HMPA as it dissolves Li metal and delays cell short circuiting from Li dendrites. In some implementations, an electrolyte may comprise amides at a mole fraction in a range of about 0.1-5 mol. % as an additive. In other implementations, an electrolyte may comprise amides at a mole fraction in a range of about 5-20 mol. %. In yet other implementations, an electrolyte may comprise amides at a mole fraction in a range of about 20-50 mol. %. In yet other implementations, an electrolyte may comprise amides in a range of about 50-70 mol. %.

In some embodiments, the L-HCE solvent composition may comprise one, two, or more nitroalkanes, such as: nitromethane (NM), nitroethane (NE), trinitromethane, tetranitromethane, 2-nitropropane (2NP), 1-nitropropane (1-NP), dinitromethane, hexanitroethane (HNE), heptanitrocubane (HNC), and trifluoro-nitrobenzenes (C₆H₂F₃NO₂), to provide a few illustrative examples. The L-HCE solvent composition may also comprise hydrazinium nitroformate (HNF). Many nitroalkanes have high dielectric constants, improving the conductivity of the electrolyte and thus improving the rate capability. Nitroalkanes may release very large amounts of energy when oxidized however, thus commonly limiting their use to additive quantities (e.g., about 0.001-5.000 mol. %) in many embodiments. In some implementations, a solvent composition may preferably comprise nitroalkanes to form a more stable SEI. In some implementations, an electrolyte may comprise nitroalkane molecules at a mole fraction in a range of about 0.001-0.1 mol. %, about 0.1-1 mol. %, about 1-2 mol. %, or about 2-5 mol. %. In some implementations, an electrolyte may comprise nitroalkanes at a mole fraction in a range of about 5-20 mol. %, about 20-50 mol. %, or about 50-70 mol. %.

In some designs, a total weight fraction of N-containing solvents in the L-HCE may range from about 0.05 wt. % to about 0.2 wt. %; in other designs, a total weight fraction may range from about 0.2 wt. % to about 0.4 wt. %; in other designs, a total weight fraction may range from about 0.4 wt. % to about 0.8 wt. %; in other designs, a total weight fraction may range from about 0.8 wt. % to about 2 wt. %; in other designs, a total weight fraction may range from about 2 wt. % to about 3 wt. %; in other designs, a total weight fraction may range from about 3 wt. % to about 5 wt. %; in other designs, a total weight fraction may range from about 5 wt. % to about 10 wt. %; in other designs, a total weight fraction may range from about 10 wt. % to about 20 wt. %; in other designs, a total weight fraction may range from about 20 wt. % to about 40 wt. %; in other designs, a total weight fraction may range from about 40 wt. % to about 60 wt. %. In some designs, at least some of the N-containing molecules may also comprise Si, B, S, P or F.

In some embodiments, the L-HCE solvent composition may advantageously comprise one, two, or more P-comprising co-solvents, such as phosphites and/or phosphates, for example. Illustrative examples of suitable phosphates include trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate, to name a few. Illustrative examples of suitable phosphites include tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite, to name a few. In some implementations, phosphates may be preferable due to their endothermic decomposition reactions, because they reduce the cell self-heating from decomposition at high temperatures. In some implementations, phosphorus-containing co-solvents are preferable due to flammability suppression via radical neutralization. Typically, carbonate-based solvents produce hydrogen radicals upon heating, which further react with oxygen to produce oxygen free radicals. This triggers the generation of more free radicals, leading to a self sustaining fire. In some implementations, phosphorus radicals, which are part of the electrolyte decomposition products, can react with hydrogen radicals and inhibit the radical linear chain reaction, suppressing the combustion of the electrolyte solvent by acting as radical scavengers. Some phosphates (as well as some phosphonates) are some of the most inexpensive and widely used flame retardant compounds (e.g., TEP (triethyl phosphate), TPP (triphenyl phosphate), TPrP (tripropyl phosphate), and DMMP (dimethyl methylphosphonate)). Furthermore, alkyl phosphates have been known as fire-retardants when studied as co-solvents (typically around 40% vol for non-flammability) due to their high Li salt solvability and the wide range of operating temperatures, reducing the flammability of conventional electrolytes. In some implementations, excessive amounts of phosphates may not be preferable due to their low stability to reduction at the anode. In some other implementations, phosphates (or, broadly, P-comprising co-solvents) may comprise a major fraction of the solvent composition if the anode has been sufficiently stabilized. In some implementations, phosphates (such as TIP, fluorophosphates, etc.) may preferably comprise the electrolyte to reduce the charge-transfer resistance of the anode anode/or cathode of the Li-ion battery, thus improving the rate capability especially at low temperatures. In some implementations, an electrolyte may comprise phosphates at a mole fraction in a range of about 0.01-5.00 mol. % of the electrolyte, as additives. In some implementations, an electrolyte may comprise phosphates at a mole fraction in a range of about 5-20 mol. % of the electrolyte. In other implementations, an electrolyte may comprise phosphates at a mole fraction in a range of about 20-40 mol. % of the electrolyte. In yet other implementations, an electrolyte may comprise phosphates at a mole fraction in a range of about 40-70 mol. % of the electrolyte.

In some designs, a total weight fraction of P-containing solvents in L-HCE may range from about 0.01 wt. % to about 0.1 wt. %; in other designs, a total weight fraction may range from about 0.1 wt. % to about 0.2 wt. %; in other designs, a total weight fraction may range from about 0.2 wt. % to about 0.4 wt. %; in other designs, a total weight fraction may range from about 0.4 wt. % to about 0.8 wt. %; in other designs, a total weight fraction may range from about 0.8 wt. % to about 2 wt. %; in other designs, a total weight fraction may range from about 2 wt. % to about 3 wt. %; in other designs, a total weight fraction may range from about 3 wt. % to about 5 wt. %; in other designs, a total weight fraction may range from about 5 wt. % to about 10 wt. %; in other designs, a total weight fraction may range from about 10 wt. % to about 20 wt. %; in other designs, a total weight fraction may range from about 20 wt. % to about 40 wt. %; in other designs, a total weight fraction may range from about 40 wt. % to about 60 wt. %; in other designs, a total weight fraction may range from about 60 wt. % to about 70 wt. %.

In some embodiments, the solvent composition comprises one, two or more sulfur (S)—containing molecules. Some of such molecules may be liquid at room temperature. Some of such molecules may be solid at room temperature (thus typically used in smaller amounts in batteries operating at room temperatures). Some of such molecules may additionally comprise P, B or N, in some designs. Illustrative examples of suitable S-containing molecules include, but are not limited to: sulfites (e.g., dimethyl sulfite (DMS), trimethylene sulfite, ethylene sulfite(ESi)), sulfones (e.g., ethyl methyl sulfone, ethyl isopropyl sulfone (EIS), dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), tetramethylene sulfone (also referred to as sulfolane, abbreviated as Sl)), phenyl vinyl sulfone), sulfonamides (e.g., 2-methyl-5-(methylsulfonyl)benzenesulfonamide, N,N-dimethyl trifluoromethanesulfonamide (DMTMSA), N,N-dimethyl fluorosulfonamide), 1,3,2-dioxathiolane-2,2-dioxide (DTD), trimethylene sulfate, methylene methanedisulfonate (MMDS), terthiophene, sulfonyldiimidazole, cyclic sulfonic esters (also referred to as sultones) (e.g., propane sultone, propene sultone, phenyl vinyl sultone), linear sulfonic esters, and sulfoxides (e.g., dimethyl sulfoxide (DMSO)), to name a few.

In some implementations, sulfur-containing molecules may be preferable to form polymeric SEI and/or CEI to stabilize the anode and/or cathode respectively for improved cycle life and/or reduced HT gassing. In some implementations, an electrolyte comprises sulfur-containing molecules at a mole fraction in a range of about 0.01-5 mol. % of the electrolyte. In other implementations, an electrolyte comprises sulfur-containing molecules at a mole fraction in a range of about 20-50 mol. % of the electrolyte. In yet other implementations, an electrolyte comprises sulfur-containing molecules at a mole fraction in a range of about 50-70 mol. % of the electrolyte.

In some designs, a total weight fraction of S-containing solvents in the L-HCE may range from about 0.01 wt. % to about 0.1 wt. %; in other designs, a total weight fraction may range from about 0.1 wt. % to about 0.2 wt. %; in other designs, a total weight fraction may range from about 0.2 wt. % to about 0.4 wt. %; in other designs, a total weight fraction may range from about 0.4 wt. % to about 0.8 wt. %; in other designs, a total weight fraction may range from about 0.8 wt. % to about 2 wt. %; in other designs, a total weight fraction may range from about 2 wt. % to about 3 wt. %; in other designs, a total weight fraction may range from about 3 wt. % to about 5 wt. %; in other designs, a total weight fraction may range from about 5 wt. % to about 10 wt. %; in other designs, a total weight fraction may range from about 10 wt. % to about 20 wt. %; in other designs, a total weight fraction may range from about 20 wt. % to about 40 wt. %; in other designs, a total weight fraction may range from about 40 wt. % to about 60 wt. %; in other designs, a total weight fraction may range from about 60 wt. % to about 70 wt. %.

In some embodiments, the solvent composition comprises one, two or more boron (B)-containing molecules. Some of such molecules may be liquid at room temperature. Some of such molecules may be solid at room temperature (thus typically used in smaller amounts in batteries operating at room temperatures). In some designs, B-containing molecules may comprise N, P, S, F or Si. Illustrative examples of such molecules include, but are not limited to: pyridine-boron trifluoride (PBF), 3-fluoro pyridine-boron trifluoride (3F-PBF), pyrazine-boron trifluoride, and borate esters (e.g., trimethyl borate, triethyl borate, triisopropyl borate, tri-tert-butyl borate, etc.). B-comprising co-solvents may enhance SEI or CEI stability, particularly at high temperatures, in some designs.

In some designs, a total weight fraction of B-containing solvents in the L-HCE may range from about 0.01 wt. % to about 0.1 wt. %; in other designs, a total weight fraction may range from about 0.1 wt. % to about 0.2 wt. %; in other designs, a total weight fraction may range from about 0.2 wt. % to about 0.4 wt. %; in other designs, a total weight fraction may range from about 0.4 wt. % to about 0.8 wt. %; in other designs, a total weight fraction may range from about 0.8 wt. % to about 2 wt. %; in other designs, a total weight fraction may range from about 2 wt. % to about 3 wt. %; in other designs, a total weight fraction may range from about 3 wt. % to about 5 wt. %.

In some embodiments, the solvent composition comprises one, two or more silicon (Si)-containing molecules. Illustrative examples of such molecules may include but are not limited to: (i) siloxanes (e.g., hexamethyldisiloxane, octamethyltrisiloxane, etc.); (ii) silanes (e.g., diphenyl silane, etc.).

In some designs, a total weight fraction of Si-containing solvents in the L-HCE may range from about 0.1 wt. % to about 0.2 wt. %; in other designs, a total weight fraction may range from about 0.2 wt. % to about 0.4 wt. %; in other designs, a total weight fraction may range from about 0.4 wt. % to about 0.8 wt. %; in other designs, a total weight fraction may range from about 0.8 wt. % to about 2 wt. %; in other designs, a total weight fraction may range from about 2 wt. % to about 3 wt. %; in other designs, a total weight fraction may range from about 3 wt. % to about 5 wt. %; in other designs, a total weight fraction may range from about 5 wt. % to about 10 wt. %; in other designs, a total weight fraction may range from about 10 wt. % to about 20 wt. %; in other designs, a total weight fraction may range from about 20 wt. % to about 30 wt. %; in other designs, a total weight fraction may range from about 30 wt. % to about 50 wt. %; in other designs, a total weight fraction may range from about 50 wt. % to about 70 wt. %.

In some implementations, a mole fraction (concentration) of the solvent composition in the electrolyte may be in a range of about 25 mol. % to about 75 mol. % (e.g., in a range of about 25 mol. % to about 35 mol. %, in a range of about 35 mol. % to about 45 mol. %, in a range of about 45 mol. % to about 55 mol. %, in a range of about 55 mol. % to about 65 mol. %, in a range of about 65 mol. % to about 75 mol. %, in a range of about 35 mol. % to about 50 mol. %, in a range of about 50 mol. % to about 75 mol. %, in a range of about 35 mol. % to about 40 mol. %, in a range of about 40 mol. % to about 50 mol. %, in a range of about 50 mol. % to about 60 mol. %, or in a range of about 60 mol. % to about 70 mol. %).

In some implementations (e.g., in designs in which LiPF₆ is employed in the lithium salt composition, among others), a molar ratio of the solvent composition to the LiPF₆ salt may be in a range of about 0.1 to about 5 (e.g., about 0.1 to about 0.5; or about 0.5 to about 1; or about 1 to about 2, or about 2 to about 3, or about 3 to about 4 or about 4 to about 5).

In some implementations (e.g., in designs in which LiTFSI is employed in the lithium salt composition, among others), a molar ratio of the solvent composition to the LiTFSI may be in a range of about 0.1 about to about 5 (e.g., about 0.1 to about 0.5; or about 0.5 to about 1; or about 1 to about 2, or about 2 to about 3, or about 3 to about 4 or about 4 to about 5).

In some implementations (e.g., in designs in which LiFSI is employed in the lithium salt composition, among others), a molar ratio of the solvent composition to the LiFSI may be in a range of about 0.1 to about 5 (e.g., about 0.1 to about 0.5; or about 0.5 to about 1; or about 1 to about 2, or about 2 to about 3, or about 3 to about 4 or about 4 to about 5).

In one or more embodiments of the present disclosure, the L-HCE includes a diluent composition. The diluent composition preferably includes compounds in which the electrolyte's salt(s) (e.g., LiFSI, among many others listed herein) have solubility of less than about 0.3 M. Furthermore, the compounds of the diluent composition are preferably sufficiently stable against reduction at the anode and oxidation at the cathode, either by being unreactive or by undergoing passivation reactions. In some implementations, the compounds of the diluent composition preferably do not vaporize from the electrolyte mixture at temperatures below about 60 to about 80° C. In some cases, some vaporization of electrolyte components may be acceptable if the cell container is able to withstand the high pressure from gases formed inside the cell. In some implementations, the compounds of the diluent composition preferably do not solidify or precipitate from the electrolyte mixture at temperatures above about −30 to about −10° C. In some implementations, at least half (by weight) of the diluent composition exhibit a melting point or a glass transition temperature below about −30° C. (in some designs, from about −120° C. to about −90° C.; in other designs, from about −90° C. to about −70° C.; in other designs, from about −70° C. to about −50° C.; in other designs, from about −50° C. to about −30° C.).

In some implementations, the diluent composition may comprise a fluorinated ether (e.g., 1,1,2,2-tetrafluoroethyl-2,2,3,3-tetrafluoropropyl ether (TTE), melting point of about −94° C.), or an alkane (e.g., heptane, melting point of about −90.6° C.).

In some implementations, the diluent composition in the L-HCE (electrolyte) may be in the range of about 5-75 mol. % (e.g., in the range of about 5-15 mol. %, about 15-25 mol. % or about 25-35 mol. % or about 35-55 mol. % or about 55-75 mol. %) of the electrolyte.

In some implementations, the diluent composition may include one, two or more fluorinated ethers. Illustrative examples of suitable fluorinated ethers include, but are not limited to: 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether (an isomer of TTE), tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane, to name a few.

Illustrative examples of chemical formulas for the suitable fluorinated ethers may include, but are not limited to: CHF₂CF₂—O—CH₃, CHF₂CF₂—O—CH₂CH₃, CHF₂CF₂CH₂—O—CH₃, CF₃CF₂CF₂—O—CH₃, CF₃CF₂CH₂—O—CHF₂, CHF₂CF₂CH₂—O—CHF₂, CF₃CHFCF₂—O—CH₂CH₃, CF₃CHFCF₂—O—CH₂CF₃, CF₃CF₂CF₂—O—CHFCF₃, CF₃CHFCF₂—O—CH₂CF₂CH₂F, or CF₃CHFCF₂—O—CH₂CF₂CH₂F, to name a few.

In some implementations, fluorinated ethers such as TTE may be preferable due to chemical and electrochemical stability at both the anode and the cathode. In some implementations, a mole fraction of the fluorinated ether(s) in the electrolyte is in a range of about 20-35 mol. %. In other implementations, a mole fraction of the fluorinated ether(s) in the electrolyte is in a range of about 5-20 mol. %.

In some implementations, the diluent composition includes 1,1,2,2-tetrafluoroethyl-2,2,3,3-tetrafluropropyl ether (TTE), shown as 208 in FIG. 2. In some implementations, TTE may constitute at least about 90 wt. % (e.g., about 90-about 95 wt. %, about 95-about 99 wt. %, or about 99-about 100 wt. %) of the diluent composition. In some implementations in which TTE is employed in the diluent composition, the mole fraction (concentration) of the TTE in the electrolyte may be in a range of about 15 mol. % to about 40 mol. % (e.g., in a range of about 15 mol. % to about 25 mol. %, or in a range of about 25 mol. % to about 40 mol. %). In some implementations in which TTE is employed in the diluent composition, the mole fraction (concentration) of the TTE in the electrolyte may be in a range of about 40 mol. % to about 55 mol. %. In some implementations in which TTE is employed in the diluent composition, a molar ratio of solvent composition to the TTE is in a range of about 1 to about 5 (e.g., about 1 to about 2, about 2 to about 3, about 3 to about 4, or about 4 to about 5).

In some embodiments, the diluent composition may comprise one, two or more amines (including fluorinated amines). Illustrative examples of suitable fluorinated amines include, but are not limited to: trimethylamine, triethylamine, tripropylamine, di-isopropylamine, perfluorotriethylamine ((CF₃CF₂)₃N) (and other similarly structured amines (e.g., perfluoromethyldiethylamine (CF₃CF₂)₂CF₃N), perfluoroethyldimethylamine (CF₃CF₂)₁(CF₃)₂N), among others)), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), 2,2,2-trifluoro-1-phenylethylamine (C₈H₈F₃N), other amines of the general formula (CH₃(CH₂)ₙ)ₘNH₃₋ₘ where n is an integer between 0 and 12 and m is 2 or 3, other (partially) fluorinated amines with the general formula CF₃(CH₂)ₙNH₂, where n is an integer between 2 and 12, and other (partially) fluorinated amines with the general formula CF₃(CH₂)ₙ₁(CF₂)ₙ₂NH₂, where (a) n1 is an integer between 0 and 12 and (b) n2 is an integer between 0 and 12.

In some embodiments, the solvent composition may comprise one, two, or more amines. Illustrative examples of suitable fluorinated amines include, but are not limited to: methylamine, fluoromethylamine, trifluoromethylamine, difluoroethylamine, and diethylamine, among others.

In some implementations, a mole fraction of the fluorinated amine(s) in the L-HCE (electrolyte) is in a range of about 0.1-75 mol. % (in some implementations, in a range of about 0.1-5 mol. %; in other implementations, in a range of about 5-15 mol. %; in other implementations, in a range of about 15-25 mol. %; in other implementations, in a range of about 25-35 mol. %; in other implementations, in a range of about 35-50 mol. %; in yet other implementations, in a range of about 50-75 mol. %).

In some embodiments, the solvent composition may comprise one, two, or more sulfonyl fluorides. Sulfonyl fluorides may have the added benefit of forming a stable SEI on the anode and/or CEI on the cathode. Illustrative examples of suitable sulfonyl fluorides include, but are not limited to: 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, and other fluorinated alkyl sulfonyl fluorides of the general formula CF₃(CF₂)ₙSO₂F where n is an integer between 0 and 7; ethane sulfonyl fluoride, propane sulfonyl fluoride, butane sulfonyl fluoride, and other non-fluorinated-alkyl sulfonyl fluorides with the general formula of CH₃(CH₂)˜SO₂F where n is an integer between 0 and 4; and partially fluorinated sulfonyl fluorides with the general formula CₓH_{y}F_{z} SO₂F where x is an integer between 1 and 6, each of y and z is respectively an integer, x, y, and z being related by y+z=2x+1. In some implementations, fluorinated sulfonyl fluorides, especially perfluorinated sulfonyl fluorides, may be advantageous because of their exceptional inertness against the cathode for any reaction other than the CEI forming reaction. In some implementations, an electrolyte comprises about 1-10 mol. % of sulfonyl fluorides. In other implementations, an electrolyte comprises about 10-20 mol. % of sulfonyl fluorides. In yet other implementations, an electrolyte comprises about 20-50 mol. % of sulfonyl fluorides. In yet other implementations, an electrolyte comprises about 50-70 mol. % of sulfonyl fluorides.

In some implementations, the diluent composition of L-HCE may comprise one, two or more alkanes, including fluorinated alkanes. Illustrative examples of such alkanes (including fluorinated alkanes) include, but are not limited to: heptanes (C₇H₁₆), octanes (C₈H₁₈), nonanes (C₉H₂₀), fluoroheptanes, difluorooctanes (C₈H₁₆F₂), fluorononanes (C₉H₁₉F), other alkanes with the general formula CₚH₂ₚ₊₂, where p is an integer between 7 and 20 (e.g., in some implementations, between 5 and 20); and other fluorinated alkanes with the general formula C_{q}H_{q1}F_{q2}, in which q is an integer between 6 and 20 (e.g., in some implementations, between 4 and 20), each of q₁ and q₂ is respectively an integer, q, q₁, and q₂ being related by q₁+q₂=2q+2.

In some implementations, alkanes may reduce undesirable high-temperature (HT) outgassing (especially on charged cells) and minimize the undesirable increase in cell internal resistance due to exposure to high temperature. In some implementations non-fluorinated alkanes may be advantageous compared to fluorinated diluents due to their relative chemical and electrochemical stability, low density (allowing high gravimetric energy density), better long-term environmental impact (e.g., no C—F bonds) and lower cost. In some implementations, alkanes may be preferable due to their weak intermolecular forces, decreasing the electrolyte viscosity and increasing the rate capability through faster diffusion and conductivity.

In some implementations, a mole fraction of the alkane(s) (including fluorinated alkane(s)) in the L-HCE (electrolyte) is in a range of about 0.1-75 mol. % (in some implementations, in a range of about 0.1-5 mol. %; in other implementations, in a range of about 5-15 mol. %; in other implementations, in a range of about 15-25 mol. %; in yet other implementations, in a range of about 25-35 mol. %; in yet other implementations, in a range of about 35-50 mol. %; in yet other implementations, in a range of about 50-75 mol. %). In some implementations, alkanes may have limited solubility (miscibility) with the other components of the electrolyte, and may make up a relatively small fraction (e.g., mole fraction) of the electrolyte. For example, in an electrolyte with LiPF₆, VC, FEC, and EP combined in mole ratios of about 11:3:26:47, respectively, the maximum miscibility of heptane in this electrolyte is about 17 mol. %.

In some embodiments, one, two, or more aromatics may be employed in the electrolyte. Depending on factors such as the choice of the salt(s) (e.g., Li salts) and the degree of solubility of the salt(s) in the respective aromatic, the respective aromatic may function as a diluent or a solvent. In some implementations, the diluent (or solvent) composition may comprise one, two or more aromatics. In some designs, such aromatics suitable for use in electrolytes may comprise side groups. In some designs, at least some of the suitable aromatics are liquid at room temperature. In other designs, at least some of the suitable aromatics are solid at room temperature. In some designs, the suitable aromatics include heteroaromatic compounds. In some designs, suitable aromatics may comprise Si, B, P, N and/or O. Illustrative examples of suitable aromatics compounds include, but are not limited to: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄). In some implementations, one or more of the foregoing aromatics may be used in a diluent composition. In addition, one or more of certain aromatics that are ring-fluorinated pyridines (e.g., fluoropyridines (C₅H₄FN), difluoropyridines (C₅H₃F₂N), trifluoropyridines (C₅H₂F₃N), tetrafluoropyridines (C₅HF₄N), etc.), as well as their similarly structured variations, may be used in an electrolyte in a diluent composition or a solvent composition depending on the implementation.

In some implementations, aromatics may be effectively used for overcharge protection of the cathode because they can be oxidized at the cathode. In some implementations, aromatics may help to reduce HT gassing and the increase in cell internal resistance due to exposure to high temperature. However, in some implementations, if the surface and/or salt reactions are passivated, aromatics may be used at higher mole fractions in the electrolyte. In some implementations, fluorinated aromatics may be preferable due to their greater electrochemical stability towards oxidation reactions at the cathode that generate gas, especially at higher temperatures (e.g., >about 40° C.). In some implementations, a mole fraction of aromatic molecules in an electrolyte may be in a range of about 0-5 mol. %, about 5-15 mol. %, about 15-35 mol. %, about 35-50 mol. %, or about 50-75 mol. %.

Many good candidate molecules for the diluent composition are fluorinated. Fluorinated organics have the performance advantage of forming a very stable C—F bond (in particular against oxidation at the cathode), while fluorine is the lightest halide element, minimizing the increase in solvent density (an increase in solvent density would lead to a decrease in the gravimetric energy density of the cell). Fluorinated organic molecules may have higher boiling points due to higher molar mass. Solvents which do not dissolve salt tend to have intermolecular forces dominated by dispersion forces and have low dielectric constant (i.e., only weakly shield the electric field between the salt anion and cation). Apart from aromatics and alkanes, molecules with slightly higher dielectric constants may be modified by fluorination to reduce the dielectric constant and be used as a diluent, such as in the case of ethers.

In some implementations, the presence of certain surface passivating salts (e.g., LiFSI or LiDFOB, among many others) and/or diluents (e.g., TTE, among many others) in a L-HCE (electrolyte) may reduce the need for other SEI builders, enabling electrolytes that comprise FEC, VC, and/or EC at relatively low mole fractions while attaining high cycle life. For example, if the electrolyte comprises LiFSI at a mole fraction in a range of about 10 mol. % to about 25 mol. % (e.g., in a range of about 10 to about 15 mol. %, in a range of about 15 to about 18 mol. %, in a range of about 18 to about 20 mol. %, in a range of about 20 to about 22 mol. %, or in a range of about 22 to about 25 mol. %), lower FEC, VC, and EC mole fractions may be sufficient to achieve high cycle life.

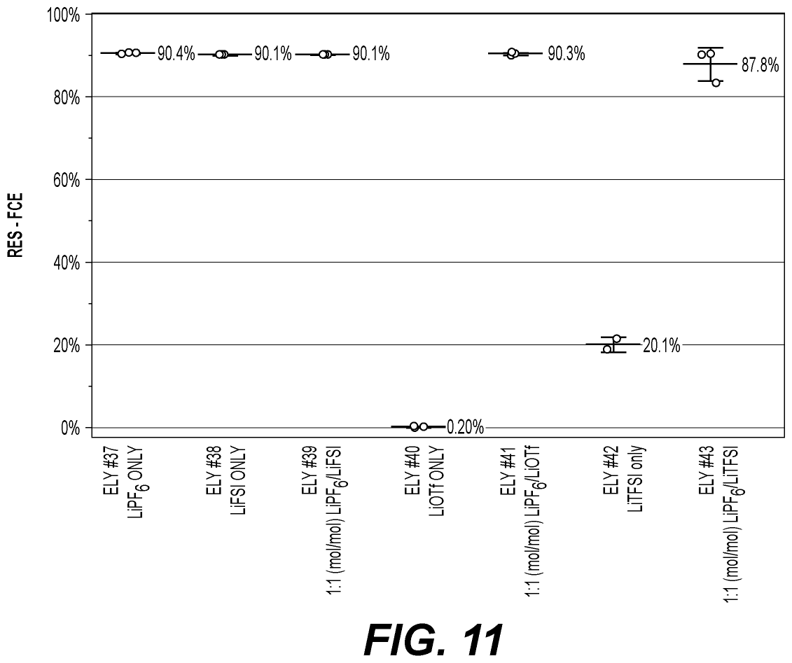

In some implementations, the primary salt (e.g., LiTFSI, LiOTf, or LiFSI in certain cases, or others) may cause corrosion of the Al current collector of the cathode, if the total salt mole fraction (concentration) is too low and the diluent mole fraction (concentration) is not sufficiently high. In such cases, it may be preferable for the electrolyte to comprise one or more aluminum passivating salts (e.g., LiPF₆) as a secondary salt at sufficiently high concentrations (e.g., in some implementations, such as the examples shown in FIG. 11, a concentration of about 0.6 M of LiPF₆ in the electrolytes was found to be sufficient to obtain significant beneficial effects on performance characteristics such as first-cycle efficiency; in other implementations, concentrations higher than or lower than about 0.6 M may be needed) to passivate the aluminum current collector against the primary salt.

In one or more embodiments of the present disclosure, if the electrolyte of the lithium-ion battery has a low ionic conductivity at room temperature (e.g., <about 3 mS/cm) and the areal capacity loading is high (e.g., >about 4 mAh/cm²), the battery may suffer from low rate capability and high cell resistance when cycled at room (or lower) temperatures, which may result in one or more of the following battery characteristics: low discharge voltage, low cycle life, low calendar life, high HT gassing, and inferior low-temperature performance. In some designs, if a cell has low rate capability, it may induce a high voltage on the cathode, causing unwanted oxidation reactions such as those that cause non-Li metals to be removed from the cathode active material, unwanted gases to be evolved, and/or current collector corrosion. In some designs, if a cell has low rate capability, the anode and/or cathode may degrade more rapidly due to some particles undergoing more volume change than others. In some designs, if a cell has low rate capability, the cell may degrade through the plating of Li metal at the anode. As such, an L-HCE composition needs to be carefully optimized for a particular cell design and battery operating conditions. For Li-ion battery cells with areal capacity loadings of about 4mAh/cm² or higher, it may be advantageous to attain L-HCE conductivity larger than about 3 mS/cm at (e.g., typical) operating temperatures (in some designs, larger than about 4 mS/cm; in other designs, larger than about 5 mS/cm; in other designs, larger than about 6 mS/cm; in other designs, larger than about 7 mS/cm; in other designs, larger than about 8 mS/cm; in other designs, larger than about 9 mS/cm; in other designs, larger than about 10 mS/cm; in other designs, larger than about 12 mS/cm; in other designs, larger than about 15 mS/cm). In some designs, such a typical operating temperature may be near room temperature (e.g., in a range of about 20° C. to about 30° C.).

In one or more embodiments of the present disclosure, a lithium-ion battery may include an anode current collector, a cathode current collector, an anode disposed on and/or in the anode current collector, a cathode disposed on and/or in the cathode current collector, and any one of the electrolytes as described herein ionically coupling the anode and the cathode. For example, there may be a separator interposed in a space between the anode and the cathode, with the electrolyte impregnating the separator. In some implementations, the anode can comprise (A) Si-comprising particles (e.g., Si—C nanocomposite particles comprising carbon and silicon which contribute to about 75-100 wt. % of such particles (e.g., (1) with the silicon part being arranged as active material particles and the carbon forming an inactive or substantially inactive part of scaffolding matrix with pores (sometimes referred to as porous carbon) in which the silicon active material is disposed therein, and/or (2) with the silicon part being arranged as active materials particles in the composite particles and a carbon coating or a carbon shell being arranged around the composite particles) and/or (B) graphitic carbon particles comprising carbon (e.g., with carbon-comprising graphite as an active material) and being substantially free of silicon. In the case of (A) above, at least some of the silicon may be present in the composite particles as nanosized silicon and/or nanostructured silicon. In some implementations, the anode may contain a mixture of (A) silicon-carbon nanocomposite particles and (B) graphitic carbon particles. In such cases, the anode is sometimes referred to as a blended anode herein. In some implementations, a mass of the silicon may be in a range of about 10 wt. % to about 90 wt. % of a total mass of the anode (not counting the weight of the current collector). In some implementations, the anode may additionally include carbon nanotubes (e.g., single-wall carbon nanotubes or double-wall carbon nanotubes or multi-wall carbon nanotubes) at a concentration of less than about 1 wt. % of the anode (not counting the weight of the current collector). In some implementations, the anode may include carbon black particles at a concentration of more than about 1 wt. % of the anode (not counting the weight of the current collector). In some implementations, the anode may include graphene (e.g., multi-layered/multi-walled graphene), graphene oxide (e.g., multi-layered/multi-walled graphene) or exfoliated graphite particles at a concentration of more than about 1 wt. % of the anode (not counting the weight of the current collector).

In some implementations, the diluent composition may improve the rate capability, reduce HT gassing, improve low temperature performance, improve calendar life, and reduce the cost. Rate capability and low temperature performance may be improved through the lowering of the viscosity of the electrolyte and the reduction of the charge-transfer resistance at the anode and cathode. Cost may be reduced by reducing the total salt concentration in the electrolyte, and/or by enabling a faster formation at higher temperatures. In some implementations, the diluent composition may be inert to reduction at the anode, oxidation at the cathode, and chemical decomposition through interaction with a salt or other organic and inorganic components. TTE is one such example of a diluent compound that exhibits beneficial effects. In other implementations, the diluent can promote self-passivating reactions, forming stable SEI at the anode and CEI at the cathode to prevent undesirable reactions. Both can be advantageous to prevent reactions at HT storage that cause an increase in cell impedance and/or gas generation; to extend the cell's calendar life and cycle life; and/or to improve the high rate cycle life of the cell.

In one illustrative example (referred to as Cell Design A), a test pouch-type Li-ion battery cell with capacity of about 0.22 Ah may comprise: (i) an anode with Si—C nanocomposite active material particles (with specific reversible capacity of about 1500 mAh/g when normalized to the mass of the anode without the current collector foil) casted on Cu current collector foil from a water-based suspension comprising a polyacrylic acid based binder and a carbon black conductive additive, (ii) a cathode with LCO (LiCoO₂) active material particles casted on Al current collector foil from an organic solvent suspension comprising a polyvinylidene fluoride (PVDF)-based binder and a carbon black conductive additive, anode:cathode areal capacity ratio of about 1.15:1 and cycle start areal capacity loading of about 2.85 mAh/cm², charge voltage of about 4.4V, (iii) a polyethylene separator, and (iv) about 2.56 μL/Ah of electrolyte. Herein, a mass of an electrode (e.g., an anode) refers to a mass of the electrode with the mass of the current collector excluded, even if the electrode is deposited on and/or in the current collector.

In another illustrative example (Cell Design B), a test pouch-type Li-ion battery cell with capacity of about 0.54 Ah may comprise: (i) an anode with Si—C nanocomposite active material particles (with specific reversible capacity of about 1500 mAh/g when normalized to the mass of the anode without the current collector foil) casted on Cu current collector foil from a water-based suspension comprising a polyacrylic acid based binder and a carbon black conductive additive, (ii) a cathode with single crystalline high-Ni NCM (approximately LiNi_{0.8}Co_{0.1}Mn_{0.1}O₂) active material particles casted on Al current collector foil from an organic solvent suspension comprising a polyvinylidene fluoride (PVDF)-based binder and a carbon black conductive additive, anode:cathode areal capacity ratio of about 1.15:1 and cycle start areal capacity loading of about 4.1 mAh/cm², charge voltage of about 4.2V, (iii) a polyethylene separator, and (iv) about 1.82 μL/Ah of electrolyte.

In another illustrative example (Cell Design C), a test pouch-type Li-ion battery cell with capacity of about 0.155 Ah may comprise: (i) an anode with Si—C nanocomposite active material particles (with specific reversible capacity of about 1500 mAh/g when normalized to the mass of the anode without the current collector foil) casted on Cu current collector foil from a water-based suspension comprising a poly(vinyl alcohol) based binder and a carbon black conductive additive, (ii) a cathode with LCO (LiCoO₂) active material particles casted on Al current collector foil from an organic solvent suspension comprising a polyvinylidene fluoride (PVDF)-based binder and a carbon black conductive additive, anode:cathode areal capacity ratio of about 1.1:1 and cycle start areal capacity loading of about 2.7 mAh/cm², charge voltage of about 4.2V, (iii) a polyethylene separator, and (iv) about 2.51 μL/Ah of electrolyte.

In another illustrative example (Cell Design D), a test pouch-type Li-ion battery cell with capacity of about 0.165 Ah may comprise: (i) an anode with Si—C nanocomposite active material particles (with specific reversible capacity of about 1500 mAh/g when normalized to the mass of the anode without the current collector foil) casted on Cu current collector foil from a water-based suspension comprising a poly(vinyl alcohol) based binder and a carbon black conductive additive, (ii) a cathode with LCO (LiCoO₂) active material particles casted on Al current collector foil from an organic solvent suspension comprising a polyvinylidene fluoride (PVDF)-based binder and a carbon black conductive additive, anode:cathode areal capacity ratio of about 1.1:1 and cycle start areal capacity loading of about 2.7 mAh/cm², charge voltage of about 4.4V, (iii) a polyethylene separator, and (iv) about 2.36 μL/Ah of electrolyte.

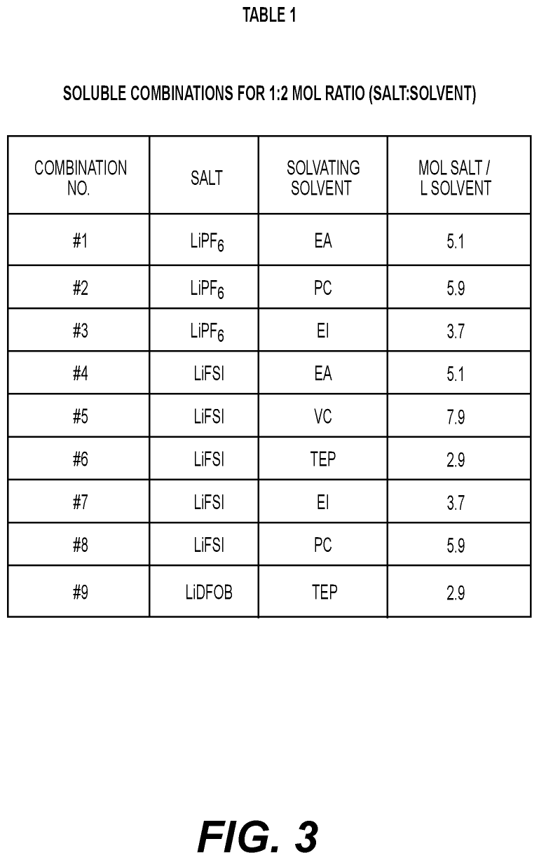

Table 1 (FIG. 3) shows some illustrative combinations of salt and solvent that were found to be soluble at a molar ratio of about 1:2 respectively, when mixed at room temperature (˜25° C.). The ratio of moles salt to liters of solvent is shown as a rough estimate of the molar concentration of the resulting mixture. Solvents were added to salts and left to mix for approximately 16 hours in a bench top automatic rocking platform shaker. The electrolytes were then observed for results (solubility) using a flashlight to make sure that all of the salt had fully dissolved. The salt composition was deemed soluble if no visible salt was seen or no reflections from the salts were seen while using the flashlight, and the liquid was clear. If all of the salt did not dissolve completely, the bottles were placed back in the shaker and left again overnight.

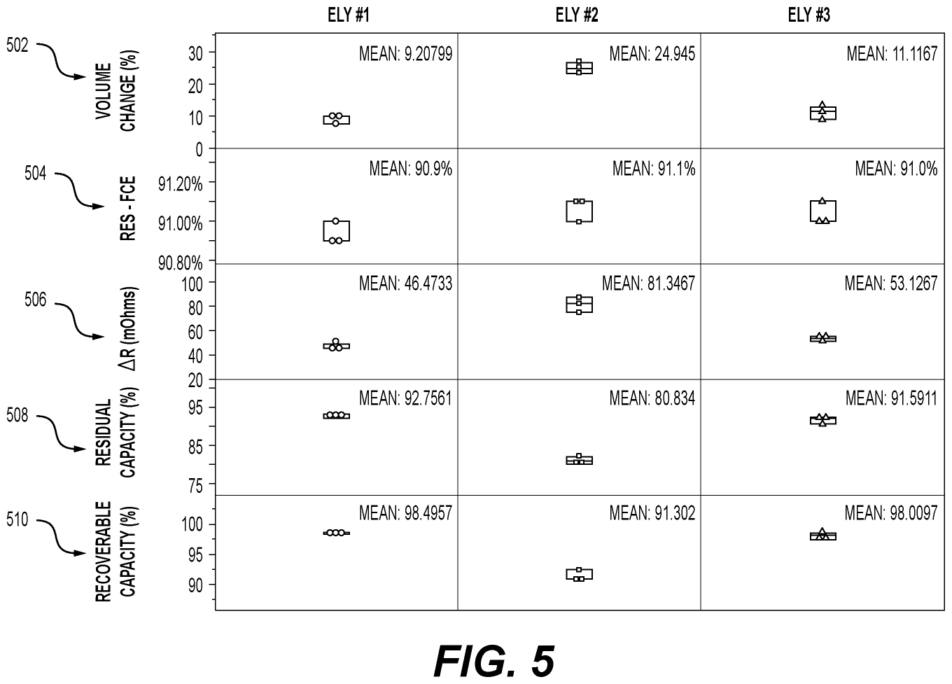

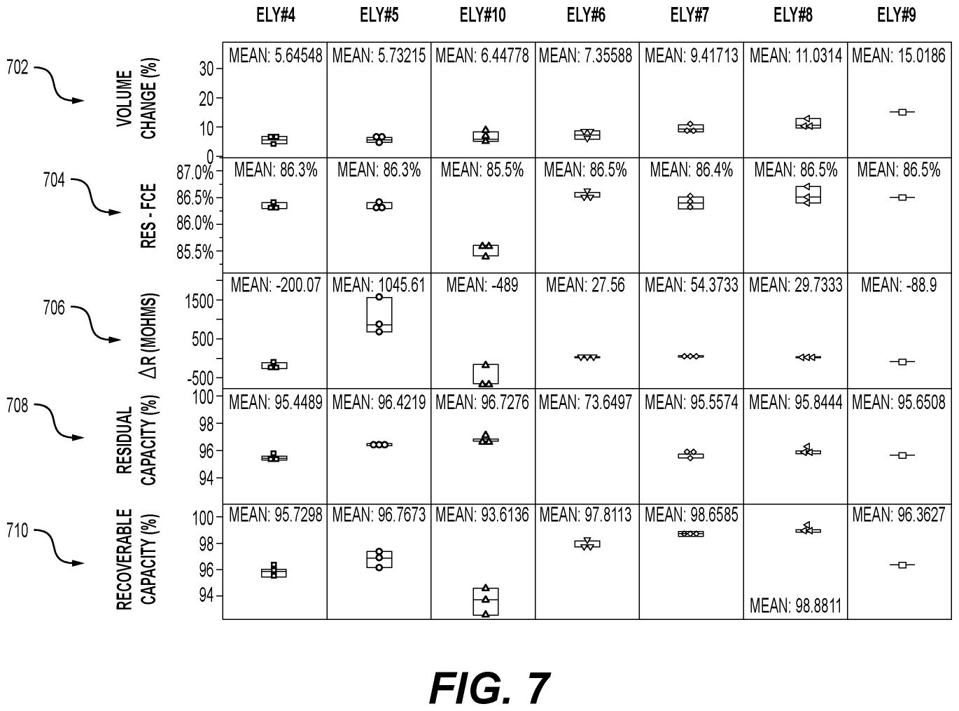

FIGS. 5 and 7 show the results of HT storage testing with various example electrolytes in Cell Designs A and B, respectively. The cells underwent a first charge-discharge cycle with a 0.1 C current, with the ratio of discharge/charge capacity defined as the first-cycle efficiency (504, 704). Cells of Cell Design A were charged to an upper cutoff voltage of 4.4 V and then discharged to 2.5 V, while cells of Cell Design B were charged to an upper cutoff voltage of 4.2 V and then discharged to 2.5 V. The cells were then charged at 0.2C to an intermediate voltage of 4.0 V or 3.5 V for cell Designs A and B, respectively, degassed under vacuum, and resealed. The cells then underwent a second cycle at 0.2C, including a constant voltage hold after the 0.2C charge at their respective upper cutoff voltages until the current fell to 0.05C (referred to as a 0.2C→0.05C charge). The discharge capacity of this cycle is defined as the “initial capacity.” The cells were then finally charged a third time at 0.2C→0.05C to their respective upper cutoff voltages. The cells' AC resistances were then measured and their internal volumes were measured using the Archimedes method. Cells of Cell Design A were then stored at 72° C. for 60 h, while cells of Cell Design B were stored at 60° C. for 72 h. The AC resistances and cell volumes were then measured after the storage period—the change in internal resistance (AR) (506, 706) and volume change metrics (502, 702) in FIGS. 5 and 7 are defined as the change in these values between the pre- and post-storage measurements. The cells were then discharged to 2.5 V at 0.2C—the ratio of this discharge capacity to the initial capacity is defined as the “residual capacity” (508, 708) in FIGS. 5 and 7. The cells then underwent another 0.2C→0.05C charge to their upper cutoff voltages and a 0.2C discharge to 2.5V. The ratio of this discharge capacity to the initial capacity is defined as the “recoverable capacity” (510, 710) in FIGS. 5 and 7.

Factors such as L-HCE composition, the so-called “formation protocol” (temperature, charge and discharge rates, constant current vs. pulsed current vs. oscillating current during initial charging, etc.), anode particle surface chemistry, binder chemistry, etc., affect the composition and properties of the SEI on the anode particle surfaces and the CEI on the cathode particle surfaces. L-HCE composition, in particular, may have a significant impact on the SEI and CEI composition and be selected to tune SEI composition and microstructure to be more favorable. For example, higher volume and mass fractions of inorganic Li-containing nanoparticles in the suitable or preferable Si-comprising anode particles' SEI commonly leads to higher cell stability and better cell performance characteristics. Higher volume and mass fractions of LiF (e.g., in the form of LiF nanoparticles) in the suitable or preferable Si-comprising anode particles' SEI commonly leads to higher cell stability and better cell performance characteristics (e.g., higher calendar life, higher cycle stability, better performance at elevated temperatures, better performance at room or low temperatures, etc.). Higher volume and mass fractions of LiF (e.g., in the form of LiF nanoparticles) in the near-particle fraction of the SEI on suitable or preferable Si-comprising anode particles SEI commonly leads to higher cell stability and better cell performance characteristics. More uniform distribution of LiF (e.g., in the form of LiF nanoparticles) in the SEI on suitable or preferable Si-comprising anode particles may lead to higher cell stability and better cell performance characteristics. For example, formation of a high fraction of LiF on the outer surface of the SEI with prolonged cycling (e.g., after about 500 full charge-discharge cycles) may be undesirable. In some designs, it may be preferable for the SEI on the suitable or preferable Si-comprising anode particles to comprise Li₂O (e.g., in the form of Li₂O nanoparticles) (e.g., to attain higher calendar life, higher cycle stability, better performance at elevated temperatures, better performance at room or low temperatures, etc.). Higher volume and mass fractions of Li₂O (e.g., in the form of Li₂O nanoparticles) in the near-particle fraction of the SEI on suitable or preferable Si-comprising anode particles SEI may lead to higher cell stability and better cell performance characteristics. More uniform distribution of Li₂O (e.g., in the form of Li₂O nanoparticles) in the SEI on suitable or preferable Si-comprising anode particles may lead to higher cell stability and better cell performance characteristics. In some designs, it may be preferable for the SEI on the suitable or preferable Si-comprising anode particles to comprise Li₂S or Li₂Se or both (e.g., in the form of Li₂S or Li₂Se or mixed nanoparticles) (e.g., to attain higher calendar life, higher cycle stability, better performance at elevated temperatures, better performance at room or low temperatures, etc.). Higher volume and mass fractions of Li₂S or Li₂Se or both (e.g., in the form of Li₂S or Li₂Se or mixed nanoparticles) in the near-particle fraction of the SEI on suitable or preferable Si-comprising anode particles SEI may lead to higher cell stability and better cell performance characteristics. More uniform distribution of Li₂S or Li₂Se or both (e.g., in the form of Li₂S or Li₂Se or mixed nanoparticles) in the SEI on suitable or preferable Si-comprising anode particles may lead to higher cell stability and better cell performance characteristics. In some designs, it may be preferable for the SEI on the suitable or preferable Si-comprising anode particles to comprise both LiF and at least one other Li-comprising inorganic component (e.g., Li₂O or Li₂S or Li₂Se or Li₃N or their various mixtures and combinations; in the Li₂O case in the form of Li₂O and LiF nanoparticles; in some designs, with Li₂O and LiF having an intimate contact with each other; in some designs, in the form of composite or intermixed Li₂O—LiF nanoparticles; in the Li₂S case in the form of Li₂S and LiF nanoparticles; in some designs, with an intimate contact with each other; in some designs, in the form of composite or intermixed Li₂S—LiF nanoparticles, etc.). As such, it may be desirable to down-select L-HCE compositions that favor a higher fraction of one or more of. LiF, Li₂O, Li₂S, Li₂Se, LiF—Li₂O intermixed nanoparticles, LiF—Li₂S intermixed nanoparticles, LiF—Li₂Se intermixed nanoparticles, LiF—Li₂O—Li₂S intermixed nanoparticles, LiF—Li₂O—Li₂Se intermixed nanoparticles, LiF—Li₂O—Li₂(S—Se)intermixed nanoparticles, etc.) within the anode SEI. In some designs, it may be preferable for the SEI formed within the first about 50 cycles to comprise about 10-75 wt. % inorganic components (in some designs, from about 10 to about 20 wt. %; in other designs, from about 20 to about 30 wt. %; in other designs, from about 30 to about 40 wt. %; in other designs, from about 40 to about 50 wt. %; in other designs, from about 50 to about 60 wt. %; in other designs, from about 60 to about 75 wt. %). In some designs, it may be preferable for the SEI formed within the first 50 cycles to comprise about 2-50 wt. % LiF (in some designs, from about 2 to about 5 wt. %; in other designs, from about 5 to about 10 wt. %; in other designs, from about 10 to about 20 wt. %; in other designs, from about 20 to about 50 wt. %). In some designs, it may be preferable for the SEI formed within the first about 50 cycles to comprise about 2-50 wt. % Li₂O (in some designs, from about 2 to about 5 wt. %; in other designs, from about 5 to about 10 wt. %; in other designs, from about 10 to about 20 wt. %; in other designs, from about 20 to about 50 wt. %). The SEI composition may be estimated from X-ray photoelectron spectroscopy (XPS), secondary emission mass spectrometry (SIMS) and many other suitable techniques (e.g., including those by using synchrotron measurements).

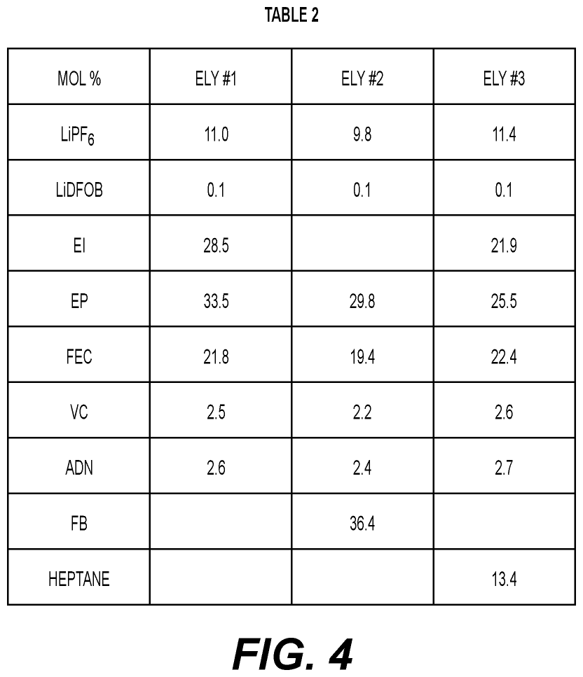

FIG. 5 shows the results of HT storage testing in Cell Design A pouch cells with electrolytes ELY #1, ELY #2, and ELY #3. The molar composition of the electrolytes is shown in Table 2 (FIG. 4). ELY #1 is an example of an ester-based (comprising EI) electrolyte. ELY #2 is an example of an electrolyte containing fluorobenzene (FB). ELY #3 is an example of an electrolyte containing heptane. Both ELY #2 and ELY #3 are examples of electrolytes containing weakly coordinating electrolyte molecules (i.e., diluents). Both ELY #2 and ELY #3 show slightly improved FCE over ELY #1, which could be due to the altered Li-ion solvation structure, increased contact ion pairs, and/or increased salt anion reduction at the anode increasing the LiF content in the anode SEI and improving the passivation of the anode parasitic reactions. ELY #2 shows a larger volume change (502, FIG. 5) than the other electrolytes during HT storage, while ELY #3 shows a similar volume change (502), internal resistance change AR (506), residual capacity (508), and recoverable capacity (510) to the ester-based ELY #1, indicating that heptane is oxidatively stable at high voltages (>4.4 V) and does not contribute to cell degradation at high voltage.

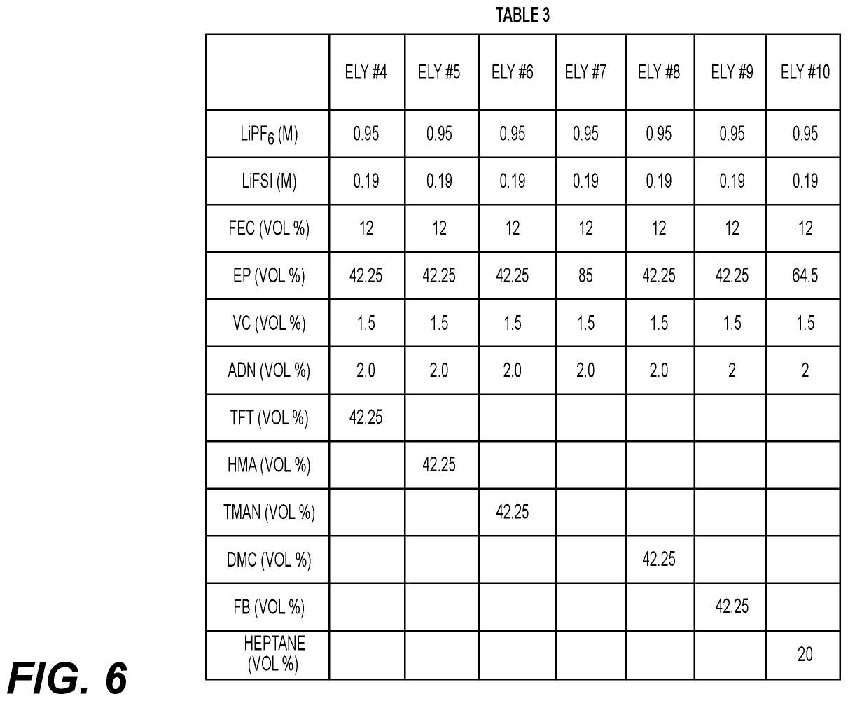

FIG. 7 shows the results of HT storage testing in Cell Design B pouch cells with electrolytes comprising ELYs #4 to #10. The compositions of the electrolytes are shown in Table 3 (FIG. 4). The ELYs #4 to #9 are of the following general composition: about 0.95 M LiPF₆ and about 0.19 M LiFSI, dissolved in about 12 vol. % FEC, about 42.25 vol. % EP, about 1.5 vol. % VC, about 2.0 vol. % ADN, and about 42.25 vol. % of one other co-solvent or diluent (i.e., some of the example ELYs comprised an additional co-solvent and some others of the example ELYs comprised a diluent). For ELYs #4 to #9, the other co-solvents are hexamethylacetone (HMA) (ELY #5), trimethylacetonitrile (TMAN) (ELY #6), EP (ELY #7), and DMC (ELY #8); and the diluents are trifluorotoluene (TFT) (ELY #4), and FB (ELY #9) respectively. ELY #10 comprises about 0.95 M LiPF₆ and about 0.19 M LiFSI, dissolved in about 12 vol. % FEC, about 64.5 vol. % EP, about 1.5 vol. % VC, about 2.0 vol. % ADN, and about 20 vol. % n-heptane as diluent. The compositions of the electrolytes ELY #4-ELY #10 are also listed in Table 3 (FIG. 6).

Example ELYs #4, #9, and #10 contain diluents (TFT, FB, and n-heptane, respectively). In some cases, such as with TFT (ELY #4) and heptane (ELY #10), the weakly coordinating diluents are able to reduce the total gas generation (as measured by cell volume change, 702) and internal resistance change AR during HT storage (706) compared to ELY #7 (EP) and ELY #8 (DMC), which could be due to the altered Li-ion solvation structure, increased contact ion pairs, and reduced salt anion oxidation at the cathode. In some cases, such as with TFT (ELY #4) and FB (ELY #9), diluents are able to give high FCEs comparable to ELY #7 (EP) and ELY #8 (DMC), which may be due to the altered Li-ion solvation structure and increased contact ion pairs leading to reduced salt anion oxidation at the cathode and increased salt anion reduction at the anode, which could lead to the formation of a robust, passivating, mechanically stable anode SEI and/or cathode CEI containing a higher fraction of LiF, and/or other inorganic species such as Li₂O and/or Li₂CO₃ in electrolytes with weakly coordinating co-solvents.

Example ELY #5 contains HMA (a ketone), which reduces the total gas generation (as measured by cell volume change, 702), increases the residual capacity after HT storage (708), and gives comparable FCE (704) compared to ELY #7 (EP, a linear ester) and ELY #8 (DMC, a linear carbonate), which could be due to the formation of a robust, passivating cathode CEI in electrolytes containing ketones through oxidation of the ketone to insoluble products such as Li₂CO₃, Li₂O, and organic polymers, which may reduce the rate of oxidation of other ELY components at high voltage. The high FCE may also be due to the generation of passivating reduction products in the anode SEI such as Li₂CO₃, Li₂O, and organic polymers in electrolytes containing ketones.

Example ELY #6 contains a TMAN (a nitrile), which reduces the total gas generation (as measured by cell volume change, 702) and internal resistance change AR during HT storage (706), and gives comparable FCE (704) compared to ELY #7 (EP) and ELY #8 (DMC), which could be due to the formation of a robust, passivating, ionically conductive cathode CEI in electrolytes containing nitriles through decomposition of the nitrile to form insoluble products such as Li₃N and organic polymers, which may reduce the rate of oxidation of other ELY components at high voltage and reduce buildup of resistive byproducts at the anode and cathode interfaces during HT storage. The high FCE may also be due to the generation of passivating reduction products in the anode SEI such as Li₃N and organic polymers in electrolytes containing nitriles.

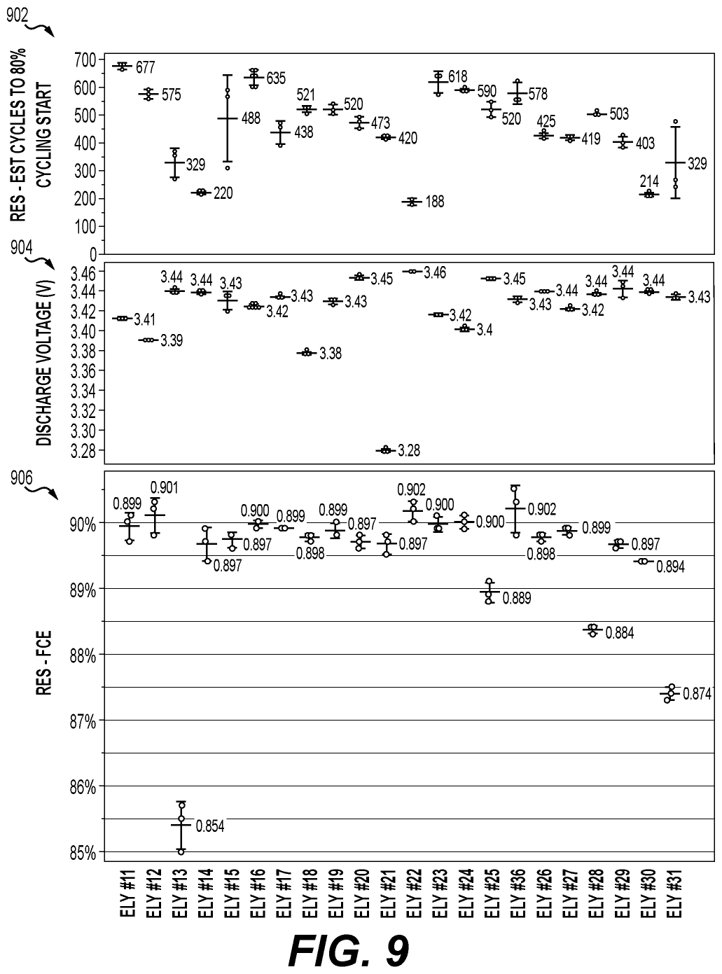

FIG. 9 shows the results of cycle life testing in example Cell Design C pouch cells with electrolytes comprising ELYs #11 to #31 and #36. The cells underwent a first charge-discharge cycle with a 0.1 C current, with the ratio of discharge/charge capacity defined as the first-cycle efficiency (FCE) (906 in FIG. 9). The cells were charged to an upper cutoff voltage of 4.2 V and then discharged to 2.5 V. The cells were then charged at 0.2C to an intermediate voltage of 4.0 V, degassed under vacuum, and resealed. The cells then underwent a capacity check cycle with a 1C→0.5C charge to 3.8V, followed by a 0.5C→0.05C charge to 4.2V, followed by a 0.2C discharge to 2.5V. The cells then underwent repeated cycling with the same charge protocol but followed by a 0.5C discharge to 2.5V. The capacity-weighted average of the discharge voltage in the first 0.5C discharge cycle is plotted as the discharge voltage (expressed in V) (904) in FIG. 9. For every 20th cycle, the cells were discharged at 0.2C to check the low-rate discharge capacity. The number of cycles it takes for the 0.2C discharge capacity to fall below 80% of the initial capacity check is referred to as the estimated number of cycles to 80% of cycling start capacity and is plotted at 902 in FIG. 9.

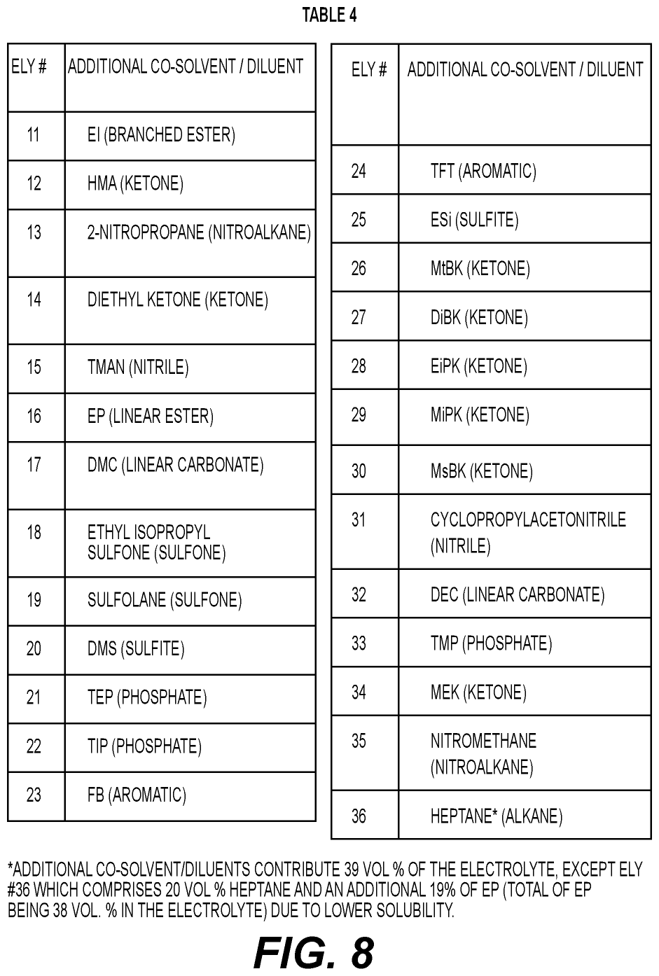

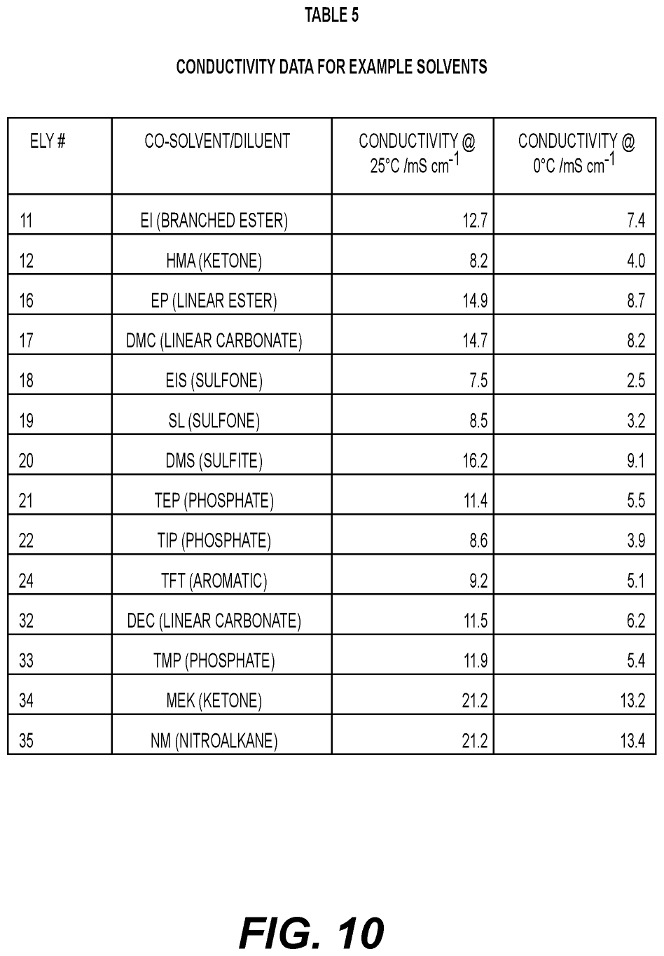

Table 5 (FIG. 10) shows the ionic conductivities of example ELYs #11, #12, #16 to #22, #24, and #32 to #35 measured using a 4-pole alternating current conductivity probe at 25° C. and 0° C. Example ELYs #11 to #35 are of the following generalized composition: about 1.15 M LiPF₆ dissolved in about 39 vol. % EP, about 2 vol. % VC, about 20 vol. % FEC, and about 39 vol. % of one other co-solvent/diluent. For ELYs #11 to #35, the other co-solvents/diluents are EI (ELY #11), HMA (ELY #12), 2-nitropropane (2NP) (ELY #13), diethyl ketone (DEK) (ELY #14), TMAN (ELY #15), EP (ELY #16), DMC (ELY #17), ethyl isopropyl sulfone (EIS) (ELY #18), sulfolane (Sl) (ELY #19), DMS (ELY #20), triethyl phosphate (TEP) (ELY #21), triisopropyl phosphate (TIP) (ELY #22), FB (ELY #23), TFT (ELY #24), ethylene sulfite (ESi) (ELY #25), pinacolone (MtBK) (ELY #26), diisobutyl ketone (DiBK) (ELY #27), ethyl isopropyl ketone (EiPK) (ELY #28), methyl isopropyl ketone (MiPK) (ELY #29), methyl sec-butyl ketone (MsBK) (ELY #30), cyclopropylacetonitrile (CPAN) (ELY #31), diethyl carbonate (DEC) (ELY #32), trimethyl phosphate (TMP) (ELY #33), methyl ethyl ketone (MEK) (ELY #34), and nitromethane (NM) (ELY #35), respectively. ELY #36 comprises about 1.15 M LiPF₆ dissolved in about 58 vol. % EP, about 2 vol. % VC, about 20 vol. % FEC, and about 20 vol. % heptane. A summary of the additional co-solvent or diluent employed in ELYs #11-36 can be found in Table 4 (FIG. 8).

Example ELYs #12 (HMA), #14 (DEK), #26 to #30 (MtBK, DiBK, EiPK, MiPK, MsBK, respectively), and #34 (MEK) contain ketones. In some cases, such as with HMA (ELY #12), MtBK (ELY #26), DiBK (ELY #27), EiPK (ELY #28), and MiPK (ELY #29), electrolytes containing the respective ketone co-solvents exhibit high cycle life characteristics (902) comparable to or greater than those of ELY #17 (DMC, a linear carbonate). In some cases, such as with HMA (ELY #12), MtBK (ELY #26), and DiBK (ELY #27), electrolytes containing the respective ketone co-solvents give high FCE values (906) comparable to those of ELY #16 (EP, a linear ester) and ELY #17 (DMC, a linear carbonate). These properties may be due to the generation of passivating decomposition products in the anode SEI and/or cathode CEI such as Li₂CO₃, Li₂O, and organic polymers in electrolytes containing ketones due to the reduction of the ketone at the anode and/or oxidation of the ketone at the cathode. In some cases, such as with DEK (ELY #14), MtBK (ELY #26), DiBK (ELY #27), EiPK (ELY #28), MiPK (ELY #29), and MsBK (ELY #30), electrolytes containing the respective ketone co-solvents show high discharge voltage values (904) comparable to or greater than those of ELY #16 (EP, a linear ester) and ELY #17 (DMC, a linear carbonate). This may be due to the high dielectric constant and dipole moment of ketone co-solvents, which could increase ion dissociation in solution and increase ionic conductivity. This may also be due to the low viscosity of ketone co-solvents, which may also increase the lithium ion diffusivity in the electrolyte and increase ionic conductivity. The high ionic conductivity of electrolytes containing ketone co-solvents is evidenced, for example, by the high conductivity of ELY #34 (MEK) shown in Table 5 (FIG. 10).

Example ELYs #13 (2NP) and #35 (NM) contain nitroalkane co-solvents, which show higher discharge voltage and much higher ionic conductivity compared to ELY #16 (EP, a linear ester) and ELY #17 (DMC, a linear carbonate). This may be due to the high dielectric constant and dipole moment of nitroalkane co-solvents, which could increase ion dissociation in solution and increase ionic conductivity. This may also be due to the low viscosity of nitroalkane co-solvents, which may also increase the lithium ion diffusivity in the electrolyte and increase ionic conductivity.

Example ELYs #15 (TMAN) and #31 (CPAN) contain nitrile co-solvents and show high discharge voltages (904) comparable to or greater than those of ELY #16 (EP, a linear ester) and ELY #17 (DMC, a linear carbonate). This may be due to the high dielectric constant and dipole moment of nitrile co-solvents, which may increase ion dissociation in solution and increase ionic conductivity. This may also be due to the low viscosity of nitrile co-solvents, which may also increase the lithium ion diffusivity in the electrolyte and increase ionic conductivity. In the case of TMAN (ELY #15), the cycle life (902) is also high and comparable to those of ELY #16 (EP, a linear ester) and ELY #17 (DMC, a linear carbonate). This may be due to the generation of passivating decomposition products in the anode SEI and/or cathode CEI such as Li₃N and organic polymers in electrolytes containing nitriles due to the reduction of the nitrile at the anode and/or oxidation of the nitrile at the cathode.

Example ELYs #18 (EIS) and #19 (Si) contain sulfone co-solvents and show high cycle life characteristics (902) comparable to or greater than those of ELY #16 (EP, a linear ester) and ELY #17 (DMC, a linear carbonate). This may be due to the generation of passivating decomposition products in the anode SEI and/or cathode CEI such as Li₂SO₃, Li₂SO₄, Li₂S, polysulfides, and organic polymers in electrolytes containing sulfones due to the reduction of the sulfone at the anode and/or oxidation of the sulfone at the cathode. In the case of Sl (ELY #19), the discharge voltage (904) is also high and comparable to those of ELY #16 (EP, a linear ester) and ELY #17 (DMC, a linear carbonate). Since the conductivity of ELY #19 is lower than those of ELYs #16 and #17 (see Table 5 of FIG. 10), this may be due to reduced interfacial resistance in sulfone-containing electrolytes, which may be due to the high ionic conductivity of the decomposition products in the anode SEI and/or cathode CEI such as Li₂SO₃, Li₂SO₄, polysulfides, and Li₂S.

Example ELYs #20 (DMS) and #25 (ESi) contain sulfite co-solvents and show much higher discharge voltages (904) and, in the case of DMS, higher ionic conductivities (Table 5, FIG. 10) than those of ELY #16 (EP, a linear ester) and ELY #17 (DMC, a linear carbonate). These properties may be due to the high dielectric constant and dipole moment of sulfite co-solvents, which may increase ion dissociation in solution and increase ionic conductivity. This may also be due to reduced interfacial resistance in sulfite-containing electrolytes, which may be due to the high ionic conductivity of the decomposition products in the anode SEI and/or cathode CEI such as Li₂SO₃, Li₂SO₄, Li₂S, and polysulfides. These example electrolytes ELYs #20 (DMS) and #25 (ESi) show high cycle life characteristics (902) comparable to or greater than those of ELY #16 (EP, a linear ester) and ELY #17 (DMC, a linear carbonate). This may be due to the generation of passivating decomposition products in the anode SEI and/or cathode CEI such as Li₂SO₃, Li₂SO₄, Li₂S, polysulfides, and organic polymers in electrolytes containing sulfites due to the reduction of the sulfite at the anode and/or oxidation of the sulfite at the cathode.

Example ELYs #21 (TEP), #22 (TIP), and #33 (TMP) contain phosphate co-solvents. In the case of TEP (ELY #21), the cycle life (902) is high and comparable to that of ELY #17 (DMC, a linear carbonate), and in the case of TIP (ELY #22), the FCE (906) is higher than those of ELY #16 (EP, a linear ester) and ELY #17 (DMC, a linear carbonate). This may be due to the generation of passivating decomposition products in the anode SEI and/or cathode CEI such as Li₃PO₄, Li₃P, polyphosphates, and organic polymers in electrolytes containing phosphates due to the reduction of the phosphate at the anode and/or oxidation of the phosphate at the cathode. In the case of TIP (ELY #22), the discharge voltage (904) is significantly higher than those of ELY #16 (EP, a linear ester) and ELY #17 (DMC, a linear carbonate), and in the case of TEP (ELY #21) and TMP (ELY #33), the conductivity (Table 5) is high and comparable to those of ELY #16 (EP, a linear ester) and ELY #17 (DMC, a linear carbonate). These properties may be due to the high dielectric constant and dipole moment of phosphate co-solvents, which may increase ion dissociation in solution and increase ionic conductivity. This may also be due to reduced interfacial resistance in phosphate-containing electrolytes, which may be due to the high ionic conductivity of the decomposition products in the anode SEI and/or cathode CEI such as Li₃PO₄, Li₃P, and polyphosphates.

Example ELYs #23 (FB), #24 (TFT), and #36 (heptane) contain diluents. These electrolytes exhibit high cycle life characteristics (902) and FCE values (906) comparable to or greater than those of ELY #16 (EP, a linear ester) and ELY #17 (DMC, a linear carbonate). These properties may be due to the altered Li-ion solvation structure and increased concentration of contact ion pairs in solution, which may reduce the salt anion oxidation at the cathode and increase the anion reduction at the anode. Increased anion reduction at the anode may increase the LiF content in the anode SEI, which may increase the mechanical stability of the SEI, reduce the reduction of other electrolyte components, and reduce capacity fade. The weakly coordinating co-solvents (diluents) themselves may also contribute beneficial reduction and oxidation products to the anode SEI and cathode CEI upon their decomposition, such as LiF and organic polymers, which may further increase the passivation of the electrodes and reduce capacity fade. In the case of heptane (ELY #36), the discharge voltage (904) is high and comparable to those of ELY #16 (EP, a linear ester) and ELY #17 (DMC, a linear carbonate). This may be due to the low viscosity of heptane, which may increase lithium ion diffusivity and ionic conductivity.

FIG. 11 shows the first-cycle efficiency (FCE) data of cells of Cell Design D, charged at 0.1C to 4.4V and discharged at 0.1C to 2.5V, filled with respective example electrolytes ELYs #37 to #43. Example ELYs #37 to #43 are of the following general composition: about 11 mol. % of a salt mixture, about 27 mol. % FEC, about 11 mol. % PC, about 48 mol. % EI, and about 3 vol. % VC. As horizontal axis of FIG. 11, the salt compositions for ELYs #37 to #43 were: about 11 mol. % LiPF₆ (ELY #37), about 11 mol. % LiFSI (ELY #38), about 5.5 mol. % LiPF₆ and about 5.5 mol. % LiFSI (ELY #39), about 11 mol. % lithium trifluoromethanesulfonate (LiOTf) (ELY #40), about 5.5 mol. % LiPF₆ and about 5.5 mol. % LiOTf (ELY #41), about 11 mol. % LiTFSI (ELY #42), about 5.5 mol. % LiPF₆ and about 5.5 mol. % LiTFSI (ELY #43). Cells with only LiOTf salt (ELY #40) or LiTFSI salt (ELY #42) had very low FCE values, which may be due to uncontrolled corrosion at the Al cathode current collector during the first cycle charge. However, when half (by mole) of the LiOTf or the LiTFSI in the foregoing electrolytes ELYs #40, #42 was replaced by LiPF₆, the FCE values were significantly increased (e.g., to about 87 to 90%), which may be due to LiPF₆ passivating the Al cathode current collector, resulting in higher FCE values exhibited by certain other electrolytes discussed herein (e.g., ELY #11-#12, #14-#31, and #36). This shows the effectiveness of LiPF₆ as a passivator of the cathode current collector against various otherwise corrosive salts.

In some designs, it may be preferable for the L-HCE to exhibit room-temperature density in a range from about 0.8 g/cc to about 1.8 g/cc (in some designs, from about 0.8 to about 1.2 g/cc; in other designs, from about 1.2 to about 1.4 g/cc; in other designs, from about 1.4 to about 1.6 g/cc; in yet other designs, from about 1.6 to about 1.8 g/cc). Too low or too high density may undesirably limit various Li-ion battery cell characteristics (e.g., stability, high-rate performance, low temperature performance, charge rate, specific energy, etc.).

In some designs, it may be preferable for the L-HCE to exhibit room-temperature dynamic viscosity (η) in a range from about 0.5 cP to about 30 cP (in some designs, from about 0.5 cP to about 2.5 cP; in other designs, from about 2.5 cP to about 3.5 cP; in other designs, from about 3.5 cP to about 5 cP; in other designs, from about 5 cP to about 7.5 cP; in other designs, from about 7.5 cP to about 10 cP; in other designs, from about 10 cP to about 12.5 cP; in other designs, from about 12.5 cP to about 15 cP; in other designs, from about 15 cP to about 20 cP; in other designs, from about 20 cP to about 25 cP; in other designs, from about 25 cP to about 30 cP). For Li-ion batteries with higher areal capacity loadings or operating at lower temperatures (e.g. lower than room temperature) or requiring faster charge, selecting L-HCE composition to exhibit lower viscosity (in some designs, by using lower salt fractions or higher fraction of lower viscosity co-solvents, etc.) may generally be beneficial. Room temperature viscosity that is too high (e.g., above 30 cP) may induce premature cell failure if charging at faster rates (e.g., by inducing uncontrolled or undesirable Li plating, SEI damages by nonuniform lithiation or delithiation of anodes, CEI or cathode particle damages by nonuniform lithiation or delithiation of cathodes or by other mechanisms, etc.). On the other hand, higher L-HCE viscosity may enhance calendar life, reduce gassing, improve cycle stability and provide other performance benefits for cells with lower area capacity loadings or cells that operate at higher temperatures or cells that charge slower, etc. An L-HCE viscosity that is too low (e.g., below about 0.5 cP) (which may be achieved, for example, by using very low viscosity co-solvents or diluents or by reducing salt concentration or by selecting specific salts and attaining low solvation size or low solvation energy, etc.) may also lead to undesirable cell performance characteristics (e.g., lower than desired calendar life or cycle life, worse than desired performance at high voltages or high temperatures, etc.). As such, the optimum L-HCE viscosity may depend on the particular anode and cathode chemistry, anode and cathode properties (e.g., active material particle size and specific surface area, active material crystal structure and grain size, electrode porosity, electrode tortuosity, binder chemistry and distribution, etc.), electrode areal capacity loadings, N—P ratio, typical charging or discharging rates, cell operating conditions (including temperature) and other factors.

In some designs, it may be preferable for the L-HCE to exhibit room-temperature conductivity (e.g., as determined by electrochemical impedance spectroscopy or other suitable measurements) in the range from about 2 to about 25 mS/cm (in some designs, from about 2 to about 5 mS/cm; in other designs, from about 5 to about 8 mS/cm; in other designs, from about 8 to about 11 mS/cm; in other designs, from about 11 to about 14 mS/cm; in other designs, from about 14 to about 18 mS/cm; in other designs, from about 18 to about 21 mS/cm; in other designs, from about 21 to about 25 mS/cm). Both too high and too low conductivity may correlate with poor cell performance in cells comprising suitable L-HCE compositions. The optimum conductivity may depend on the cell composition, design and operating conditions.

In some designs, it may be preferable to operate the Li-ion battery cell at elevated temperature to achieve desired power characteristics (e.g., cell resistance, charge rate capability, discharge rate capability, thermal cooling load on the battery management system, etc.), or if the environment of the application makes a high operating temperature desirable (e.g. in an elevated temperature industrial environment, in operation next to electronic or combustion devices that generate heat, etc.). In some embodiments, elevated operating temperature may be desirable for applications such as for propulsion of automobiles (e.g., cars, vans, buses, and trucks); stationary storage for residential, commercial, industrial, or grid use; or propulsion of manned/unmanned aircrafts or seacrafts. In some embodiments, elevated operating temperature may be achieved by means of a heat pump, resistive heating elements, self-heating, waste heat (e.g. from a hot process fluid or motor), or passive heating from the ambient environment. In some embodiments, the operating temperature may be in the range of about 40 to about 90° C. (e.g., about 40-45° C., about 45-50° C., about 50-55° C., about 55-60° C., about 60-65° C., about 65-70° C., about 70-75° C., about 75-80° C., about 80-85° C., or about 85-90° C.).

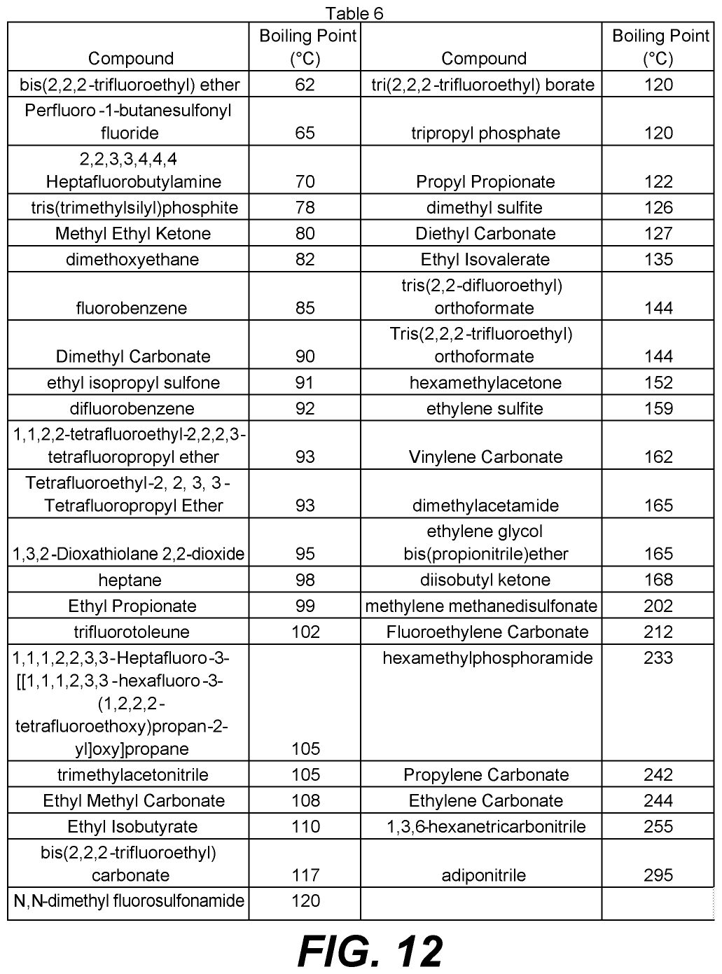

In some designs, it may be preferable for the L-HCE to have a sufficiently high (at least about 10° C. above the operating temperature) boiling point to enable operation at elevated temperatures (about 40-90° C.) without the cell case rupturing due to vaporization of the electrolyte, and without a rigid enclosure to pressurize the electrolyte. FIG. 12 shows a Table 6 listing the boiling points of certain compounds, which may function as co-solvents and/or diluents, ordered from low to high, as an illustrative example. In some designs, electrolytes with lower boiling points at atmospheric pressure may be acceptable if a rigid cell casing such as a cylindrical (e.g., 18650 cells, 21700 cells, 46xx format cells such as 4680 cells, etc.) or prismatic cell design (e.g., 40 Ah, 80 Ah, 150 Ah, etc.) is used to allow the cell to operate at elevated pressures without the cell case rupturing. In some designs, the acceptable maximum internal pressure generated by the electrolyte may be elevated pressures in the range of about 1-1.2 bar, about 1.2-5 bar, about 5-10 bar, or about 10-20 bar in absolute terms.

The above-described exemplary particles (e.g., anode or cathode particles) may generally be of any shape (e.g., near-spherical or a spheroidal or an ellipsoid (e.g., including oblate spheroid), cylindrical, plate-like, have a random shape, etc.) and of any size. The maximum size of the particle may depend on the rate performance requirements, on the rate of the ion diffusion into the partially filled particles, and/or on other parameters. For most applications, the average diffusion distance from the solid-electrolyte interphase (e.g., from the surface of the composite particles) to the inner core of the composite particles may be smaller than about 10 microns for the optimal performance.

Some aspects of this disclosure may also be applicable to cells with conventional intercalation-type electrodes (e.g., cathodes with no nickel or relatively small amounts of nickel, anodes with no silicon or relatively small amounts of silicon) and provide benefits of improved rate performance or improved stability or improved calendar life, particularly for electrodes with medium and high-capacity loadings (e.g., greater than about 3-4 mAh/cm²).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A lithium-ion battery, comprising: an anode current collector; a cathode current collector; an anode disposed on and/or in the anode current collector; a cathode disposed on and/or in the cathode current collector; and an electrolyte ionically coupling the anode and the cathode, the electrolyte comprising (1) a lithium salt composition and (2) a solvent composition, and (3) a diluent composition, wherein: the anode comprises composite particles comprising carbon and silicon, at least some of the silicon being nanosized silicon in the composite particles; the diluent composition comprises at least one aromatic compound and/or at least one alkane compound; and the at least one alkane compound is selected from (1) non-fluorinated alkane compounds characterized by a first molecular formula CₚH₂ₚ₊₂, in which p is a first integer between 5 and 20 (e.g., in some designs, between 7 and 20), and (2) fluorinated alkane compounds characterized by a second molecular formula C_{q}H_{q1}F_{q2}, in which q is a second integer between 4 and 20 (e.g., in some designs, between 6 and 20), q₁ is a third positive integer, and q₂ is a fourth positive integer, q, q₁, and q₂ being related by q₁+q₂=2q+2.

Clause 2. The lithium-ion battery of clause 1, wherein: the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

Clause 3. The lithium-ion battery of any of clauses 1 to 2, wherein: the at least one alkane compound comprises two or more of the non-fluorinated alkane compounds and/or the fluorinated alkane compounds.

Clause 4. The lithium-ion battery of any of clauses 1 to 3, wherein: the at least one alkane compound is selected from heptanes (C₇H₁₆), octanes (C₈H₁₈), nonanes (C₉H₂₀), fluoroheptanes (C₇H₁₅F), difluorooctanes (C₈H₁₆F₂), and fluorononanes (C₉H₁₉F).

Clause 5. The lithium-ion battery of any of clauses 1 to 4, wherein: a mole fraction of the lithium salt composition in the electrolyte is in a range of 10 mol. % to 20 mol. %.

Clause 6. The lithium-ion battery of any of clauses 1 to 5, wherein: the lithium salt composition comprises a salt compound selected from lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li₃PS₄, Li₆PS₅Cl, lithium tris(fluorosulfonyl)methide (LTFSM), lithium bis(oxalate)borate (LiBOB), lithium tetracyanoborate (LiBison), lithium dicyano-trifluoromethyl-imidazole (LiTDI), lithium dicyano-(pentafluoroethyl)imidazole (LiPDI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), and lithium cyclo-hexafluoropropane-1,1-bis(sulfonyl)imide (Li HPSI).

Clause 7. The lithium-ion battery of any of clauses 1 to 6, wherein the lithium salt composition comprises two or more salt compounds.

Clause 8. The lithium-ion battery of any of clauses 1 to 7, wherein the electrolyte comprises at least one non-Li salt compound.

Clause 9. The lithium-ion battery of any of clauses 1 to 8, wherein: the solvent composition comprises vinylene carbonate (VC), a mole fraction of the VC in the electrolyte being in a range of about 0.05 to about 2.00 mol. %.

Clause 10. The lithium-ion battery of any of clauses 1 to 9, wherein: the solvent composition comprises fluoroethylene carbonate (FEC), a mole fraction of the FEC in the electrolyte being in a range of about 0.1 to about 20 mol. %.

Clause 11. The lithium-ion battery of any of clauses 1 to 10, wherein: the solvent composition comprises a linear ester, a cyclic ester, and/or a branched ester.

Clause 12. The lithium-ion battery of any of clauses 1 to 11, wherein: the solvent composition comprises a ketone selected from: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA).

Clause 13. The lithium-ion battery of any of clauses 1 to 12, wherein: the solvent composition comprises an ether selected from: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (DME), and diethoxyethane.

Clause 14. The lithium-ion battery of any of clauses 1 to 13, wherein: the solvent composition comprises a nitrile selected from acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), and 1,3,6-hexanetricarbonitrile (HTCN).

Clause 15. The lithium-ion battery of any of clauses 1 to 14, wherein: the solvent composition comprises an amide selected from dimethylacetamide (DMAc), hexamethylphosphoramide (HMPA), N,N-dimethyl trifluoromethanesulfonamide (DMTMSA), N,N-diethyl trifluoromethanesulfonamide, N,N-dimethyl fluorosulfonamide, and carbamides.

Clause 16. The lithium-ion battery of any of clauses 1 to 15, wherein: the solvent composition comprises a nitroalkane selected from nitromethane (NM), nitroethane (NE), trinitromethane, tetranitromethane, 2-nitropropane (2NP), 1-nitropropane (1-NP), dinitromethane, hexanitroethane (HNE), and heptanitrocubane (HNC).

Clause 17. The lithium-ion battery of any of clauses 1 to 16, wherein: the solvent composition comprises a phosphate selected from trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate.

Clause 18. The lithium-ion battery of any of clauses 1 to 17, wherein: the solvent composition comprises a phosphite selected from tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite.

Clause 19. The lithium-ion battery of any of clauses 1 to 18, wherein: the solvent composition comprises a sulfite selected from dimethyl sulfite (DMS), trimethylene sulfite, and ethylene sulfite (ESi).

Clause 20. The lithium-ion battery of any of clauses 1 to 19, wherein: the solvent composition comprises a sulfone selected from ethyl methyl sulfone, ethyl isopropyl sulfone, dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), sulfolane, and phenyl vinyl sulfone.

Clause 21. The lithium-ion battery of any of clauses 1 to 20, wherein: the solvent composition comprises a sulfonamide selected from 2-methyl-5-(methylsulfonyl)benzenesulfonamide, N,N-dimethyl trifluoromethanesulfonamide (DMTMSA), and N,N-dimethyl fluorosulfonamide.

Clause 22. The lithium-ion battery of any of clauses 1 to 21, wherein: the solvent composition comprises a boron (B)-comprising compound selected from pyridine-boron trifluoride (PBF), 3-fluoro pyridine-boron trifluoride (3F-PBF), pyrazine-boron trifluoride, and borate esters.

Clause 23. The lithium-ion battery of any of clauses 1 to 22, wherein: the solvent composition comprises a silicon (Si)-comprising compound selected from siloxanes and silanes.

Clause 24. The lithium-ion battery of any of clauses 1 to 23, wherein: the diluent composition comprises fluorinated ether selected from 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether, tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane.

Clause 25. The lithium-ion battery of any of clauses 1 to 24, wherein: the diluent composition comprises one or more amines selected from trimethylamine, triethylamine, tripropylamine, di-isopropylamine, perfluorotriethylamine ((CF₃CF₂)₃N), perfluoromethyldiethylamine ((CF₃CF₂)₂CF₃N), perfluoroethyldimethylamine (CF₃CF₂)₁(CF₃)₂N), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), and 2,2,2-trifluoro-1-phenylethylamine (C₈H₈F₃N).

Clause 26. The lithium-ion battery of any of clauses 1 to 25, wherein: the solvent composition comprises one or more amines selected from methylamine, fluoromethylamine, trifluoromethylamine, difluoroethylamine, and diethylamine.

Clause 27. The lithium-ion battery of any of clauses 1 to 26, wherein: the solvent composition comprises one or more sulfonyl fluorides selected from 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, ethane sulfonyl fluoride, propane sulfonyl fluoride, butane sulfonyl fluoride, and sulfonyl fluoride compounds characterized by a third molecular formula C_{X}H_{y}F_{z} SO₂F in which x is a fifth integer between 1 and 6, each of y and z is respectively a sixth integer and a seventh integer, x, y, and z being related by y+z=2x+1.

Clause 28. The lithium-ion battery of any of clauses 1 to 27, wherein: the solvent composition comprises one or more linear carbonates selected from dimethyl carbonate (DMC), ethyl methyl carbonate (EMC), and diethyl carbonate (DEC).

Clause 29. The lithium-ion battery of any of clauses 1 to 28, wherein: a mass of the silicon is in a range of about 10 wt. % to about 90 wt. % of the anode (not counting the anode current collector).

Clause 30. The lithium-ion battery of any of clauses 1 to 29, wherein: the anode additionally comprises graphite particles.

Clause 31. The lithium-ion battery of any of clauses 1 to 30, wherein: the anode additionally comprises carbon nanotubes or carbon black particles.

Clause 32. The lithium-ion battery of any of clauses 1 to 31, wherein: the anode current collector comprises copper.

Clause 33. The lithium-ion battery of any of clauses 1 to 32, wherein: the cathode current collector comprises aluminum.

Clause 34. The lithium-ion battery of any of clauses 1 to 33, wherein the lithium-ion battery is operated at a temperature in a range of about 40 to about 90° C., and the lithium-ion battery is configured for propulsion of an automobile.

Clause 35. The lithium-ion battery of any of clauses 1 to 34, wherein the first integer is between 7 and 20, and the second integer is between 6 and 20.

Implementation examples are described in the following numbered Additional Clauses:

Additional Clause 1. An electrolyte, comprising: a lithium salt composition; a solvent composition; and a diluent composition, wherein: the diluent composition comprises at least one alkane compound selected from (1) non-fluorinated alkane compounds characterized by a first molecular formula CₚH₂ₚ₊₂, in which p is a first integer between 5 and 20, and (2) fluorinated alkane compounds characterized by a second molecular formula C_{q}H_{q1}F_{q2}, in which q is a second integer between 4 and 20, q₁ is a third positive integer, and q₂ is a fourth positive integer, q, q₁, and q₂ being related by q₁+q₂=2q+2.

Additional Clause 2. The electrolyte of Additional Clause 1, wherein: the at least one alkane compound comprises two or more of the non-fluorinated alkane compounds and/or the fluorinated alkane compounds.

Additional Clause 3. The electrolyte of any of Additional Clauses 1 to 2, wherein: the at least one alkane compound is selected from heptanes (C₇H₁₆), octanes (C₈H₁₈), nonanes (C₉H₂₀), fluoroheptanes (C₇H₁₅F), difluorooctanes (C₈H₁₆F₂), and fluorononanes (C₉H₁₉F).

Additional Clause 4. The electrolyte of any of Additional Clauses 1 to 3, wherein: a mole fraction of the lithium salt composition in the electrolyte is in a range of about 10 mol. % to about 20 mol. %.

Additional Clause 5. The electrolyte of any of Additional Clauses 1 to 4, wherein: the lithium salt composition comprises a salt compound selected from lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li PS₄, Li₆PS₅Cl, lithium tris(fluorosulfonyl)methide (LTFSM), lithium bis(oxalate)borate (LiBOB), lithium tetracyanoborate (LiBison), lithium dicyano-trifluoromethyl-imidazole (LiTDI), lithium dicyano-pentafluoroethyl-imidazole (LiDPI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), and lithium cyclo-hexafluoropropane-1,1-bis(sulfonyl)imide (Li HPSI).

Additional Clause 6. The electrolyte of any of Additional Clauses 1 to 5, wherein the lithium salt composition comprises two or more salt compounds.

Additional Clause 7. The electrolyte of any of Additional Clauses 1 to 6, wherein the electrolyte comprises at least one non-Li salt compound.

Additional Clause 8. The electrolyte of any of Additional Clauses 1 to 7, wherein: the solvent composition comprises vinylene carbonate (VC), a mole fraction of the VC in the electrolyte being in a range of about 0.05 to about 2.00 mol. %.

Additional Clause 9. The electrolyte of any of Additional Clauses 1 to 8, wherein: the solvent composition comprises fluoroethylene carbonate (FEC), a mole fraction of the FEC in the electrolyte being in a range of about 0.1 to about 20 mol. %.

Additional Clause 10. The electrolyte of any of Additional Clauses 1 to 9, wherein: the solvent composition comprises a linear ester, a cyclic ester, and/or a branched ester.

Additional Clause 11. The electrolyte of any of Additional Clauses 1 to 10, wherein: the solvent composition comprises a ketone selected from: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA).

Additional Clause 12. The electrolyte of any of Additional Clauses 1 to 11, wherein: the solvent composition comprises an ether selected from: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (DME), and diethoxyethane.

Additional Clause 13. The electrolyte of any of Additional Clauses 1 to 12, wherein: the solvent composition comprises a nitrile selected from acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), and 1,3,6-hexanetricarbonitrile (HTCN).

Additional Clause 14. The electrolyte of any of Additional Clauses 1 to 13, wherein: the solvent composition comprises an amide selected from dimethylacetamide (DMAc), hexamethylphosphoramide (HMPA), N,N-dimethyl trifluoromethanesulfonamide (DMTMSA), N,N-diethyl trifluoromethanesulfonamide, N,N-dimethyl fluorosulfonamide, and carbamides.

Additional Clause 15. The electrolyte of any of Additional Clauses 1 to 14, wherein: the solvent composition comprises a nitroalkane selected from nitromethane (NM), nitroethane (NE), trinitromethane, tetranitromethane, 2-nitropropane (2NP), 1-nitropropane (1-NP), dinitromethane, hexanitroethane (HNE), and heptanitrocubane (HNC).

Additional Clause 16. The electrolyte of any of Additional Clauses 1 to 15, wherein: the solvent composition comprises a phosphate selected from trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate.

Additional Clause 17. The electrolyte of any of Additional Clauses 1 to 16, wherein: the solvent composition comprises a phosphite selected from tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite.

Additional Clause 18. The electrolyte of any of Additional Clauses 1 to 17, wherein: the solvent composition comprises a sulfite selected from dimethyl sulfite (DMS), trimethylene sulfite, and ethylene sulfite (ESi).

Additional Clause 19. The electrolyte of any of Additional Clauses 1 to 18, wherein: the solvent composition comprises a sulfone selected from ethyl methyl sulfone, ethyl isopropyl sulfone, dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), sulfolane, and phenyl vinyl sulfone.

Additional Clause 20. The electrolyte of any of Additional Clauses 1 to 19, wherein: the solvent composition comprises a sulfonamide selected from 2-methyl-5-(methylsulfonyl)benzenesulfonamide, N,N-dimethyl trifluoromethanesulfonamide (DMTMSA), and N,N-dimethyl fluorosulfonamide.

Additional Clause 21. The electrolyte of any of Additional Clauses 1 to 20, wherein: the solvent composition comprises a boron (B)-comprising compound selected from pyridine-boron trifluoride (PBF), 3-fluoro pyridine-boron trifluoride (3F-PBF), pyrazine-boron trifluoride, and borate esters.

Additional Clause 22. The electrolyte of any of Additional Clauses 1 to 21, wherein: the solvent composition comprises a silicon (Si)-comprising compound selected from siloxanes and silanes.

Additional Clause 23. The electrolyte of any of Additional Clauses 1 to 22, wherein: the diluent composition comprises fluorinated ether selected from 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether, tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane.

Additional Clause 24. The electrolyte of any of Additional Clauses 1 to 23, wherein: the diluent composition comprises one or more amines selected from trimethylamine, triethylamine, tripropylamine, di-isopropylamine, perfluorotriethylamine ((CF₃CF₂)₃N), perfluoromethyldiethylamine ((CF₃CF₂)₂CF₃N), perfluoroethyldimethylamine (CF₃CF₂)₁(CF₃)₂N), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), and 2,2,2-trifluoro-1-phenylethylamine (C₈H₈F₃N).

Additional Clause 25. The electrolyte of any of Additional Clauses 1 to 24, wherein: the solvent composition comprises one or more amines selected from methylamine, fluoromethylamine, trifluoromethylamine, difluoroethylamine, and diethylamine.

Additional Clause 26. The electrolyte of any of Additional Clauses 1 to 25, wherein: the solvent composition comprises one or more sulfonyl fluorides selected from 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, ethane sulfonyl fluoride, propane sulfonyl fluoride, butane sulfonyl fluoride, and sulfonyl fluoride compounds characterized by a third molecular formula CₓH_{y}F_{z} SO₂F in which x is a fifth integer between 1 and 6, each of y and z is respectively a sixth integer and a seventh integer, x, y, and z being related by y+z=2x+1.

Additional Clause 27. The electrolyte of any of Additional Clauses 1 to 26, wherein: the solvent composition comprises one or more linear carbonates selected from dimethyl carbonate (DMC), ethyl methyl carbonate (EMC), and diethyl carbonate (DEC).

Additional Clause 28. A lithium-ion battery, comprising: an anode current collector; a cathode current collector; an anode disposed on and/or in the anode current collector; a cathode disposed on and/or in the cathode current collector; and the electrolyte of Additional Clause 1 ionically coupling the anode and the cathode, wherein: the anode comprises composite particles comprising carbon and silicon, at least some of the silicon being nanosized silicon in the composite particles.

Additional Clause 29. The lithium-ion battery of Additional Clause 28, wherein: a mass of the silicon is in a range of about 10 wt. % to about 90 wt. % of the anode excluding the anode current collector.

Additional Clause 30. The lithium-ion battery of any of Additional Clauses 28 to 29, wherein: the anode additionally comprises graphite particles.

Additional Clause 31. The lithium-ion battery of any of Additional Clauses 28 to 30, wherein: the anode additionally comprises carbon nanotubes and/or carbon black particles.

Additional Clause 32. The lithium-ion battery of any of Additional Clauses 28 to 31, wherein: the anode current collector comprises copper.

Additional Clause 33. The lithium-ion battery of any of Additional Clauses 28 to 32, wherein: the cathode current collector comprises aluminum.

Additional Clause 34. The lithium-ion battery of any of Additional Clauses 28 to 33, wherein: the lithium-ion battery is operated at a temperature in a range of about 40 to about 90° C.; and the lithium-ion battery is configured to supply an electromotive force for propulsion of an automobile.

Additional Clause 35. The electrolyte of any of Additional Clauses 1 to 34, wherein: the first integer is between 7 and 20, and the second integer is between 6 and 20.

Additional Clause 36. The electrolyte of any of Additional Clauses 1 to 35, wherein: the diluent composition additionally comprises at least one aromatic compound.

Additional Clause 37. The electrolyte of Additional Clause 36, wherein: the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

Additional Clause 38. An electrolyte, comprising: a lithium salt composition; a solvent composition; and a diluent composition, wherein: the diluent composition comprises at least one aromatic compound, and the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

Additional Clause 39. The electrolyte of Additional Clause 38, wherein: a mole fraction of the lithium salt composition in the electrolyte is in a range of about 10 mol. % to about 20 mol. %.

Additional Clause 40. The electrolyte of any of Additional Clauses 38 to 39, wherein: the lithium salt composition comprises a salt compound selected from lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li₃PS₄, Li₆PS₅Cl, lithium tris(fluorosulfonyl)methide (LTFSM), lithium bis(oxalate)borate (LiBOB), lithium tetracyanoborate (LiBison), lithium dicyano-trifluoromethyl-imidazole (LiTDI), lithium dicyano-pentafluoroethyl-imidazole (LiDPI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), and lithium cyclo-hexafluoropropane-1,1-bis(sulfonyl)imide (Li HPSI).

Additional Clause 41. The electrolyte of any of Additional Clauses 38 to 40, wherein the lithium salt composition comprises two or more salt compounds.

Additional Clause 42. The electrolyte of any of Additional Clauses 38 to 41, wherein the electrolyte comprises at least one non-Li salt compound.

Additional Clause 43. The electrolyte of any of Additional Clauses 38 to 42, wherein: the solvent composition comprises vinylene carbonate (VC), a mole fraction of the VC in the electrolyte being in a range of about 0.05 to about 2.00 mol. %.

Additional Clause 44. The electrolyte of any of Additional Clauses 38 to 43, wherein: the solvent composition comprises fluoroethylene carbonate (FEC), a mole fraction of the FEC in the electrolyte being in a range of about 0.1 to about 20 mol. %.

Additional Clause 45. The electrolyte of any of Additional Clauses 38 to 44, wherein: the solvent composition comprises a linear ester, a cyclic ester, and/or a branched ester.

Additional Clause 46. The electrolyte of any of Additional Clauses 38 to 45, wherein: the solvent composition comprises a ketone selected from: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA).

Additional Clause 47. The electrolyte of any of Additional Clauses 38 to 46, wherein: the solvent composition comprises an ether selected from: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (DME), and diethoxyethane.

Additional Clause 48. The electrolyte of any of Additional Clauses 38 to 47, wherein: the solvent composition comprises a nitrile selected from acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), and 1,3,6-hexanetricarbonitrile (HTCN).

Additional Clause 49. The electrolyte of any of Additional Clauses 38 to 48, wherein: the solvent composition comprises an amide selected from dimethylacetamide (DMAc), hexamethylphosphoramide (HMPA), N,N-dimethyl trifluoromethanesulfonamide (DMTMSA), N,N-diethyl trifluoromethanesulfonamide, N,N-dimethyl fluorosulfonamide, and carbamides.

Additional Clause 50. The electrolyte of any of Additional Clauses 38 to 49, wherein: the solvent composition comprises a nitroalkane selected from nitromethane (NM), nitroethane (NE), trinitromethane, tetranitromethane, 2-nitropropane (2NP), 1-nitropropane (1-NP), dinitromethane, hexanitroethane (HNE), and heptanitrocubane (HNC).

Additional Clause 51. The electrolyte of any of Additional Clauses 38 to 50, wherein: the solvent composition comprises a phosphate selected from trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate.

Additional Clause 52. The electrolyte of any of Additional Clauses 38 to 51, wherein: the solvent composition comprises a phosphite selected from tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite.

Additional Clause 53. The electrolyte of any of Additional Clauses 38 to 52, wherein: the solvent composition comprises a sulfite selected from dimethyl sulfite (DMS), trimethylene sulfite, and ethylene sulfite (ESi).

Additional Clause 54. The electrolyte of any of Additional Clauses 38 to 53, wherein: the solvent composition comprises a sulfone selected from ethyl methyl sulfone, ethyl isopropyl sulfone, dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), sulfolane, and phenyl vinyl sulfone.

Additional Clause 55. The electrolyte of any of Additional Clauses 38 to 54, wherein: the solvent composition comprises a sulfonamide selected from 2-methyl-5-(methylsulfonyl)benzenesulfonamide, N,N-dimethyl trifluoromethanesulfonamide (DMTMSA), and N,N-dimethyl fluorosulfonamide.

Additional Clause 56. The electrolyte of any of Additional Clauses 38 to 55, wherein: the solvent composition comprises a boron (B)-comprising compound selected from pyridine-boron trifluoride (PBF), 3-fluoro pyridine-boron trifluoride (3F-PBF), pyrazine-boron trifluoride, and borate esters.

Additional Clause 57. The electrolyte of any of Additional Clauses 38 to 56, wherein: the solvent composition comprises a silicon (Si)-comprising compound selected from siloxanes and silanes.

Additional Clause 58. The electrolyte of any of Additional Clauses 38 to 57, wherein: the diluent composition comprises fluorinated ether selected from 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether, tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane.

Additional Clause 59. The electrolyte of any of Additional Clauses 38 to 58, wherein: the diluent composition comprises one or more amines selected from trimethylamine, triethylamine, tripropylamine, di-isopropylamine, perfluorotriethylamine ((CF₃CF₂)₃N), perfluoromethyldiethylamine ((CF₃CF₂)₂CF₃N), perfluoroethyldimethylamine (CF₃CF₂)₁(CF₃)₂N), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), and 2,2,2-trifluoro-1-phenylethylamine (C₈H₈F₃N).

Additional Clause 60. The electrolyte of any of Additional Clauses 38 to 59, wherein: the solvent composition comprises one or more amines selected from methylamine, fluoromethylamine, trifluoromethylamine, difluoroethylamine, and diethylamine.

Additional Clause 61. The electrolyte of any of Additional Clauses 38 to 60, wherein: the solvent composition comprises one or more sulfonyl fluorides selected from 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, ethane sulfonyl fluoride, propane sulfonyl fluoride, butane sulfonyl fluoride, and sulfonyl fluoride compounds characterized by a third molecular formula CₓH_{y}F_{z} SO₂F in which x is a fifth integer between 1 and 6, each of y and z is respectively a sixth integer and a seventh integer, x, y, and z being related by y+z=2x+1.

Additional Clause 62. The electrolyte of any of Additional Clauses 38 to 61, wherein: the solvent composition comprises one or more linear carbonates selected from dimethyl carbonate (DMC), ethyl methyl carbonate (EMC), and diethyl carbonate (DEC).

Additional Clause 63. A lithium-ion battery, comprising: an anode current collector; a cathode current collector; an anode disposed on and/or in the anode current collector; a cathode disposed on and/or in the cathode current collector; and the electrolyte of Additional Clause 38 ionically coupling the anode and the cathode, wherein: the anode comprises composite particles comprising carbon and silicon, at least some of the silicon being nanosized silicon in the composite particles.

Additional Clause 64. The lithium-ion battery of Additional Clause 63, wherein: a mass of the silicon is in a range of about 10 wt. % to about 90 wt. % of the anode excluding the anode current collector.

Additional Clause 65. The lithium-ion battery of any of Additional Clauses 63 to 64, wherein: the anode additionally comprises graphite particles.

Additional Clause 66. The lithium-ion battery of any of Additional Clauses 63 to 65, wherein: the anode additionally comprises carbon nanotubes and/or carbon black particles.

Additional Clause 67. The lithium-ion battery of any of Additional Clauses 63 to 66, wherein: the anode current collector comprises copper.

Additional Clause 68. The lithium-ion battery of any of Additional Clauses 63 to 67, wherein: the cathode current collector comprises aluminum.

Additional Clause 69. The lithium-ion battery of any of Additional Clauses 63 to 68, wherein: the lithium-ion battery is operated at a temperature in a range of about 40 to about 90° C.; and the lithium-ion battery is configured to supply an electromotive force for propulsion of an automobile.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. An electrolyte, comprising:
a lithium salt composition;
a solvent composition; and
a diluent composition,
wherein:
the diluent composition comprises at least one alkane compound selected from (1) non-fluorinated alkane compounds characterized by a first molecular formula CₚH₂ₚ₊₂, in which p is a first integer between 5 and 20, and (2) fluorinated alkane compounds characterized by a second molecular formula C_{q}H_{q1}F_{q2}, in which q is a second integer between 4 and 20, q₁ is a third positive integer, and q₂ is a fourth positive integer, q, q₁, and q₂ being related by q₁+q₂=2q+2.

2. The electrolyte of claim 1, wherein:
the at least one alkane compound comprises two or more of the non-fluorinated alkane compounds and/or the fluorinated alkane compounds.

3. The electrolyte of claim 1, wherein:
the at least one alkane compound is selected from heptanes (C₇H₁₆), octanes (C₈H₁₈), nonanes (C₉H₂₀), fluoroheptanes (C₇H₁₅F), difluorooctanes (C₈H₁₆F₂), and fluorononanes (C₉H₁₉F).

4. The electrolyte of claim 1, wherein:
a mole fraction of the lithium salt composition in the electrolyte is in a range of about 10 mol. % to about 20 mol. %.

5. The electrolyte of claim 1, wherein:
the lithium salt composition comprises a salt compound selected from lithium bis(fluorosulfonyl)imide (LiFSI), LiPF₆, lithium bis(trifluoromethanesulfonyl)imide (LiTFSI), lithium trifluoromethanesulfonate (LiOTf, LiOSO₂CF₃), LiSO₃F (LSF), LiClO₄, LiAsF₆, LiBF₄, lithium difluoro(oxalato)borate (LiDFOB), lithium difluoro(bisoxalato)phosphate (LiDFBOP), lithium tetrafluoro(oxalato)phosphate (LiTFOP), lithium trifluoromethanesulfonate (LiOTf), LiSO₃F (LSF), Li₃PS₄, Li₆PS₅Cl, lithium tris(fluorosulfonyl)methide (LTFSM), lithium bis(oxalate)borate (LiBOB), lithium tetracyanoborate (LiBison), lithium dicyano-trifluoromethyl-imidazole (LiTDI), lithium dicyano-pentafluoroethyl-imidazole (LiDPI), lithium bis(fluoromalanoto)borate (LiBFMB), lithium dicyanotriazolate (LiDCTA), lithium tris(pentafluoroethyl)trifluorophosphate (LiFAP), lithium phosphate (Li₃PO₄), lithium fluorophosphate (FLi₂O₃P), lithium difluorophosphate (LiPO₂F₂ or LFO), LiClO₄, Li₂SO₄, LiNO₃, lithium hexafluorosilicate (Li₂SiF₆), lithium hexafluoroaluminate (Li₃AlF₆), lithium iodide (LiI), LiAsF₆, lithium cyclo-difluoromethane-1,1-bis(sulfonyl)imide (Li DMSI), and lithium cyclo-hexafluoropropane-1,1-bis(sulfonyl)imide (Li HPSI).

6. The electrolyte of claim 1, wherein the lithium salt composition comprises two or more salt compounds.

7. The electrolyte of claim 1, wherein the electrolyte comprises at least one non-Li salt compound.

8. The electrolyte of claim 1, wherein:
the solvent composition comprises vinylene carbonate (VC), a mole fraction of the VC in the electrolyte being in a range of about 0.05 to about 2.00 mol. %.

9. The electrolyte of claim 1, wherein:
the solvent composition comprises fluoroethylene carbonate (FEC), a mole fraction of the FEC in the electrolyte being in a range of about 0.1 to about 20 mol. %.

10. The electrolyte of claim 1, wherein:
the solvent composition comprises a linear ester, a cyclic ester, and/or a branched ester.

11. The electrolyte of claim 1, wherein:
the solvent composition comprises a ketone selected from: methyl ethyl ketone (MEK), diethyl ketone (DEK), methyl isopropyl ketone (MiPK), ethyl isopropyl ketone (EiPK), diisopropyl ketone, pinacolone (MtBK), diisobutyl ketone (DiBK), methyl sec-butyl ketone (MsBK), and hexamethylacetone (HMA).

12. The electrolyte of claim 1, wherein:
the solvent composition comprises an ether selected from: diethyl ether, 2-methoxy-2-methylpropane, dipropyl ether, diisopropyl ether, butyl ethyl ether, ethyl tert-butyl ether, 1-propoxybutane, ethyl pentyl ether, butyl isopropyl ether, sec-butyl isopropyl ether, ethylene glycol dimethyl ether (DME), and diethoxyethane.

13. The electrolyte of claim 1, wherein:
the solvent composition comprises a nitrile selected from acetonitrile (ACN), trimethylacetonitrile (TMAN), 2-oxo-1,3-dioxolane-4-carbonitrile (ECCN), cyclopropylacetonitrile (CPAN), ethylene glycol bis(propionitrile)ether (EGBE), fumaronitrile (FM), succinonitrile, glutaronitrile, adiponitrile (ADN), and 1,3,6-hexanetricarbonitrile (HTCN).

14. The electrolyte of claim 1, wherein:
the solvent composition comprises an amide selected from dimethylacetamide (DMAc), hexamethylphosphoramide (HMPA), N,N-dimethyl trifluoromethanesulfonamide (DMTMSA), N,N-diethyl trifluoromethanesulfonamide, N,N-dimethyl fluorosulfonamide, and carbamides.

15. The electrolyte of claim 1, wherein:
the solvent composition comprises a nitroalkane selected from nitromethane (NM), nitroethane (NE), trinitromethane, tetranitromethane, 2-nitropropane (2NP), 1-nitropropane (1-NP), dinitromethane, hexanitroethane (HNE), and heptanitrocubane (HNC).

16. The electrolyte of claim 1, wherein:
the solvent composition comprises a phosphate selected from trimethyl phosphate (TMP), triethyl phosphate (TEP), tripropyl phosphate (TPrP), triisopropyl phosphate (TIP), triphenyl phosphate (TPP), triallyl phosphate (TAP), tris(2,2,3,3,3-pentafluoropropyl) phosphate (5F-TPrP), tris(1,1,1,3,3,3-hexafluoropropan-2-yl) phosphate (HFiP), and diisopropyl fluorophosphate.

17. The electrolyte of claim 1, wherein:
the solvent composition comprises a phosphite selected from tris(trimethylsilyl)phosphite (TMSPi), tris(2,2,2-trifluoroethyl) phosphite (TTFPi), triphenyl phosphite (TPPi), tris(1,1,1,3,3,3-hexafluoropropan-2-yl) phosphite (THFPP), and tris(trimethylsilyl) phosphite.

18. The electrolyte of claim 1, wherein:
the solvent composition comprises a sulfite selected from dimethyl sulfite (DMS), trimethylene sulfite, and ethylene sulfite (ESi).

19. The electrolyte of claim 1, wherein:
the solvent composition comprises a sulfone selected from ethyl methyl sulfone, ethyl isopropyl sulfone, dimethyl sulfone, ethylmethyl sulfone, ethyl 3-(methylsulfonyl)propanoate, 2-(ethylsulfonyl)aniline, 6-(ethylsulfonyl)-1,3-benzoxazole-2-thiol, ethyl isopropyl sulfone, 4-ethylsulfonylbenzaldehyde, 2-(ethylsulfonyl)ethanamine, 1-(ethanesulfonyl)-4-nitrobenzene, 5-(1-azepanyl)-2-(ethylsulfonyl)aniline, N-(2-(methylsulfonyl)phenyl)acetamide, 3-amino-2,3-dihydrobenzo[b]thiophene 1,1-dioxide, 2-amino-4-(methylsulfonyl)phenol, 2-(isobutyl sulfonyl)ethanamine, ethyl 2-(phenylsulfonyl)acetate, 1-amino-2-(isopropylsulfonyl)benzene, N-methyl-4-(methylsulfonyl)aniline, 2-methoxy-6-(methylsulfonyl)aniline, [4-(methylsulfonyl)methyl)phenyl]methanamine, 2-(methylsulfonyl)cyclopentan-1-one, 2-bromoethyl methyl sulfone, bis(vinylsulfonyl)methane), sulfolane, and phenyl vinyl sulfone.

20. The electrolyte of claim 1, wherein:
the solvent composition comprises a sulfonamide selected from 2-methyl-5-(methylsulfonyl)benzenesulfonamide, N,N-dimethyl trifluoromethanesulfonamide (DMTMSA), and N,N-dimethyl fluorosulfonamide.

21. The electrolyte of claim 1, wherein:
the solvent composition comprises a boron (B)-comprising compound selected from pyridine-boron trifluoride (PBF), 3-fluoro pyridine-boron trifluoride (3F-PBF), pyrazine-boron trifluoride, and borate esters.

22. The electrolyte of claim 1, wherein:
the solvent composition comprises a silicon (Si)-comprising compound selected from siloxanes and silanes.

23. The electrolyte of claim 1, wherein:
the diluent composition comprises fluorinated ether selected from 1,1,2,2-tetrafluoroethyl-2,2,3,3-tetrafluoropropyl ether (TTE), bis(2,2,2-trifluoroethyl) ether (BTFE), 1,1,2,2-tetrafluoroethyl-2,2,2,3-tetrafluoropropyl ether, tris(2,2-difluoroethyl) orthoformate (TDFEO), bis(2,2-difluoroethyl)ether, tris(2,2,2-trifluoroethyl) orthoformate (TFEO), 2-(2,2-difluoroethoxy)-1,1-difluoroethane, 1-(2,2-difluoroethoxy)-1,1-difluoroethane, 1-(2,2-difluoroethoxy)-1,1-difluoroethane, 1,1,1,2,2-pentafluoro-2-methoxyethane, 1-(difluoromethoxy)-1,1,2,3,3,3-hexafluoropropane, 1,1,1,2,2,3,3-heptafluoro-3-(1,2,2,2-tetrafluoroethoxy)propane, 1-fluoro-3-(trifluoromethoxy)benzene, 1,1,1,2,2,3,3-heptafluoro-3-methoxypropane, and 1,1,1,2,2-pentafluoro-2-(2,2,2-trifluoroethoxy)ethane.

24. The electrolyte of claim 1, wherein:
the diluent composition comprises one or more amines selected from trimethylamine, triethylamine, tripropylamine, di-isopropylamine, perfluorotriethylamine ((CF₃CF₂)₃N), perfluoromethyldiethylamine ((CF₃CF₂)₂CF₃N), perfluoroethyldimethylamine (CF₃CF₂)₁(CF₃)₂N), trifluoroethylamine (TFEAm), trifluoropropylamine (TFPAm, C₃H₆F₃N), pentafluoropropylamine (PFPAm, C₃H₄F₅N), trifluoromethylamine (CF₃NH₂), heptafluorobutylamine (HFBAm, C₄H₄F₇N), nonafluoropentylamine (NFPAm, C₅H₄F₉N), 2,2,2-trifluoro-n-(2,2,2-trifluoroethyl)ethanamine (C₄H₅F₆N), difluoroethylamine (C₂H₅F₂N), and 2,2,2-trifluoro-1-phenylethylamine (C₈H₈F₃N).

25. The electrolyte of claim 1, wherein:
the solvent composition comprises one or more amines selected from methylamine, fluoromethylamine, trifluoromethylamine, difluoroethylamine, and diethylamine.

26. The electrolyte of claim 1, wherein:
the solvent composition comprises one or more sulfonyl fluorides selected from 5-oxooxolane-3-sulfonyl fluoride, methyl 2,2-difluoro-2-(fluorosulfonyl)acetate (MDFA), pyrrolidine-1-sulfonyl fluoride (C₄H₈FNO₂S), N-ethyl-N-methylsulfamoyl fluoride (C₃H₈FNO₂S), (1E)-2-cyanoeth-1-ene-1-sulfonyl fluoride (NC₃H₂SO₂F), trifluoromethylpropane sulfonyl fluoride (C₃H₆F₄SO₂), fluoroethane sulfonyl fluoride (C₂H₄F₂O₂S), perfluorobutane sulfonyl fluorides, perfluorohexane sulfonyl fluorides, perfluoroheptane sulfonyl fluorides, perfluorooctane sulfonyl fluorides, ethane sulfonyl fluoride, propane sulfonyl fluoride, butane sulfonyl fluoride, and sulfonyl fluoride compounds characterized by a third molecular formula CₓH_{y}F_{z} SO₂F in which x is a fifth integer between 1 and 6, each of y and z is respectively a sixth integer and a seventh integer, x, y, and z being related by y+z=2x+1.

27. The electrolyte of claim 1, wherein:
the solvent composition comprises one or more linear carbonates selected from dimethyl carbonate (DMC), ethyl methyl carbonate (EMC), and diethyl carbonate (DEC).

28. A lithium-ion battery, comprising:
an anode current collector;
a cathode current collector;
an anode disposed on and/or in the anode current collector;
a cathode disposed on and/or in the cathode current collector; and
the electrolyte of claim 1 ionically coupling the anode and the cathode, wherein:
the anode comprises composite particles comprising carbon and silicon, at least some of the silicon being nanosized silicon in the composite particles.

29. The lithium-ion battery of claim 28, wherein:
a mass of the silicon is in a range of about 10 wt. % to about 90 wt. % of the anode excluding the anode current collector.

30. The lithium-ion battery of claim 28, wherein:
the anode additionally comprises graphite particles.

31. The lithium-ion battery of claim 28, wherein:
the anode additionally comprises carbon nanotubes and/or carbon black particles.

32. The lithium-ion battery of claim 28, wherein:
the anode current collector comprises copper.

33. The lithium-ion battery of claim 28, wherein:
the cathode current collector comprises aluminum.

34. The lithium-ion battery of claim 28, wherein:
the lithium-ion battery is operated at a temperature in a range of about 40 to about 90° C.; and
the lithium-ion battery is configured to supply an electromotive force for propulsion of an automobile.

35. The electrolyte of claim 1, wherein:
the first integer is between 7 and 20, and
the second integer is between 6 and 20.

36. The electrolyte of claim 1, wherein:
the diluent composition additionally comprises at least one aromatic compound.

37. The electrolyte of claim 36, wherein:
the at least one aromatic compound is selected from: benzene, fluorobenzene (FB), difluorobenzenes (C₆H₄F₂), trifluorobenzenes (C₆H₃F₃), tetrafluorobenzenes (C₆H₂F₄), pentafluorobenzenes (C₆H₁F₅), trifluorotoluenes (TFT), bis(trifluoromethyl)benzenes (C₈H₄F₆), and bis(difluoromethyl)benzenes (C₈H₆F₄).

38.-69. (canceled)
